(19) United States
(12) Patent Application Publication
(10) Pub. No.: US 2024/0053712 A1
(43) Pub. Date: Feb. 15, 2024

(54) SYSTEMS, APPARATUS, ARTICLES OF MANUFACTURE, AND METHODS FOR AN APPLICATION MARKETPLACE FOR PROCESS CONTROL SYSTEMS

(71) Applicant: FISHER-ROSEMOUNT SYSTEMS, INC., Round Rock, TX (US)

(72) Inventors: Mark Nixon, Thorndale, TX (US); Anthony Amaro, JR., Leander, TX (US); Robert Gustaf Halgren, III, Singapore (SG); Claudio Aun Fayad, Austin, TX (US); Peter Hartmann, Round Rock, TX (US)

(21) Appl. No.: 17/819,532

(22) Filed: Aug. 12, 2022

(51) Int. Cl. G05B 15/02

(52) U.S. Cl. CPC G05B 15/02

(57) ABSTRACT

Methods, apparatus, systems, and articles of manufacture are disclosed for an application marketplace for process control systems. An example apparatus includes at least one memory, machine readable instructions, and processor circuitry to at least one of instantiate or execute the machine readable instructions to detect at least one of a configuration or a state of operation of a process control system based on telemetry data associated with the process control system, execute a machine learning model to generate an output based on the at least one of the configuration or the state of operation, the output to be representative of a recommendation to change a portion of the process control system, and cause a change of the portion of the process control system based on the recommendation.

### FIELD OF THE DISCLOSURE

This disclosure relates generally to process control systems and, more particularly, to systems, apparatus, articles of manufacture, and methods for an application marketplace for process control systems.

### BACKGROUND

Distributed control systems monitor and/or control field devices, such as actuators and sensors, in a process control system. The designing, commissioning, and operation of a distributed control system is typically a manually intensive process. Distributed control systems may not have access to an application marketplace tailored for process control systems.

### SUMMARY

Systems, apparatus, articles of manufacture, and methods for a process control system cloud-based service are disclosed.

An example apparatus includes at least one memory, machine readable instructions, and processor circuitry to at least one of instantiate or execute the machine readable instructions to detect at least one of a configuration or a state of operation of a process control system based on telemetry data associated with the process control system, execute a machine learning model to generate an output based on the at least one of the configuration or the state of operation, the output to be representative of a recommendation to change a portion of the process control system, and cause a change of the portion of the process control system based on the recommendation.

An example non-transitory machine readable storage medium includes instructions that, when executed, cause processor circuitry to at least detect at least one of a configuration or a state of operation of a process control system based on telemetry data associated with the process control system, execute a machine learning model to generate an output based on the at least one of the configuration or the state of operation, the output to be representative of a recommendation to change a portion of the process control system, and cause a change of the portion of the process control system based on the recommendation.

An example method includes detecting at least one of a configuration or a state of operation of a process control system based on telemetry data associated with the process control system, executing a machine learning model to generate an output based on the at least one of the configuration or the state of operation, the output to be representative of a recommendation to change a portion of the process control system, and causing a change of the portion of the process control system based on the recommendation.

### BRIEF DESCRIPTION OF THE DRAWINGS

FIG. 1 depicts an example system including an example process control system and an example marketplace system.

FIG. 2 depicts another example system including the example process control system and the example marketplace system of FIG. 1.

FIG. 3 depicts an example workflow to effectuate the example marketplace system of FIGS. 1 and/or 2.

FIG. 4 is a block diagram of example recommendation engine circuitry to effectuate examples disclosed herein.

FIG. 5 is a block diagram of example gateway circuitry to effectuate examples disclosed herein.

FIG. 6 is a flowchart representative of example machine readable instructions and/or example operations that may be executed by example processor circuitry to implement the recommendation engine circuitry of FIG. 4 to cause a change in a portion of a process control system based on a recommendation.

FIG. 7 is a flowchart representative of example machine readable instructions and/or example operations that may be executed by example processor circuitry to implement the recommendation engine circuitry of FIG. 4 to cause an update of a process control system based on a recommendation.

FIG. 8 is a flowchart representative of example machine readable instructions and/or example operations that may be executed by example processor circuitry to implement the recommendation engine circuitry of FIG. 4 to cause an update of a first process control system based on a second process control system.

FIG. 9 is a flowchart representative of example machine readable instructions and/or example operations that may be executed by example processor circuitry to implement the recommendation engine circuitry of FIG. 4 to generate a recommendation of application(s) based on a state of operation of a process control system.

FIG. 10 is a flowchart representative of example machine readable instructions and/or example operations that may be executed by example processor circuitry to implement the recommendation engine circuitry of FIG. 4 to cause an update of a process control system based on a recommendation.

FIG. 11 is a flowchart representative of example machine readable instructions and/or example operations that may be executed by example processor circuitry to implement the recommendation engine circuitry of FIG. 4 to effectuate a recovery of a process control system after a failure of the process control system.

FIG. 12 is a flowchart representative of example machine readable instructions and/or example operations that may be executed by example processor circuitry to implement the recommendation engine circuitry of FIG. 4 to effectuate execution of an application on at least one of a cloud host or a client electronic device.

FIG. 13 is a flowchart representative of example machine readable instructions and/or example operations that may be executed by example processor circuitry to implement the recommendation engine circuitry of FIG. 4 to implement a process control system marketplace.

FIG. 14 is a flowchart representative of example machine readable instructions and/or example operations that may be executed by example processor circuitry to implement the gateway circuitry of FIG. 5 to cause a change of a field device based on a recommendation.

FIG. 15 is a flowchart representative of example machine readable instructions and/or example operations that may be executed by example processor circuitry to implement the gateway circuitry of FIG. 5 to cause a change of at least one of firmware or software of a process control system based on recommendation(s).

FIG. 16 is a flowchart representative of example machine readable instructions and/or example operations that may be executed by example processor circuitry to implement the gateway circuitry of FIG. 5 to transmit telemetry data to a server.

FIG. 17 is a flowchart representative of example machine readable instructions and/or example operations that may be executed by example processor circuitry to implement the gateway circuitry of FIG. 5 to carry out a recovery operation.

FIG. 18 is a flowchart representative of example machine readable instructions and/or example operations that may be executed by example processor circuitry to implement the gateway circuitry of FIG. 5 to upgrade a device of a process control system.

FIG. 19 is a block diagram of an example processing platform including processor circuitry structured to execute the example machine readable instructions and/or the example operations of FIGS. 6-13 to implement the recommendation engine circuitry of FIG. 3.

FIG. 20 is a block diagram of an example processing platform including processor circuitry structured to execute the example machine readable instructions and/or the example operations of FIGS. 14-18 to implement the gateway circuitry of FIG. 4.

FIG. 21 is a block diagram of an example implementation of the processor circuitry of FIGS. 19 and/or 20.

FIG. 22 is a block diagram of another example implementation of the processor circuitry of FIGS. 19 and/or 20.

FIG. 23 is a block diagram of an example software distribution platform (e.g., one or more servers) to distribute software (e.g., software corresponding to the example machine readable instructions of FIGS. 6-18) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

### DETAILED DESCRIPTION

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

Process control systems (sometimes referred to as industrial control systems) are systems that have the ability to monitor and adjust a process or operation in a process control environment (e.g., a factory, a plant, a refinery, etc.) to achieve a desired output. For example, the desired output can include an assembly and/or manufacturing of a substance (e.g., a chemical substance, composition, or compound), product, or good. In some examples, process control systems may be used to monitor and/or control different aspects of an operation to be conducted or carried out in a process control environment such as, for example, manufacturing components, processing raw chemical materials, etc.

Some process control systems may be controlled and/or otherwise implemented by a distributed control system (DCS). A DCS may include a system of sensors, controllers, and associated electronic or computing devices or systems distributed throughout the process control environment. Individual components of the DCS can be communicatively coupled to one(s) of each other via a process control network, which can be implemented by one or more gateways, switches, bus networks, protocols, etc.

Process control systems are growing increasingly complex as individual components of the process control systems are developed and deployed with increased data acquisition resolution, processing power, and signal conditioning. Process control systems typically contain at least one controller with accompanying inputs and outputs, which allow the controller(s) to control and/or acquire signals from various field devices and/or instruments.

As used herein, the terms “field device” and “instrument” are used interchangeably and refer to assemblies and/or devices (e.g., computing devices, electronic devices, etc.) such as, for example, actuators, actuator assemblies, actuator controllers, actuator positioners, sensors (e.g., rate and/or speed sensors, level sensors, pressure sensors, temperature sensors, etc.), transmitters, valve assemblies, etc., that may be used throughout a process control system to measure and/or control different aspects (e.g., other field devices or process control components) of the process control system. By way of example, a field device such as a valve (e.g., a valve assembly, a fluid flow control assembly, etc.) may include both electrical and mechanical components. The valve may include electrical components such as a digital valve positioner, a flow rate sensor, a pressure sensor, a controller (e.g., a valve controller), etc. The valve may include mechanical components such as an actuator, a housing, a linkage, etc. In some examples, the field device may be a sensor (e.g., a pressure sensor, a temperature sensor, etc.) that monitors a condition or parameter of the valve, such as a pressure, a temperature, etc.

Typically, the designing, commissioning, and operation of a DCS is a manually intensive process. For example, personnel (e.g., developers, engineers, technicians, etc.) may develop a schematic or arrangement of a plurality of field devices and associated equipment to implement a process control system. The personnel may individually and manually configure hardware, software, and/or firmware of the plurality of field devices. The personnel may manually verify whether updates exist for the hardware, software, and/or firmware and manually carry out the updates to the hardware, software, and/or firmware. Typically, the personnel do not have visibility on configurations of similar process control systems and are instead focused on the process control system of which they are associated. Such manual operations and processes may lead to suboptimal operation of the process control system.

Examples disclosed herein include an example application marketplace or electronic commerce (e-commerce) platform for process control systems. In some disclosed examples, the application marketplace is implemented by a service (e.g., a cloud-based service, a Software-as-a-Service (SaaS) platform, etc.) that can be communicatively coupled to a process control system. For example, the process control system can include a gateway device (e.g., an edge gateway, an edge gateway device, etc.) to facilitate communication between the process control system and the application marketplace service. In some disclosed examples, the gateway device can facilitate one-way communication (e.g., from the process control system to the application marketplace service) or two-way communication (e.g., from the process control system to the application marketplace service and vice versa).

In some disclosed examples, the application marketplace service can be an online destination that client electronic devices of a process control system can access, browse, try-out, and/or purchase applications that are designed and/or developed for the process control system. In some disclosed examples, a client electronic device, which can be a laptop, a server, a tablet computer, etc., of a process control system can access the application marketplace service to retrieve new application(s) for deployment to monitor and/or control portion(s) of the process control system. In some disclosed examples, the client electronic device can access the application marketplace service to retrieve new version(s) of previously deployed application(s), hardware configuration(s), firmware, etc.

Examples disclosed herein include machine learning techniques to generate a recommendation based on telemetry data associated with a process control system to improve, update, and/or otherwise change portion(s) of the process control system. In some disclosed examples, an electronic device, such as a gateway, can execute a machine learning model to classify telemetry data collected from a field device into first data with a first data classification and second data with a second data classification. For example, the gateway can determine based on output(s) from the machine learning model that the first data is to be transmitted to a server and the second data is to be stored locally in the process control system based on a policy (e.g., a service level agreement, a data privacy policy, etc.) associated with the process control system. Advantageously, examples disclosed herein can invoke machine learning models to improve portion(s) of the process control system using portion(s) of telemetry data that is/are able to be shared with the machine learning models through adherence to data security and/or privacy policies.

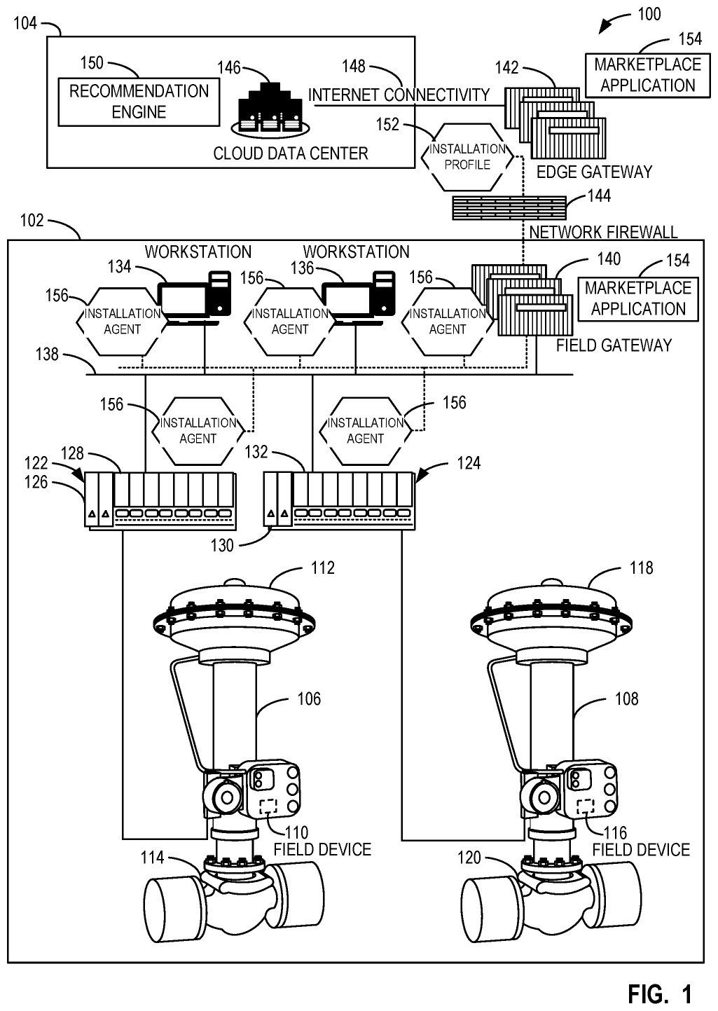

Turning to the figures, the illustrated example of FIG. 1 depicts an example system 100, which includes an example process control system 102 and an example marketplace system 104. The system 100 includes the marketplace system 104 to generate recommendations, which can be based on machine learning techniques, to update and/or otherwise change portion(s) or aspect(s) of the process control system 102 to achieve increased efficiency and/or otherwise improved operation. The process control system 102 of the illustrated example can be used to control and/or monitor process(es), operation(s), etc., in a process control environment, such as a factory, plant, a warehouse (e.g., an automated warehouse), etc.

The process control system 102 includes a first example fluid flow control assembly 106 and a second example fluid flow control assembly 108. The first fluid flow control assembly 106 includes a first example field device 110, a first example actuator 112, and a first example valve 114. The second fluid flow control assembly 108 includes a second example field device 116, a second example actuator 118, and a second example valve 120. The fluid flow control assemblies 106, 108 of the illustrated example are process control valves, which can include a respective one of the actuators 112, 118 and a respective one of the valves 114, 120. In some examples, the actuators 112, 118 can be a pneumatic actuator, a hydraulic actuator, etc. The valves 114, 120 of the illustrated example are butterfly valves. Alternatively, the valves 114, 120 may be any other type of valve, such as a globe valve, a gate valve, a ball valve, a diaphragm valve, a plug valve, a needle valve, an angle valve, etc.

The fluid flow control assemblies 106, 108 of the illustrated example include a respective one of the field devices 110, 116. The field devices 110, 116 of the illustrated example are electronic devices that monitor and/or control physical equipment in the process control environment, such as the fluid flow control assemblies 106, 108. In some examples, the first field device 110 can be a transmitter (e.g., a transmitter interface, a transmitter circuitry, etc.) that can obtain sensor measurements and/or transmit the sensor measurements to an electronic device (e.g., an input/output (I/O) card, a controller, etc.) of the process control system 102. For example, the first field device 110 can be a transmitter associated with a position sensor of the first valve 114, and/or, more generally, the first fluid flow control assembly 106, that can transmit a sensor measurement measured by the position sensor to an electronic device of the process control system 102. In some examples, the second field device 116 can be a transmitter associated with a pressure sensor (e.g., a pressure transducer, a pressure switch, etc.) of the second valve 120, and/or, more generally, the second fluid flow control assembly 108. For example, the second field device 116 can be a transmitter associated with a pressure sensor of the second valve 120, and/or, more generally, the second fluid flow control assembly 108, that can transmit a sensor measurement measured by the pressure sensor to an electronic device of the process control system 102.

The process control system 102 includes a first example programmable logic controller (PLC) rack 122 and a second example PLC rack 124. The first PLC rack 122 includes first example controllers 126 and first example I/O cards 128. The second PLC rack 124 includes second example controllers 130 and second example I/O cards 132. In some examples, one(s) of the first controllers 126 and/or one(s) of the second controllers 130 is/are implemented by processor circuitry as described herein. For example, one(s) of the controllers 126, 130 can be PLC controllers, which can be implemented by an ASIC, FPGA, CPU, etc., and/or any combination(s) thereof. In some examples, one(s) of the first I/O cards 128 and/or one(s) of the second I/O cards 132 is/are implemented by processor circuitry as described herein. For example, one(s) of the I/O cards 128, 132 can be PLC I/O cards, which can be respectively implemented by an ASIC, FPGA, CPU, etc., and/or any combination(s) thereof. In some examples, the I/O cards 128, 132 are electronic devices that convert analog signals from the field devices 110, 116 into digital data that can be provided to the controllers 126, 130. For example, the first I/O cards 128 and the first controllers 126 can be coupled together on a backplane (e.g., a programmable logic controller (PLC) backplane, a backplane chassis, etc.) or backplane system to effectuate communication of data between the first I/O cards 128 and the first controllers 126. In some examples, the second I/O cards 132 and the second controllers 130 can be coupled together on a backplane (e.g., a PLC backplane, a backplane chassis, etc.) or backplane system to effectuate communication of data between the second I/O cards 132 and the second controllers 130. For example, the backplane can be implemented by an electrical and/or communication bus.

In the illustrated example, the first field device 110, and/or, more generally, the first fluid flow control assembly 106, is coupled to one of the first I/O cards 128. In the illustrated example, the second field device 116, and/or, more generally, the second fluid flow control assembly 108, is coupled to one of the second I/O cards 132. In some examples, the I/O cards 128, 132 of the PLC racks 122, 124 can receive and/or otherwise obtain data from the field devices 110, 116. For example, the I/O cards 128, 132 can obtain data, such as sensor measurements obtained by the field devices 110, 116, configuration settings associated with the field devices 110, 116 and/or the fluid flow control assemblies 106, 108, hardware version(s) of hardware of the field devices 110, 116, firmware version(s) of firmware installed on and/or executed by the field devices 110, 116, etc., and/or any combination(s) thereof.

In some examples, the I/O cards 128, 132 of the PLC racks 122, 124 can transmit data to the field devices 110, 116. For example, the I/O cards 128, 132 can transmit data, such as commands, control signals, configuration settings, etc. In some examples, the controllers 126, 128 can obtain data from the I/O cards 128, 132. For example, the controllers 126, 128 can obtain data, such as sensor measurements obtained by the field devices 110, 116, configuration settings associated with the field devices 110, 116 and/or the fluid flow control assemblies 106, 108, hardware version(s) of the field devices 110, 116, hardware version(s) of hardware of the I/O cards 128, 132, firmware version(s) of firmware installed on and/or executed by the field devices 110, 116, firmware version(s) installed on and/or executed by the I/O cards 128, 132, etc., and/or any combination(s) thereof.

The controllers 126, 130 of the illustrated example are in communication with a first example workstation 134 and/or a second example workstation 136 via a first example network 138. For example, the first workstation 134 and/or the second workstation 136 can be a personal computer, a desktop computer, a server, a laptop computer, a mobile device (e.g., a smartphone, a tablet computer, etc.), etc. In some examples, the first workstation 134 and/or the second workstation 136 can execute an application (e.g., a software application, a process control system application, etc.) to control and/or monitor portion(s) of the process control system 102, such as one(s) of the fluid flow control assemblies 106, 108. In some examples, the application can include a graphical user interface (GUI) to facilitate interaction between a user (e.g., an engineer, maintenance personnel, an operator, a supervisor, a technician, etc.) and the process control system 102.

The first network 138 of the illustrated example is a process control network. For example, the first network 138 can be a private network, an enterprise network, a closed network, etc., implemented using any suitable wired and/or wireless network(s) including, for example, one or more data buses (e.g., a data bus implemented by an automation or industrial communication protocol), one or more Local Area Networks (LANs), one or more wireless LANs (WLANs), one or more cellular networks, one or more optical networks, etc. In some examples, the first network 138, or portion(s) thereof, can be implemented by the Internet. In some examples, the first network 138, or portion(s) thereof, can be implemented by a virtual private network (VPN).

The process control system 102 of the illustrated example includes one or more example field gateways 140. One(s) of the field gateways 140 is/are coupled (e.g., communicatively coupled, electrically coupled, etc.) to the first PLC rack 122, the second PLC rack 124, the first workstation 134, and/or the second workstation 136 via the first network 138. In some examples, the field gateways 140 can be implemented by interface circuitry as described herein. For example, the field gateways 140 can be routers that enable electronic devices of the process control system 102, such as the workstations 134, 136, to communicate with example edge gateways 142. In some examples, the field gateways 140 include and/or otherwise effectuate gateway functionality such as modem capabilities. In some examples, one(s) of the field gateways 140 is/are implemented in two or more devices (e.g., a router, a modem, a switch, a firewall, etc.).

One(s) of the field gateways 140 is/are in communication with one(s) of the edge gateways 142 via an example network firewall 144. In some examples, the edge gateways 142 can be implemented by interface circuitry as described herein. For example, the edge gateways 142 can be routers that enable electronic devices of the process control system 102, such as the field gateways 140, to communicate with the marketplace system 104. For example, the edge gateways 142 can effectuate communication between two networks (e.g., a private network implemented by the first network 138 and a public network such as the Internet). In some examples, the edge gateways 142 include and/or otherwise effectuate gateway functionality such as modem capabilities. In some examples, one(s) of the edge gateways 142 is/are implemented in two or more devices (e.g., a router, a modem, a switch, a firewall, etc.).

The network firewall 144 of the illustrated example can be implemented by hardware, software, and/or firmware. For example, the network firewall 144 can be implemented by interface circuitry to receive data; processor circuitry to execute and/or instantiate machine readable instructions to inspect the data; and the processor circuitry to determine whether to transmit the data to another destination based on the data inspection. In some examples, the network firewall 144, or portion(s) thereof, can be included in and/or instantiated by one(s) of the field gateways 140 and/or the edge gateways 142.

One(s) of the edge gateways 142 of the illustrated example is/are in communication with an example cloud data center 146 of the marketplace system 102 via a second example network 148. The second network 148 of the illustrated example is the Internet. For example, the second network 148 can be a public network implemented using any suitable wired and/or wireless network(s) including, for example, one or more LANs, one or more WLANs, one or more cellular networks, one or more optical networks, one or more satellite networks (e.g., a line-of-sight satellite network, a beyond-line-of-site satellite network, etc.), etc. In some examples, the second network 148, or portion(s) thereof, can be implemented by a VPN.

The cloud data center 146 of the illustrated example can be implemented by one or more servers (e.g., electronic servers, computer or computing servers, etc.) managed by a cloud provider (e.g., a public cloud provider, a private cloud provider, etc.). In some examples, the cloud data center 146 can be implemented by virtualizations of the one or more servers, such as virtualized servers, which can include virtualizations of physical compute, memory, storage, security, and/or acceleration hardware.

In some examples, first electronic device(s) of the cloud data center 146 can be server(s), server device(s), or server electronic device(s). In some examples, second electronic device(s) of the process control system 102 can be clients, client device(s), or client electronic device(s). For example, the field devices 110, 116, the controllers 126, 130, the I/O devices 128, 132, the workstations 134, 136, the field gateways 140, and/or the edge gateways 142 can be client electronic device(s). In some examples, the workstations 134, 136 can be server(s), server device(s), or server electronic device(s) and one(s) of the field devices 110, 116, the controllers 126, 130, the I/O devices 128, 132, the field gateways 140, and/or the edge gateways 142 can be client(s), client device(s), or client electronic device(s).

The cloud data center 146, and/or, more generally, the marketplace system 104, includes, instantiates, implements, and/or otherwise causes execution of an example recommendation engine 150. In some examples, the recommendation engine 150 can be implemented by hardware alone or by hardware in combination with software and/or firmware. Thus, for example, the recommendation engine 150 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs).

In some examples, the recommendation engine 150 can generate recommendation(s) to update, upgrade, and/or otherwise change portion(s) of the process control system 102. For example, the recommendation engine 150 can execute a machine learning (ML) model using telemetry data as input(s) to generate output(s), which can include the recommendation(s). In some examples, the recommendation engine 150 obtains telemetry data associated with one(s) of the fluid flow control assemblies 106, 108, the PLC racks 122, 124, the workstations 134, 136, the field gateways 140, and/or the edge gateways 142.

In some examples, the telemetry data can correspond to, be representative of, and/or otherwise include or indicate data (e.g., data values, metadata, information, measurements, configuration settings, etc.) associated with a device (e.g., a mechanical and/or electrical device) of the process control system 102. In some examples, the telemetry data can include quality-related information (e.g., hardware, firmware, and/or software parameters, statistics, etc., hardware reliability data such as mean-time between failure (MTBF) data, etc.), configuration information (e.g., hardware, firmware, and/or software attributes, settings, features, versions, etc.), or any other analytics-based data associated with the device(s) of the process control system 102. As used herein, such quality-related information, configuration information, and/or analytics-based data is generally referred to as telemetry (e.g., telemetry data, telemetry information, etc.).

In some examples, the telemetry data can include a type of software application installed on and/or executed by the first workstation 134, a software version of the software application, etc. In some examples, the telemetry data can include a type and/or quantity of the fluid flow control assemblies 106, 108. For example, the telemetry data can include a make and/or model of the field devices 110, 116, the actuators 112, 118, the valves 114, 120, and/or, more generally, the fluid flow control assemblies 106, 108. In some examples, the telemetry data can include a hardware version of processor circuitry of the field devices 110, 116, a firmware version of firmware utilized by the field devices 110, 116, etc. In some examples, the telemetry data can include a type (e.g., a vendor or manufacturer make and/or model, a model number, a serial number, etc.) of one(s) of the PLC racks 122, 124, the controllers 126, 130, the I/O cards 128, 132, the workstations 134, 136, the field gateways 140, the network firewall 144, and/or the edge gateways 142. In some examples, the telemetry data can include hardware, software, and/or software version(s) of respective hardware, software, and/or firmware of one(s) of the PLC racks 122, 124, the controllers 126, 130, the I/O cards 128, 132, the workstations 134, 136, the field gateways 140, the network firewall 144, and/or the edge gateways 142.

In some examples, the telemetry data can include environmental data associated with the process control system 102, such as weather data (e.g., an ambient air temperature, precipitation conditions, wind speeds, etc.), timestamp data (e.g., a time of day, a day of the week, a day of the month, a day of the year, the current date/time, etc.), etc. In some examples, the telemetry data can include a state of operation (e.g., an operation state) of the process control system 102, or portion(s) thereof. For example, the state of operation can be a design operation state, an installation operation state, a fully operational state (e.g., a fully enabled operational state, a fully deployed operational state, a fully configured operational state, etc.), a maintenance state of operation, a failure state of operation, an upgrade operational state, etc., and/or any combination(s) thereof.

In some examples, the state of operation can be a design operation state in which a design of the process control system 102 is being carried out. In some examples, the state of operation can be an installation operation state in which portion(s) of the process control system 102 is/are being assembled, coupled together, and/or otherwise installed into operational placement. In some examples, the state of operation can be a fully operational state of operation in which the process control system 102 is performing its intended task(s) or function(s). In some examples, the state of operation can be a maintenance state of operation in which portion(s) of the process control system 102 is/are offline for periodic or aperiodic maintenance. In some examples, the state of operation can be a failure state of operation in which portion(s) of the process control system 102 is/are offline due to a failure of one or more devices of the process control system. In some examples, the state of operation can be an upgrade state of operation in which portion(s) of the process control system 102 is/are offline due to being updated, upgraded, modified, and/or otherwise changed.

In some examples, the recommendation engine 150 generates recommendation(s), such as a recommendation to download a new application, update existing firmware of a field device, etc., based on an example installation profile 152 associated with the process control system 102. In some examples, the installation profile 152 can be implemented with data representative of an inventory of device(s) included in the process control system 102. For example, the installation profile 152 can include identifications of the fluid flow control assemblies 106, 108, the PLC racks 122, 124, the workstations 134, 136, the field gateways 140, the network firewall 144, and/or the edge gateways 142, or portion(s) thereof. In some examples, the installation profile 152 can include identifications or indications of type(s) of application(s) utilized by the workstations 134, 136. In some examples, the installation profile 152 can include identifications or determinations of hardware, software, and/or firmware version(s) of hardware, software, and/or firmware of the process control system 102. In some examples, the installation profile 152 can be implemented with data representative of a snapshot of the process control system 102, or portion(s) thereof, at a specific point in time. For example, the snapshot can include identifications of equipment, such as the fluid flow control assemblies 106, 108, hardware versions, software versions, firmware versions, makes/models of the equipment, etc., and/or any combination(s) thereof.

By way of example, the recommendation engine 150, based on a state of operation of the process control system 102, can recommend to a user of the process control system the purchase and installation of specific software, firmware, and/or hardware configuration instances to assist the user during the state of operations described above. For example, the recommendation engine 150 can recommend a design simulation application and license if the process control system 102 is in a design state of operation. In some examples, the recommendation engine 150 can recommend a factory acceptance test simulation application and license if the process control system 102 is in a commissioning state of operation (e.g., a state of operation that includes a factory acceptance test). In some examples, the recommendation engine 150 can recommend an asset management application and license during startup of the process control system 102 to streamline and/or otherwise improve an efficiency of commissioning activities. In some examples, during normal operation of the process control system 102, the recommendation engine 150 can recommend an alarm management application and license if collected telemetry data indicates that the process control system 102 experiences a large number of alarm annunciations per unit time (e.g., a number of alarms per day, or some other specified metric). In some examples, the recommendation engine 150 can recommend application packages and licenses useful for when the process control system 102 is shut down for maintenance and/or otherwise is not in a production state of operation, such as asset maintenance application packages, software upgrade application packages, firmware upgrade application packages, etc. In some examples, if the process control system 102 suffered a safety trip, the recommendation engine 150 can recommend diagnostic software to determine the cause of the safety failure. In some examples, the recommendation engine 150 can recommend application(s), container(s), firmware, hardware configuration(s), etc., to refine and/or otherwise improve aspect(s) of the process control system 102 to achieve improved efficiency, utilization, output, etc.

In some examples, the recommendation engine 150 compiles, generates, and/or instantiates an example marketplace application 154. For example, the recommendation engine 150 can generate an executable binary file that, when executed and/or instantiated by process circuitry, can cause execution of the marketplace application 154 as a service (e.g., an application service, a software service, etc.), an application (e.g., a software application), etc. In some examples, the marketplace application 154 is implemented by a web browser. For example, the marketplace application 154 can be launched by a web browser and the web browser can execute the marketplace application 154 within the web browser. In some examples, the marketplace application 154, or portion(s) thereof, can be implemented as a web browser plug-in.

In the illustrated example, one(s) of the field gateways 140 and one(s) of the edge gateways 142 execute and/or instantiate an instance of the marketplace application 154. In some examples, the field gateways 140 and/or the edge gateways 142 can execute and/or instantiate the marketplace application 154 to effectuate a variety of marketplace associated functions. For example, the field gateways 140 and/or the edge gateways 142 can execute the marketplace application 154 to search an application repository, catalog, or database for application(s) to download and deploy in the process control system 102. In some examples, the field gateways 140 and/or the edge gateways 142 can execute the marketplace application 154 to identify update(s) to hardware, software, and/or firmware associated with the process control system 102.

In some examples, the field gateways 140 and/or the edge gateways 142 can execute and/or instantiate the marketplace application 154 to cause change(s) to portion(s) of the process control system 102. For example, the marketplace application 154 can transmit commands, directions, instructions, etc., to one(s) of example installation agents 156 to effectuate desired or intended changes to the process control system 102. In the illustrated example, the first controllers 126, the second controllers 130, the first workstation 134, the second workstation 136, and/or the field gateways 140 execute an instance of the installation agent 156. In some examples, the installation agents 156 collect and/or otherwise obtain telemetry data associated with an electronic device on which they are executed and/or instantiated by. For example, the installation agent 156 of the first controllers 126, and/or, more generally, the first PLC rack 122, can collect and/or otherwise obtain telemetry data associated with the first controllers 126, the first I/O cards 128, the first field device 110, etc. In some examples, the installation agent 156 reports (e.g., periodically reports, aperiodically reports, etc.) installed software components and licensing to one(s) of the field gateways 140. In some examples, the one(s) of the field gateways 140 can report the installed software components and licensing to the cloud data center 146 via one(s) of the edge gateways 142.

In some examples, the installation agent 156 can be implemented by hardware alone or by hardware in combination with software and/or firmware. Thus, for example, the installation agent 156 could be implemented by processor circuitry, analog circuit(s), digital circuit(s), logic circuit(s), programmable processor(s), programmable microcontroller(s), GPU(s), DSP(s), ASIC(s), PLD(s), and/or FPLD(s).

By way of example, a first one of the field gateways 140 can execute an instance of the marketplace application 154 to access an application catalog hosted and/or otherwise maintained by the cloud data center 146. The first one of the field gateways 140 can select an application in the application catalog for download via the marketplace application 154. For example, the selected application can be a diagnostic tool to evaluate whether the first field device 110 is operating correctly or as expected. After the selection, the cloud data center 146 can cause a download of the application to the first one of the field gateways 140 for execution (e.g., local execution to the first one of the field gateways 140). For example, the first one of the field gateways 140 can invoke the installation agent 156 to install the application and/or run the application after installation. Advantageously, the first one of the field gateways 140 can execute the downloaded application to perform a diagnostic function, operation, etc., that the process control system 102 previously could not perform but for the downloaded application.

By way of another example, the cloud data center 146 can provide telemetry data associated with the first field device 110 to the recommendation engine 150. The recommendation engine 150 can execute an ML model with the telemetry data as input(s) (e.g., model input(s), ML input(s), ML model input(s), etc.) to generate output(s) (e.g., model output(s), ML output(s), ML model output(s), etc.), which can include a recommendation of an application to be downloaded to the process control system 102. For example, the recommendation engine 150 can determine that the first field device 110 is a transmitter associated with a pressure sensor; the transmitter is associated with a diagnostic application stored in an application catalog hosted by the cloud data center 146; and that the diagnostic application is not present in the process control system 102. Based on the determinations, the recommendation engine 150 can generate a recommendation that identifies the diagnostic application as applicable and/or compatible with the first field device 110. The recommendation engine 150 can push and/or otherwise transmit the recommendation to a first one of the field gateways 140. The first one of the field gateways 140 can launch the marketplace application 154 to analyze the recommendation. The first one of the field gateways 140 can determine to download the diagnostic application identified by the recommendation. The first one of the field gateways 140 can download the diagnostic application and cause an installation of the diagnostic application on at least one of the first workstation 134 or the second workstation 136. For example, the first workstation 134 can invoke a local instance of the installation agent 156 to install the diagnostic application and/or run the diagnostic application after installation. Advantageously, the at least one of the first workstation 134 or the second workstation 136 can execute the diagnostic application to perform a diagnostic function, operation, etc., that the process control system 102 previously could not perform but for the diagnostic application recommended by the recommendation engine 150.

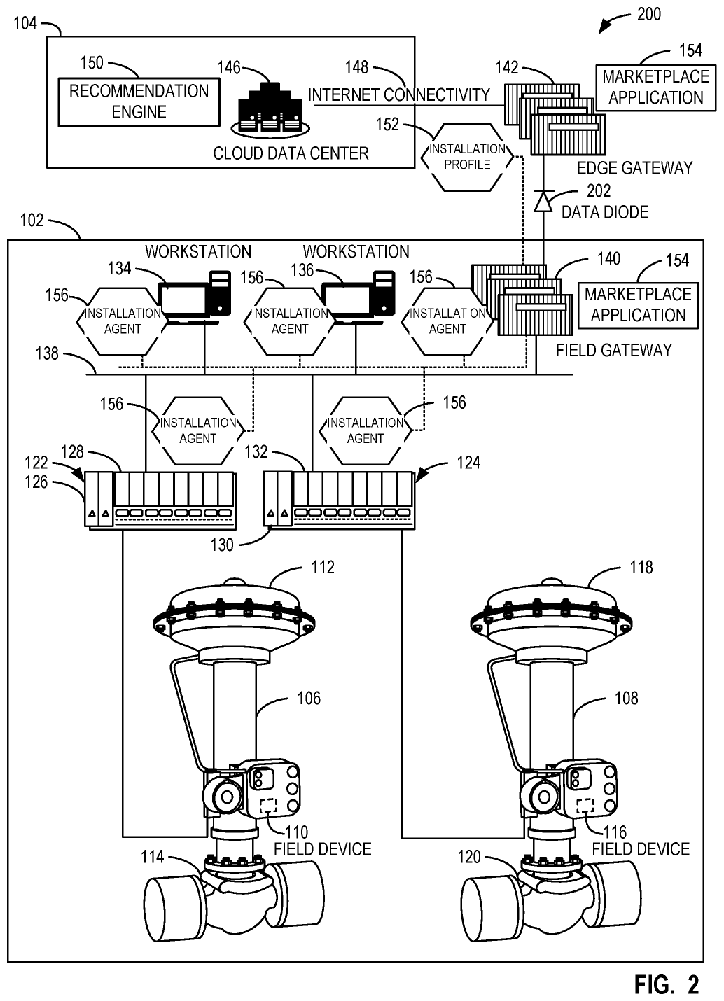

FIG. 2 depicts a second example system 200 including the process control system 102, the marketplace system 104, and the edge gateways 142 of FIG. 1. The second system 200 includes an example data diode 202. The data diode 202 is a unidirectional network communication device that enables one-way transfer of data between segmented networks, such as the first network 138 and the second network 148. In some examples, the data diode 202 is implemented by hardware (e.g., a hardware-based device) with two nodes or circuits (e.g., a first node/circuit to only transmit data and a second node/circuit to only receive data) that allow the flow of data in only one direction. In some examples, the data diode 202 is implemented by software (e.g., a software appliance, a software service, a software application, etc.). In some examples, the data diode 202 is implemented by a combination of hardware, software, and/or firmware. Advantageously, the second system 200 can achieve enhanced security and reduced access to the process control system 102 by enforcing the flow of data in only one direction by utilizing the data diode 202.

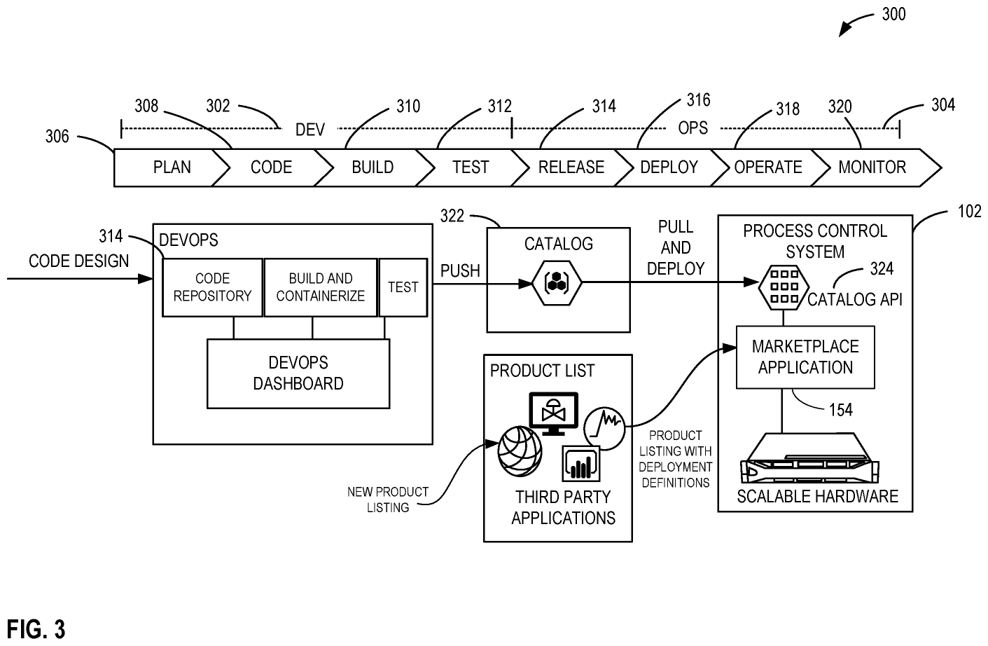

FIG. 3 depicts an example workflow 300 to effectuate the example marketplace system 102 of FIGS. 1 and/or 2. The workflow 300 includes a first example stage 302 and a second example stage 304. The first stage 302 is a development stage (identified by DEV) and the second stage 304 is an operational stage (identified by OPS). For example, the first stage 302 can correspond to the planning, coding, building, and/or testing of an application for execution in the process control system 102 of FIGS. 1 and/or 2. In some examples, the second stage 304 can correspond to the release, deployment, operation, and/or monitoring of the application.

The first stage 302 includes a first example substage 306, a second example substage 308, a third example substage 310, and a fourth example substage 312. The first substage 306 is a plan or planning substage (or phase/subphase). For example, the planning stage can correspond to development of an application architecture, a technical requirement or specification, etc., of the application. The second substage 308 is a code or coding substage. For example, the coding stage can correspond to the developing of pseudocode, human-readable code, and/or machine-readable code (e.g., compiled code). In some examples, the pseudocode, the human-readable code, and/or the machine-readable code can be stored in an example code repository 314. The third substage 310 corresponds to a build or building substage. For example, the building stage can correspond to compiling and/or otherwise assembling portion(s) of an application into an executable construct, such as a web browser plugin, an executable file, etc. In some examples, the building stage can include containerizing portion(s) of an application, which can include segmenting the portion(s) of the application into one or more containers (e.g., virtual containers, containerized applications, etc.). The fourth substage 312 corresponds to a test or testing substage. For example, the testing phase can correspond to performing quality review and/or quality control of a built application and/or built container(s).

The second stage 304 includes a fifth example substage 314, a sixth example substage 316, a seventh example substage 318, and a seventh example substage 320. The fifth substage 314 is a release or releasing substage. For example, the fifth substage 314 can correspond to pushing tested application(s)/container(s) into an example catalog 322. In some examples, the catalog 322 can be implemented by a datastore, a database, a data repository, etc., that can store application(s)/container(s) and can facilitate retrieval of the application(s)/container(s) by the marketplace application 154 of FIGS. 1 and/or 2.

The sixth substage 316 is a deploy or deployment substage. For example, the deployment stage can correspond to pushing (e.g., pushing based on a recommendation) application(s)/container(s) from the catalog 322 to electronic device(s) of the process control system 102, such as the first workstation 134 and/or the second workstation 136 of FIGS. 1 and/or 2. In some examples, the deployment stage can correspond to electronic device(s) of the process control system 102 downloading application(s)/container(s) from the catalog 322.

The seventh substage 318 is an operate, operation, or operational substage. For example, the operational stage can correspond to the process control system 102 operating in a typical or fully operational state of operation. In some examples, the operational stage can correspond to the marketplace application 154 accessing the catalog 322 via an example catalog application programming interface (API) 324. For example, the marketplace application 154 (e.g., a user interfacing with the marketplace application 154) can browse, view, research, etc., application(s)/container(s) (e.g., third party applications or applications not developed by the cloud data center 146, applications provided by the cloud data center 146, etc.). In some examples, the marketplace application 154 can review, inspect, etc., a product listing of the catalog 322 that includes deployment definitions, which can include firmware/software versions, hardware/software/firmware computability requirements, etc., associated with the application(s)/container(s) in the catalog 322.

The eighth substage 320 is a monitor or monitoring substage. For example, the monitoring substage can correspond to the process control system 102 executing (e.g., locally executing within the process control system 102) application(s)/container(s) from the catalog 322 and transmitting telemetry data to the cloud data center 146 for ingestion by the recommendation engine 150. In some examples, the monitoring substage can correspond to the recommendation engine 150 executing an ML model to generate output(s) based on the telemetry data. For example, the output(s) can include a recommendation such as downloading a new version of a previously downloaded application/container from the catalog 322, downloading a newly available application/container (e.g., a beta version, a final release version, etc.) from the catalog 322 for execution in the process control system 102.

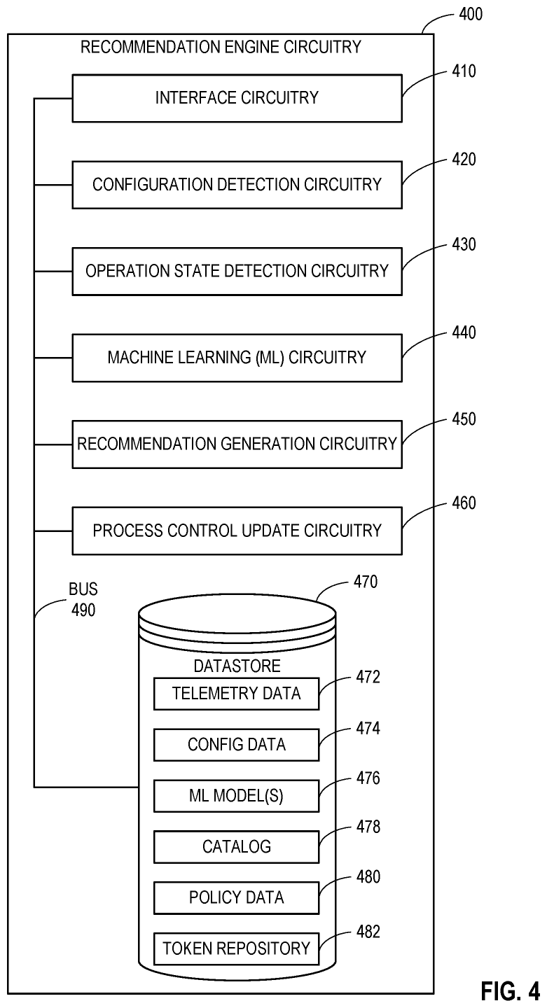

FIG. 4 is a block diagram of recommendation engine circuitry 400 to generate a recommendation to change portion(s) of the process control system 102 for increased efficiency and/or otherwise improved operation of the process control system 102. In some examples, the recommendation engine 150 of FIGS. 1 and/or 2 can be implemented by the recommendation engine circuitry 400.

The recommendation engine circuitry 400 of FIG. 4 may be instantiated (e.g., creating an instance of, bring into being for any length of time, materialize, implement, etc.) by processor circuitry such as a central processing unit executing instructions. Additionally or alternatively, the recommendation engine circuitry 400 of FIG. 4 may be instantiated (e.g., creating an instance of, bring into being for any length of time, materialize, implement, etc.) by an ASIC or an FPGA structured to perform operations corresponding to the instructions. It should be understood that some or all of the recommendation engine circuitry 400 of FIG. 4 may, thus, be instantiated at the same or different times. Some or all of the recommendation engine circuitry 400 of FIG. 4 may be instantiated, for example, in one or more threads executing concurrently on hardware and/or in series on hardware. Moreover, in some examples, some or all of the recommendation engine circuitry 400 of FIG. 4 may be implemented by microprocessor circuitry executing instructions to implement one or more virtual machines and/or containers.

The recommendation engine circuitry 400 of FIG. 4 includes example interface circuitry 410, example configuration detection circuitry 420, example operation state detection circuitry 430, example machine learning (ML) circuitry 440, example recommendation generation circuitry 450, example process control update circuitry 460, an example datastore 470, and an example bus 490. In this example, the datastore 470 stores and/or otherwise includes example telemetry data 472, example configuration data 474 (identified by CONFIG DATA), example ML model(s) 476, an example catalog 478, example policy data 480, and an example token repository 482. In the illustrated example of FIG. 4, the interface circuitry 410, the configuration detection circuitry 420, the operation state detection circuitry 430, the ML circuitry 440, the recommendation generation circuitry 450, the process control update circuitry 460, and/or the datastore 470 are in communication with one(s) of each other via the bus 490. For example, the bus 490 can be implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally or alternatively, the bus 490 can be implemented by any other type of computing or electrical bus.

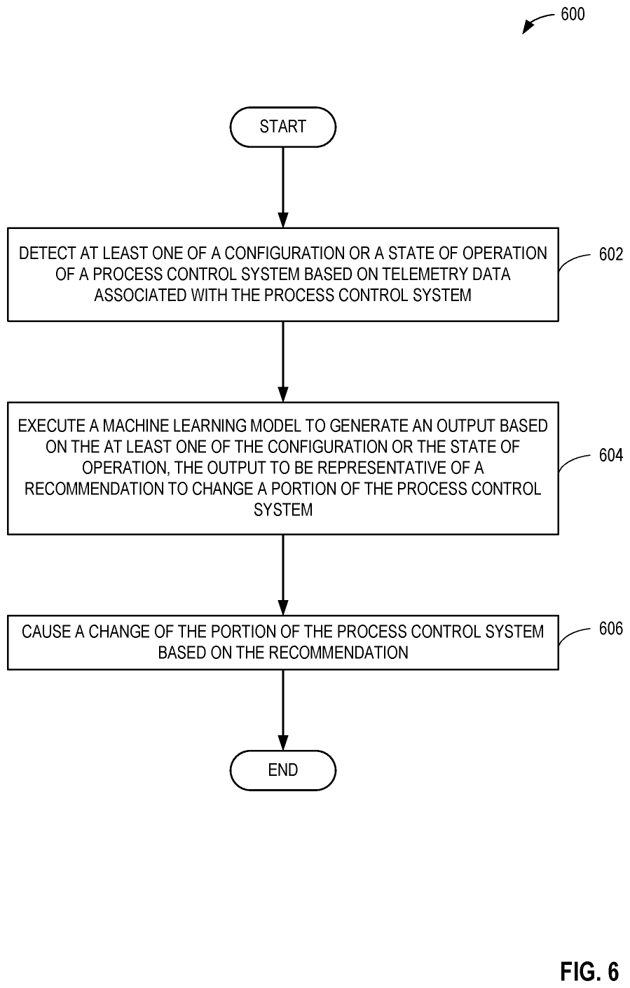

The recommendation engine circuitry 400 of the illustrated example includes the interface circuitry 410 to obtain data and/or transmit data. In some examples, the interface circuitry 410 is instantiated by processor circuitry executing interface instructions and/or configured to perform operations such as those represented by the flowcharts of FIGS. 6, 7, 8, 9, 10, 11, 12, and/or 13.

In some examples, the interface circuitry 410 obtains data, such as telemetry data, from the process control system 102. For example, the interface circuitry 410 can obtain telemetry data from one(s) of the edge gateways 142 and/or one(s) of the field gateways 154. In some examples, the telemetry data is associated with the field devices 110, 116, the PLC racks 122, 124, the workstations 134, 136, the field gateways 140, and/or the edge gateways 142. In some examples, the interface circuitry 410 can obtain telemetry data, such as data indicative of an access of an application in the catalog 478, by a client electronic device (e.g., the workstations 134, 136, the field gateways 140, the edge gateways 142, the PLC racks 122, 124, the field devices 110, 116, etc.) of the process control system.

In some examples, the interface circuitry 410 obtains the telemetry data 472, which can include control system performance data of the process control system 102. For example, the control system performance data can include diagnostic data associated with the PLC racks 122, 124 such as a number of messages processed per second, a number of interrupts handled, a utilization parameter (e.g., a percentage of a CPU being utilized, a percentage of memory or mass storage being utilized, etc.), etc. Advantageously, such control system performance data can enable the ML circuitry 440 to analyze performance issues within the process control system 102 and recommend applications, products, services, etc., to mitigate and/or resolve the detected performance issues.

In some examples, the interface circuitry 410 obtains the telemetry data 472, which can include usage data for improvements of products or sales funnel conversion to improve marketing strategies associated with the products to increase conversion rates. For example, the usage data can be based on the control system performance data or any other data associated with usage of portion(s) of the process control system 102. In some examples, the usage data can be utilized to improve products offered for use or sale by the marketplace system 104. In some examples, the usage data can be used as input(s) to the ML model(s) 476 to generate output(s), which can include a sales conversion funnel. In some examples, the sales conversion funnel is a visual representation of the stages associated with a journey of a user of the process control system 102 such as landing on a webpage or browser page of the marketplace application 154 and completing a purchase through the marketplace application 154. Advantageously, the sales conversion funnel can be used to improve marketing strategies associated with the products offered for use or sale by the marketplace system 104 to increase and/or otherwise improve conversion rates (e.g., sales conversion rates).

In some examples, the interface circuitry 410 obtains the telemetry data 472, which can include power diagnostic data associated with the process control system 102. For example, the power diagnostic data can be data associated with battery powered wireless instruments, or traditional power supplies used in fixed installations. Power subsystems can be monitored by the ML circuitry 440 whereby smart power systems in the process control system 102 that are visible to the cloud data center 146 may be monitored for operational health as well as detection of a potential overload or greater-than-allowed utilization of a power supply. Advantageously, the recommendation generation circuitry 450 can output a recommendation of a greater capacity power supply or facility to extend the power supply functionality for elements and instruments in the process control system 102. Advantageously, the ML circuitry 440, and/or, more generally, the recommendation engine circuitry 400, can perform such power diagnostic monitoring to detect and address power surges and potential damage caused by ground loops, lightning strikes, or other electrical phenomena.

In some examples, the interface circuitry 410 can obtain an application and/or container from a developer for execution by the process control system 102. For example, the interface circuitry 410 can obtain an application and/or container from a content generation source (e.g., a third party developer) different from the cloud data center 146.

In some examples, the interface circuitry 410 transmits data, such as application(s) and/or container(s) to an electronic device, such as the edge gateways 142. For example, the interface circuitry 410 can determine that a request for recovery of the process control system 102 has been received after a failure of portion(s) of the process control system 102. In some examples, the interface circuitry 410 can distribute and/or otherwise transmit application(s) to the process control system 102 to cause a recovery of the process control system 102 after the failure or non-responsiveness of the portion(s) of the process control system 102.

In some examples, the interface circuitry 410 can determine that a request to access an application is received. For example, the marketplace application 154 of the field gateways 140 can request to access an application from the catalog 322, which can be implemented by the catalog 478 of FIG. 4. Advantageously, the marketplace application 154 can be executed to filter applications in the catalog 322 based on a current or installed version of hardware, software, and/or firmware of the process control system 102. Advantageously, the marketplace application 154 can ensure that selected applications are to be compatible with the process control system 102. In some examples, the interface circuitry 410 can obtain the request from the marketplace application 154 of the field gateways 140 and cause a download of the application to a client electronic device (e.g., the workstations 134, 136, the field gateways 140, the edge gateways 142, the PLC racks 122, 124, the field devices 110, 116, etc.) of the process control system 100 for local execution.

In some examples, the interface circuitry 410 can transmit data, such as alerts, announcements, messages, notices, notifications, etc., to the marketplace application 154 of a device, such as the edge gateways 142 and/or the field gateways 140. For example, the alerts can be indicative of an availability of software licenses that are not deployed in the process control system 102. In some examples, the alerts can be indicative of an availability of newer or updated versions of software licenses deployed in the process control system 102. In some examples, the alerts can be indicative of an availability of a beta version (or pre-released version) of an application and/or container to user(s) of the process control system 102 who opted-in to receive beta version alerts. For example, such users may inquire or demonstrate interest in unreleased software to give the cloud data center 146 a mechanism to gauge market acceptance of new techniques, concepts, or strategies prior to developing the released software. In some examples, the marketplace application 154 can present advertisements (e.g., paid advertisements) to end users to promote and/or describe products such as software or services made available through the marketplace application 154.

In some examples, the interface circuitry 410 determines whether to continue monitoring the process control system 102. For example, the interface circuitry 410 can determine whether to continue requesting and/or collecting telemetry data associated with the process control system 102. In some examples, the interface circuitry 410 can determine whether there is new and/or otherwise unprocessed telemetry data associated with the process control system 102 to obtain for ingestion by the ML circuitry 440 as described herein.

The recommendation engine circuitry 400 of the illustrated example includes the configuration detection circuitry 420 to detect a configuration of the process control system 102 based on telemetry data associated with the process control system 102. In some examples, the configuration detection circuitry 420 is instantiated by processor circuitry executing configuration detection instructions and/or configured to perform operations such as those represented by the flowcharts of FIGS. 6, 7, 8, 9, 10, 11, 12, and/or 13.

In some examples, the interface circuitry 410 can obtain telemetry data that can include a configuration of the process control system 102; and store the configuration as the configuration data 474 in the datastore 470. In some examples, the configuration detection circuitry 420 can determine that the configuration of the process control system 102 incudes a quantity and/or type of components of the process control system, such as a quantity and/or type of the fluid flow control assemblies 106, 108, the field devices 110, 116, the PLC racks 122, 124, the workstations 134, 136, the field gateways 140, the edge gateways 142, etc. In some examples, the configuration detection circuitry 420 can determine that the configuration of the process control system 102 incudes specific hardware, software, and/or firmware versions associated with components of the process control system, such as hardware, software, and/or firmware versions associated with the fluid flow control assemblies 106, 108, the field devices 110, 116, the PLC racks 122, 124, the workstations 134, 136, the field gateways 140, the edge gateways 142, etc. In some examples, the configuration detection circuitry 420 can determine that the configuration of the process control system 102 incudes makes, models, vendor identifiers, manufacturing serial numbers, etc., associated with the fluid flow control assemblies 106, 108, the field devices 110, 116, the PLC racks 122, 124, the workstations 134, 136, the field gateways 140, the edge gateways 142, etc.

In some examples, the configuration detection circuitry 420 can detect and/or otherwise determine that the process control system 102 has recovered from a failure or non-responsive condition. For example, the configuration detection circuitry 420 can determine, based on telemetry data from previously identified failed or non-responsive components, that the previously identified failed/non-responsive components are operational and/or otherwise performing in an expected manner.

In some examples, the configuration detection circuitry 420 can identify a different process control system than the process control system 102 of FIG. 1 based on a configuration of the process control system 102 of FIG. 1. For example, the configuration detection circuitry 420 can determine that a first configuration in the configuration data 474 associated with the process control system 102 of FIG. 1 is similar (e.g., matches, partially matches, etc.) to a second configuration in the configuration data 474 associated with a different process control system (e.g., a process control system that is in communication with the cloud data center 146). For example, the configuration detection circuitry 420 can identify application(s), container(s), hardware version(s), software version(s), firmware version(s), etc., associated with the different process control system. Advantageously, the ML circuitry 440 can generate recommendations for the process control system 102 based on the second configuration. For example, the ML circuitry 440 can execute the ML model(s) 476 to identify aspect(s) of the process control system 102 of FIG. 1 based on updates, improvements, changes, etc., that the different process control system underwent.

The recommendation engine circuitry 400 of the illustrated example includes the operation state detection circuitry 430 to detect a state of operation of the process control system 102 based on telemetry data associated with the process control system 102. In some examples, the operation state detection circuitry 430 is instantiated by processor circuitry executing operation state detection instructions and/or configured to perform operations such as those represented by the flowcharts of FIGS. 6, 7, 8, 9, 10, 11, 12, and/or 13. For example, the operation state detection circuitry 430 can detect that the process control system 102 is in a design operation state, an installation operation state, a fully operational state, a maintenance state of operation, a failure state of operation, an upgrade operational state, etc., and/or any combination(s) thereof.

The recommendation engine circuitry 400 of the illustrated example includes the ML circuitry 440 to execute an ML model based on ML input(s) to generate ML output(s). In some examples, the ML circuitry 440 is instantiated by processor circuitry executing ML instructions and/or configured to perform operations such as those represented by the flowcharts of FIGS. 6, 7, 8, 9, 10, 11, 12, and/or 13.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the ML model(s) 476 may be trained with data to recognize patterns and/or associations and follow such patterns and/or associations when processing input data such that other input(s) result in output(s) consistent with the recognized patterns and/or associations.

Many different types of machine-learning models and/or machine-learning architectures exist. In some examples, the ML circuitry 440 generates the ML model(s) 476 as neural network model(s). The ML circuitry 440 may invoke the interface circuitry 410 to transmit the ML model(s) 476 to an external computing or electronic system. Using a neural network model enables the ML circuitry 440 to execute an AI/ML workload. In general, machine-learning models/architectures that are suitable to use in the example approaches disclosed herein include recurrent neural networks. However, other types of machine learning models could additionally or alternatively be used such as supervised learning ANN models, clustering models, classification models, etc., and/or a combination thereof. Example supervised learning ANN models may include two-layer (2-layer) radial basis neural networks (RBN), learning vector quantization (LVQ) classification neural networks, etc. Example clustering models may include k-means clustering, hierarchical clustering, mean shift clustering, density-based clustering, etc. Example classification models may include logistic regression, support-vector machine or network, Naive Bayes, etc. In some examples, the ML circuitry 440 may compile and/or otherwise generate one(s) of the ML model(s) 476 as lightweight machine-learning models.

In general, implementing an ML/AI system involves two phases, a learning/training phase and an inference phase. In the learning/training phase, a training algorithm is used to train the ML model(s) 476 to operate in accordance with patterns and/or associations based on, for example, training data. In general, the ML model(s) 476 include(s) internal parameters that guide how input data is transformed into output data, such as through a series of nodes and connections within the ML model(s) 476 to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, the ML circuitry 440 may invoke supervised training to use inputs and corresponding expected (e.g., labeled) outputs to select parameters (e.g., by iterating over combinations of select parameters) for the ML model(s) 476 that reduce model error. As used herein, “labeling” refers to an expected output of the machine learning model (e.g., a classification, an expected output value, etc.). Alternatively, the ML circuitry 440 may invoke unsupervised training (e.g., used in deep learning, a subset of machine learning, etc.) that involves inferring patterns from inputs to select parameters for the ML model(s) 476 (e.g., without the benefit of expected (e.g., labeled) outputs).

In some examples, the ML circuitry 440 trains the ML model(s) 476 using unsupervised clustering of operating observables. For example, the operating observables may include a vendor identifier, a media access control (MAC) address, a serial number, a hardware version, a software version, a firmware version, a state of operation, a configuration, etc., associated with a process control system). However, the ML circuitry 440 may additionally or alternatively use any other training algorithm such as stochastic gradient descent, Simulated Annealing, Particle Swarm Optimization, Evolution Algorithms, Genetic Algorithms, Nonlinear Conjugate Gradient, etc.

In some examples, the ML circuitry 440 may train the ML model(s) 476 until the level of error is no longer reducing. In some examples, the ML circuitry 440 may train the ML model(s) 476 locally on the cloud data center 146 and/or remotely at an external computing system communicatively coupled to the cloud data center 146. In some examples, the ML circuitry 440 trains the ML model(s) 476 using hyperparameters that control how the learning is performed (e.g., a learning rate, a number of layers to be used in the machine learning model, etc.). In some examples, the ML circuitry 440 may use hyperparameters that control model performance and training speed such as the learning rate and regularization parameter(s). The ML circuitry 440 may select such hyperparameters by, for example, trial and error to reach an optimal model performance. In some examples, the ML circuitry 440 utilizes Bayesian hyperparameter optimization to determine an optimal and/or otherwise improved or more efficient network architecture to avoid model overfitting and improve the overall applicability of the ML model(s) 476. Alternatively, the ML circuitry 440 may use any other type of optimization. In some examples, the ML circuitry 440 may perform re-training. The ML circuitry 440 may execute such re-training in response to override(s) by a user of the cloud data center 146, a receipt of new training data, etc.

In some examples, the ML circuitry 440 facilitates the training of the ML model(s) 476 using training data. In some examples, the ML circuitry 440 utilizes training data that originates from locally generated data. In some examples, the ML circuitry 440 utilizes training data that originates from externally generated data, such as the telemetry data 472. In some examples where supervised training is used, the ML circuitry 440 may label the training data (e.g., label training data or portion(s) thereof as having a first data classification, a second data classification, etc.). Labeling is applied to the training data by a user manually or by an automated data pre-processing system. In some examples, the ML circuitry 440 may pre-process the training data using the interface circuitry 410 to parse and/or otherwise inspect data of interest of the telemetry data 472. In some examples, the ML circuitry 440 sub-divides the training data into a first portion of data for training the ML model(s) 476, and a second portion of data for validating the ML model(s) 476.

Once training is complete, the ML circuitry 440 may deploy the ML model(s) 476 for use as an executable construct that processes an input and provides an output based on the network of nodes and connections defined in the ML model(s) 476. The ML circuitry 440 may store the ML model(s) 476 in the datastore 470. In some examples, the ML circuitry 440 may invoke the interface circuitry 410 to transmit the ML model(s) 476 to one(s) of external computing systems. In some such examples, in response to transmitting the ML model(s) 476 to the one(s) of the external computing systems, the one(s) of the external computing systems may execute the ML model(s) 476 to execute AI/ML workloads with at least one of improved efficiency or performance.

Once trained, the deployed one(s) of the ML model(s) 476 may be operated in an inference phase to process data. In the inference phase, data to be analyzed (e.g., live data) is input to the ML model(s) 476, and the ML model(s) 476 execute(s) to create an output. This inference phase can be thought of as the AI “thinking” to generate the output based on what it learned from the training (e.g., by executing the ML model(s) 476 to apply the learned patterns and/or associations to the live data). In some examples, input data undergoes pre-processing before being used as an input to the ML model(s) 476. Moreover, in some examples, the output data may undergo post-processing after it is generated by the ML model(s) 476 to transform the output into a useful result (e.g., a display of data, a detection and/or identification of an object, an instruction to be executed by a machine, etc.).

In some examples, output of the deployed one(s) of the ML model(s) 476 may be captured and provided as feedback. By analyzing the feedback, an accuracy of the deployed one(s) of the ML model(s) 476 can be determined. If the feedback indicates that the accuracy of the deployed model is less than a threshold or other criterion, training of an updated model can be triggered using the feedback and an updated training data set, hyperparameters, etc., to generate an updated, deployed model.

In some examples, the ML circuitry 440 executes the ML model(s) 476 to generate output(s) based on the at least one of the configuration data 474 or the state of operation of the process control system 102. In some examples, the output(s) is/are representative of a recommendation to change portion(s) of the process control system 102. In some examples, the output(s) is/are representative of data classifications of the telemetry data 472. For example, the ML circuitry 440 can determine that a first portion of the telemetry data 472 can be classified with a first data classification and a second portion of the telemetry data 472 can be classified with a second data classification. In some examples, data associated with the first data classification can be excluded from recommendation generation based on and/or specified by the policy data 480. In some examples, data associated with the second data classification can be included and/or otherwise opted-into recommendation generation based on and/or specified by the policy data 480.

The recommendation engine circuitry 400 of the illustrated example includes the recommendation generation circuitry 450 to generate a recommendation to change portion(s) of the process control system 102. In some examples, the recommendation generation circuitry 450 is instantiated by processor circuitry executing recommendation generation instructions and/or configured to perform operations such as those represented by the flowcharts of FIGS. 6, 7, 8, 9, 10, 11, 12, and/or 13.

In some examples, the recommendation generation circuitry 450 can identify change(s) to the process control system 102 based on a configuration of the process control system 102. For example, the recommendation generation circuitry 450 can identify a first application run by the first workstation 134. In some examples, the recommendation generation circuitry 450 can generate a recommendation to run a second application that is associated with the first application. For example, the first application can be used to monitor and/or control a type of valve and the second application can be a software package (e.g., an add-on software package) to troubleshoot and/or otherwise perform diagnostic functions on the type of valve. In some examples, the second application can be software infrastructure such as a VPN, a firewall, a software data diode (e.g., a software-based or implemented data diode), etc., and/or any combination(s) thereof. For example, the recommendation generation circuitry 450 can recommend a deployment of at least one of a VPN, a firewall, or a software data diode and cause the process control update circuitry 460 to deploy the at least one of the VPN, the firewall, or the software data diode.

In some examples, the recommendation generation circuitry 450 can determine that the change(s) to the process control system 102 are associated with a monetary cost. For example, the recommendation generation circuitry 450 can determine that the monetary cost is based on an identification of a customer or user of the process control system 102, a service level agreement associated with the process control system 102, predefined pricing specified by a sales agreement or contract associated with the process control system 102, etc.

In some examples, the recommendation generation circuitry 450 can identify change(s) to the process control system 102 based on a configuration of a different process control system. For example, the recommendation generation circuitry 450 can generate a recommendation for the process control system 102 to download an application based on the different process control system utilizing the application in a similar manner, context, configuration etc., to the process control system 102. In some examples, the recommendation generation circuitry 450 can generate a recommendation to access a support service (e.g., an automated or live technical support service) associated with the recommended application.

In some examples, the recommendation generation circuitry 450 generates a recommendation based on a state of operation of the process control system. For example, the recommendation generation circuitry 450 can generate a recommendation of application(s), container(s), etc., associated with a process control system in a design operation state, a fully enabled operation state, a maintenance operation state, etc. In some examples, the recommendation generation circuitry 450 can generate a recommendation to access a support service (e.g., an automated or live technical support service) associated with the recommended application(s), container(s), etc.

In some examples, the recommendation generation circuitry 450 causes sale(s) of physical products associated with the process control system 102. For example, the recommendation generation circuitry 450 can determine that a new model or version of the first controllers 126 is available that may be more capable and/or able to address a detected, known, or observed control performance issue. Advantageously, the new model/version of the first controllers 126 can be ordered through the marketplace application 154 and shipped to the customer account address associated with the process control system 102. By way of another example, the recommendation generation circuitry 450 can determine that the first workstation 134 is identified as end-of-life (EOL) and is no longer supported. The recommendation generation circuitry 450 can identify a new model or version of the first workstation 134 is available that is compatible with the requirements, specifications, etc., of the process control system 102. In some examples, the recommendation generation circuitry 450 can generate a customization of the new model/version of the first workstation 134 to ensure that the new model/version conforms or satisfies the form factor, features, functionality, etc., needed to operate the process control system 102. Advantageously, the new model/version of the first workstation 134 can be ordered through the marketplace application 154 and shipped to the customer account address associated with the process control system 102. In some examples, the recommendation generation circuitry 450 can generate a recommendation to access a support service (e.g., an automated or live technical support service) associated with physical products already installed in the process control system 102 and/or selected physical products for deployment in the process control system 102.

In some examples, the recommendation generation circuitry 450 can identify new and/or improved deployments of a safety instrumented system (SIS) to the process control system 102. For example, an SIS can be hardware, software, and/or firmware that can be executed and/or instantiated to transition the process control system 102, or portion(s) thereof, to a safe state when predetermined conditions are violated or breached. Advantageously, the recommendation generation circuitry 450 can recommend an SIS based on an output from the ML circuitry 440, which can be representative of an analysis of a configuration of the process control system 102. For example, the recommendation generation circuitry 450 can generate a recommendation including a configuration and/or deployment of an SIS in the process control system 102 based on the telemetry data 472 associated with the process control system 102.

In some examples, the recommendation generation circuitry 450 can identify improvements to computer or electronic security of the process control system 102. For example, the recommendation generation circuitry 450 can identify a lack of security appliances (e.g., physical security appliances such as a hardware firewall or data diode, virtual security appliances such as a software firewall, data diode, or network intrusion application, etc.). Advantageously, available security appliances to improve security of the process control system 102 can be ordered through the marketplace application 154 and either shipped to the customer account address associated with the process control system 102 and/or made available for download to the process control system 102.

In some examples, the recommendation generation circuitry 450 can identify security improvements by managing computing or electronic assets associated with the process control system 102. For example, the recommendation generation circuitry 450 can generate an inventory of electronic devices associated with the process control system 102; identify recommended security actions associated with the electronic devices; and output a security report representative of the recommended security actions and/or security hardware, software, and/or firmware for purchase through the marketplace application 154.

The recommendation engine circuitry 400 of the illustrated example includes the process control update circuitry 460 to cause change(s) to portion(s) of the process control system 102. In some examples, the change(s) is/are based on recommendation(s) generated by the recommendation generation circuitry 450. In some examples, the process control update circuitry 460 is instantiated by processor circuitry executing process control update instructions and/or configured to perform operations such as those represented by the flowcharts of FIGS. 6, 7, 8, 9, 10, 11, 12, and/or 13.

In some examples, the process control update circuitry 460 can determine that a recommendation is to be implemented without intervention (e.g., user, human, or manual intervention) based on the policy data 480. For example, the policy data 480 can include a policy, a service level agreement (SLA), a maintenance agreement, a monitoring agreement, etc., associated with the process control system 102. In some examples, the policy, the SLA, etc., can define a manner in which changes to the process control system 102 can be carried out. For example, the policy, the SLA, etc., can define that a recommendation, such as an upgrade in a software version of an application, can be carried out automatically and/or otherwise without human intervention. In some examples, the policy, the SLA, etc., can define that the upgrade can be carried out semiautomatically that requires portion(s) of the upgrade to invoke human intervention. In some examples, the policy, the SLA, etc., can define that the upgrade requires human intervention. For example, the process control update circuitry 460 can request authorization from the process control system 102 (e.g., an authorized or authenticated user of the process control system 102) to proceed with a semiautomatic or manual upgrade process indicated by a recommendation. After authorization is received, the process control update circuitry 460 can cause the update to occur per the recommendation. For example, the process control update circuitry 460 can cause, instruct, and/or invoke the installation agent 156 of a corresponding electronic device of the process control system 102 to update the electronic device. In some examples, the process control update circuitry 460 can determine whether to continue monitoring the process control system 102, such as whether to continue monitoring for collection of the telemetry data 472.

In some examples, the process control update circuitry 460 can detect new versions of hardware configurations, software, and/or firmware to deploy. For example, the process control update circuitry 460 can detect that a new version of an application executed and/or instantiated by the first workstation 134 is available in the catalog 478. In some examples, the process control update circuitry 460 can determine whether process control system(s) in communication with the cloud data center 146 have a previous version of the application installed; and notify one(s) of the process control system(s) that a newer version of the application is available for download or use. In some examples, the process control update circuitry 460 can detect and/or otherwise identify a new version of a hardware configuration of the first controllers 126, the first I/O cards 128, the second controllers 130, the second I/O cards 132, the field devices 110, 116, etc. In some examples, the process control update circuitry 460 can detect a new version of a firmware version of firmware executed and/or instantiated by the first controllers 126, the first I/O cards 128, the second controllers 130, the second I/O cards 132, the field devices 110, 116, etc.

In some examples, the process control update circuitry 460 can determine that a request to access an application of the catalog 478 indicates that the access is for execution of the application by a cloud host. For example, the field gateway 154 can transmit a request to the interface circuitry 410 for the first workstation 134 to execute an application on a web browser of the first workstation 134. In some examples, the web browser can access an instance of the application hosted by the cloud data center 146 instead of downloading the instance locally to the first workstation 134. Advantageously, such an access of the application on a cloud/remote server can reduce utilization of compute, memory, and/or storage resources of the first workstation 134. Advantageously, such an access of the application on a cloud/remote server can effectuate a try-before-you-buy service, such as by executing a trial version or cloud-hosted version prior to downloading a copy of the application for local execution in the process control system 102. In some examples, the process control update circuitry 460 can determine that a request for access of an application is for local execution, such as execution and/or instantiation on the first workstation 134. For example, the process control update circuitry 460 can invoke the interface circuitry 410 to push and/or otherwise transmit an executable binary file (or any other executable construct) to the first workstation 134 via the edge gateways 142 and the field gateways 140.

In some examples, the process control update circuitry 460 can determine that feedback or suggestions are associated with an application of the catalog 478. For example, the marketplace application 154 of FIGS. 1 and/or 2 can include functionality or interface(s) (e.g., graphical user interface(s) (GUI(s)), application programming interface(s) (API(s)), etc.) to provide a ratings and review system for specific software packages and services available for purchase. Advantageously, the marketplace application 154 can provide a mechanism for end-users to comment on the experiences of the software packages for feedback (e.g., immediate feedback) to the software vendor, third party, or internal development teams. For example, the marketplace application 154 can include software support forums moderated by software vendors associated with the cloud data center 146 for particular software packages so end users can discuss the operation of software amongst a community that interacts with the marketplace application 154. Advantageously, the cloud data center 146 can utilize these forums as sources of information to feed into the product decision cycle of product development.

By way of example, a user of the first workstation 134 can interface and/or interact with a software application in the catalog 478. In some examples, the user can access a portion of the marketplace application 154 that corresponds to the software application. For example, the user can access a forum (e.g., a review or feedback forum) on which users can post and/or otherwise leave feedback, comments, reviews, etc., associated with the application. In some examples, the process control update circuitry 460 can identify language (e.g., feedback, comments, reviews, etc.) posted on the forum; parse the language using natural language processing techniques into machine readable data (e.g., data vectors, binary data, etc.); and provide the machine readable data as input(s) to the ML model(s) 474. In some examples, the ML circuitry 440 can execute the ML model(s) 474 to generate a recommendation to change the application (e.g., add/remove/change a feature, function, capability, etc.) based on the language posted on the forum. In some examples, the process control update circuitry 460 can redeploy the application based on the posted language. For example, the process control update circuitry 460 can redeploy the application by carrying out the workflow 300 of FIG. 3, or portion(s) thereof.

In some examples, the process control update circuitry 460 can authenticate an application or a container from a developer (e.g., a third-party developer, a developer associated with the cloud data center 146, etc.) for insertion or addition to the catalog 478. For example, the process control update circuitry 460 can determine that the application/container conforms to terms and conditions, guidelines, policies, etc., associated with adding an application/container to the catalog 478.

In some examples, the process control update circuitry 460 can add the application/container to the catalog 478 after authentication of the application/container. In some examples, the process control update circuitry 460 can reject the application/container from being added to the catalog 478 after a determination that the application/container is not authenticated and/or otherwise does not conform to the terms and conditions, guidelines, policies, etc., associated with the catalog 478.

In some examples, the process control update circuitry 460 can determine that the application/container is a beta version or pre-released version. In some examples, the process control update circuitry 460 can publish an alert to user(s) who opted-in to beta version releases. For example, certain software packages may be available for preview installation for select end users. In some examples, the marketplace application 154 can record end-user experiences for usability testing and feedback collection. In some examples, the marketplace application 154 can control licensing and installation to install, configure, and remove beta-test site installations with notification(s) to the beta-test end users.

In some examples, the process control update circuitry 460 effectuates a payment delivery system associated with access to application(s), container(s), service(s), etc., of the catalog 478. For example, the first workstation 134 can request a license (e.g., a software license) to access and/or utilize a cloud hosted application of the catalog 478 for a first time duration (e.g., an 8 hour license, a 24 hour license, a weekly license, an annual license, etc.). In some examples, the process control update circuitry 460 can determine that the license for the first time duration is associated with a first quantity of tokens, which can be representative of payment for the license. In some examples, the recommendation generation circuitry 450 can advise on licenses about to expire, or licenses that have expired for software throughout the process control system 102; and the process control update circuitry 460 can obtain authorizations from the process control system 102 to renew the licenses or obtain instructions to allow the licenses to lapse or remain lapsed.

In some examples, tokens or credits (e.g., licenses, access credits, access tokens, non-fungible tokens (NFTs), etc.) can be exchanged into access and/or utilization of application(s), container(s), service(s), etc., of the catalog 478. For example, the token repository 482 can be implemented by storage for tokens or credits, such as cryptographic credits, cryptographic tokens, firmware/software credits, firmware/software tokens, NFTs, electronic tokens, compute tokens, etc. For example, the process control update circuitry 460 can mint and/or otherwise generate an NFT associated with access to an application of the catalog 478. In some examples, the process control update circuitry 460 can generate and/or store the NFT in the token repository 482. In some examples, the process control update circuitry 460 can provide the NFT to the first workstation 134 in exchange for payment (e.g., monetary payment). In some examples, the first workstation 134 can exchange the NFT for access to application(s) in the catalog 478.

In some examples, the process control update circuitry 460 can record entries associated with the credits/tokens in a database ledger, such as a blockchain (e.g., a private blockchain, a public blockchain, etc.). By way of example, the process control update circuitry 460 can record a first entry in a ledger or blockchain to memorialize a minting/generation of a first set of tokens. The process control update circuitry 460 can record a second entry in the ledger or blockchain to record a purchase or procurement of the first set of tokens by an electronic device of the process control system 102, such as the first workstation 134. The process control update circuitry 460 can record a third entry in the ledger or blockchain to record a decrement or decrease of a first number of tokens from the first set of tokens in response to a purchase or access of an application of the catalog 478 by the first workstation 134. The process control update circuitry 460 can record a fourth entry in the ledger or blockchain to record an increment or increase in a second number of tokens to a second set of tokens associated with a developer of the application in response to the purchase or access of the application of the catalog 478 by the first workstation 134. For example, the recording of the fourth entry can be representative of payment by the third workstation 134 to the developer of the application. In some examples, the first number of tokens is the same as the second number of tokens. In some examples, the second number of tokens is less than the first number of tokens with the difference between the first and second number being representative of a processing fee for the cloud data center 146 to handle the payment.

The recommendation engine circuitry 400 of the illustrated example includes the datastore 470 to record data, such as the telemetry data 472, the configuration data 474, the ML model(s) 476, the catalog 478, the policy data 480, and the token repository 482. In some examples, the datastore 470 is instantiated by processor circuitry executing datastore instructions and/or configured to perform operations such as those represented by the flowcharts of FIGS. 6, 7, 8, 9, 10, 11, 12, and/or 13.

The datastore 470 can be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 470 may additionally or alternatively be implemented by one or more double data rate (DDR) memories, such as DDR, DDR2, DDR3, DDR4, DDR5, mobile DDR (mDDR), DDR SDRAM, etc. The datastore 470 may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the datastore 470 is illustrated as a single datastore, the datastore 470 may be implemented by any number and/or type(s) of datastores. Furthermore, the data stored in the datastore 470 may be in any data format such as, for example, binary data, comma delimited data, tab delimited data, structured query language (SQL) structures, etc.

In some examples, the datastore 470 can implement one or more databases, which can store the telemetry data 472, the configuration data 474, the ML model(s) 476, the catalog 478, the policy data 480, and the token repository 482. The term “database” as used herein means an organized body of related data, regardless of the manner in which the data or the organized body thereof is represented. For example, the organized body of related data can be in the form of one or more of a table, a map, a grid, a packet, a datagram, a frame, a file, an e-mail, a message, a document, a report, a list or in any other form. The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of corresponding information in a different physical form or forms.

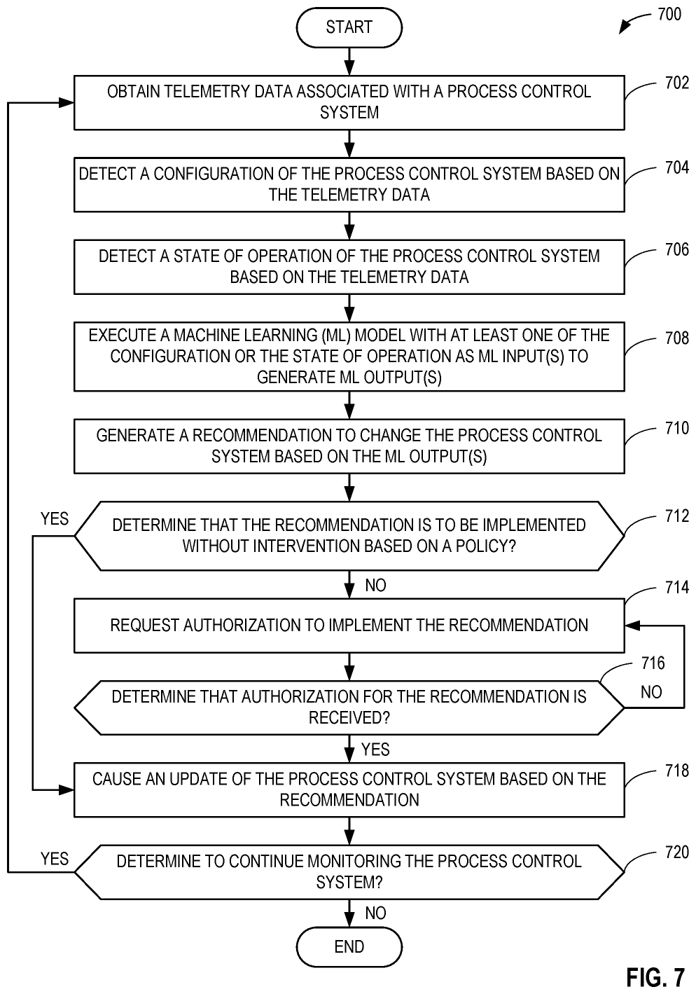

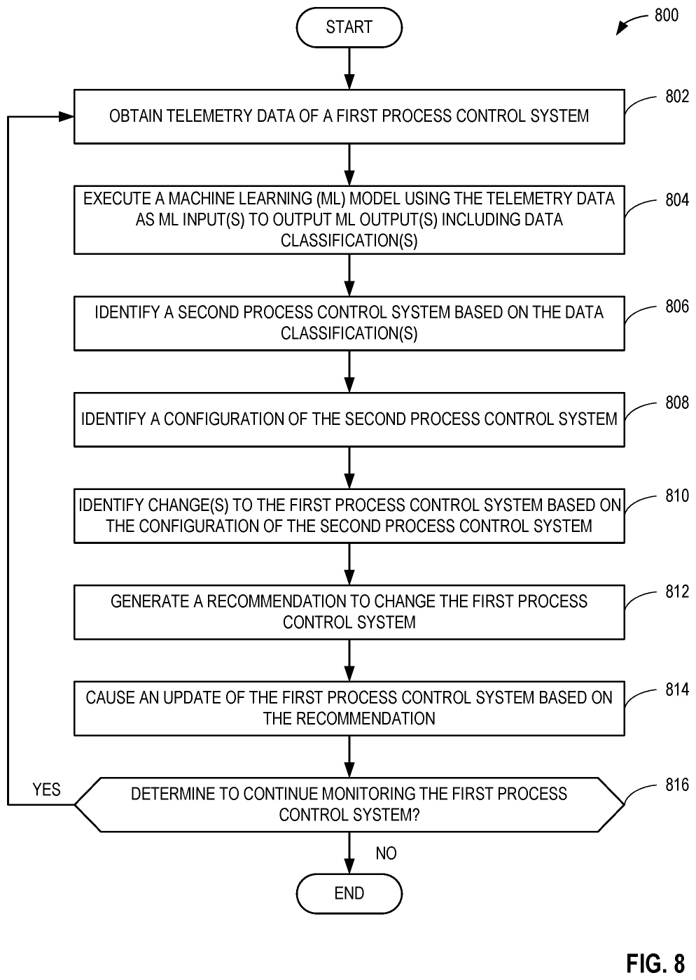

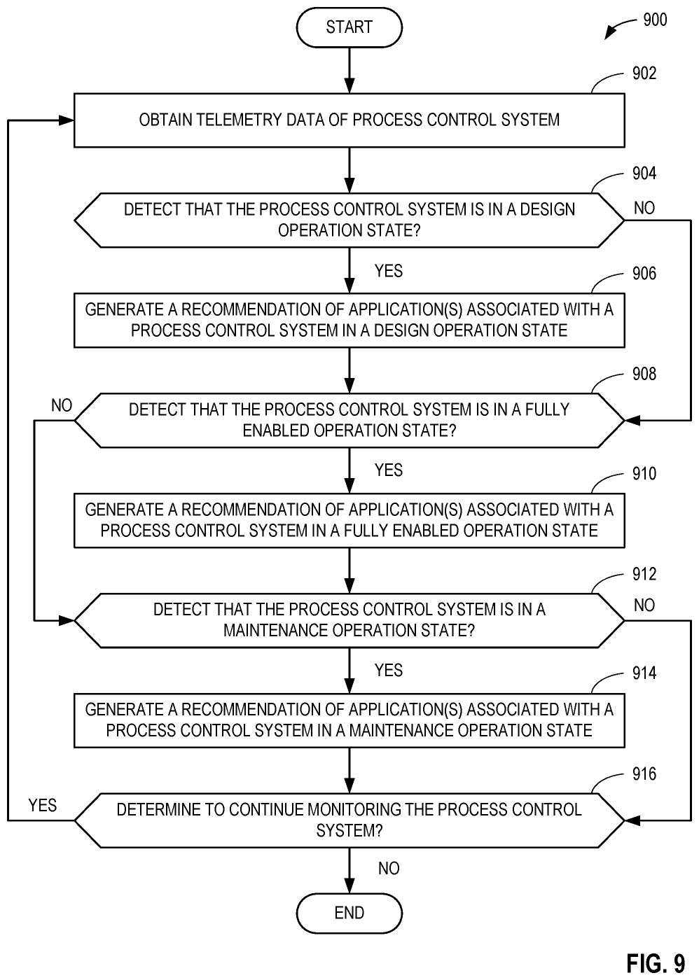

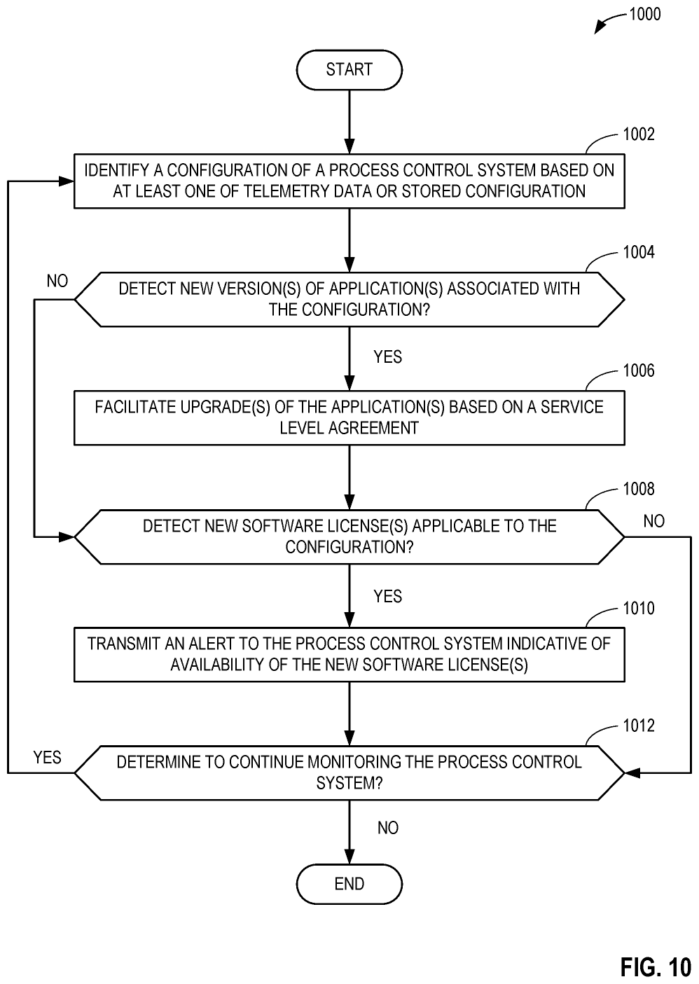

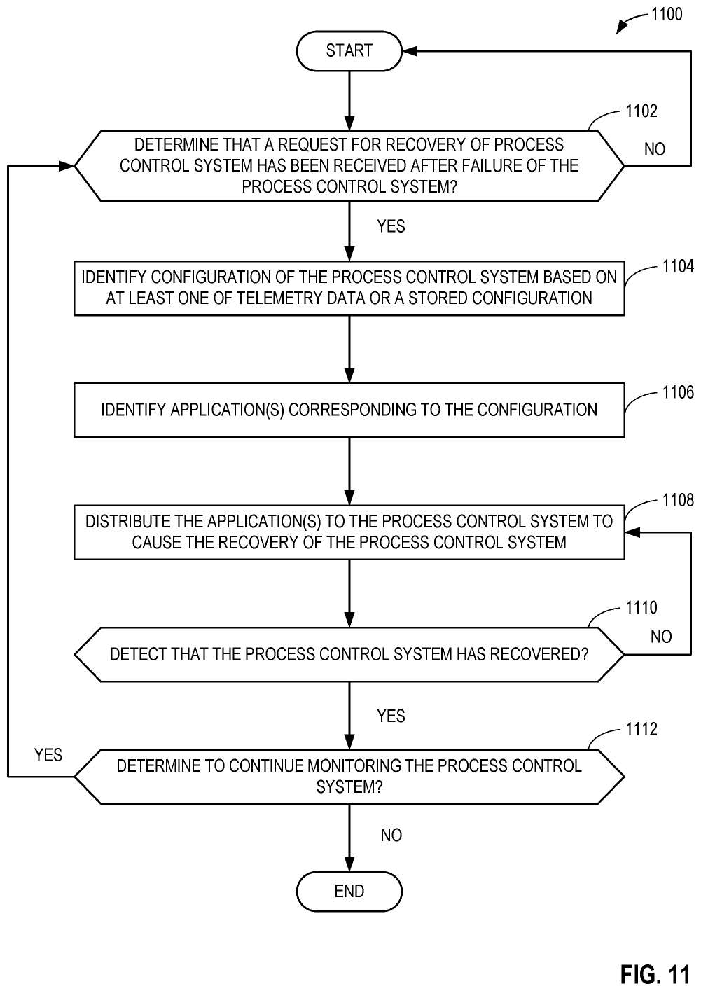

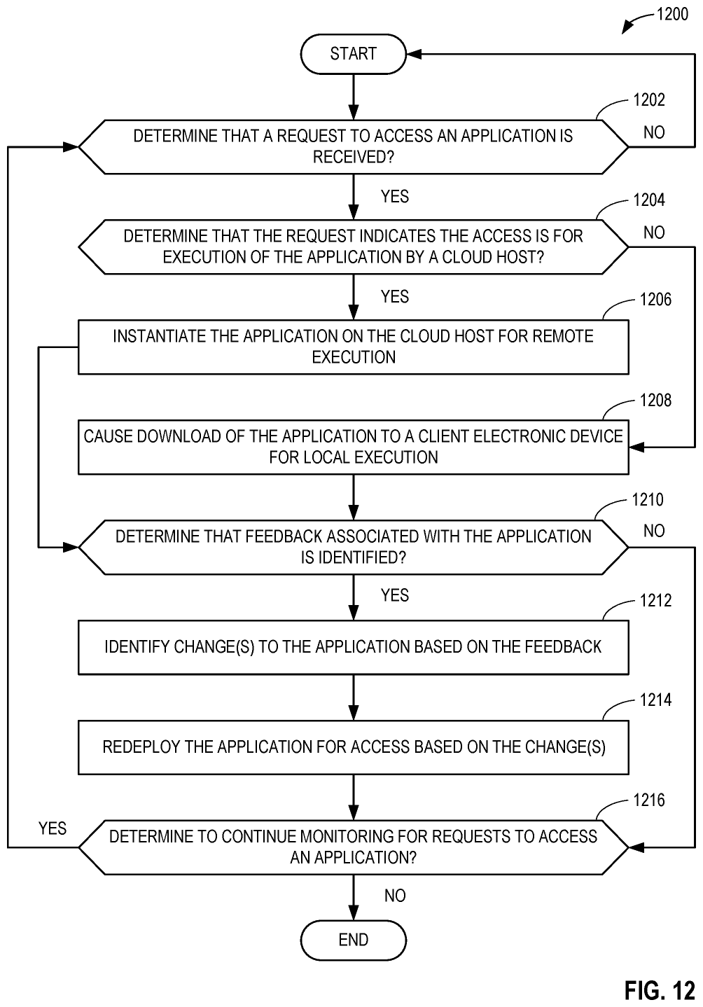

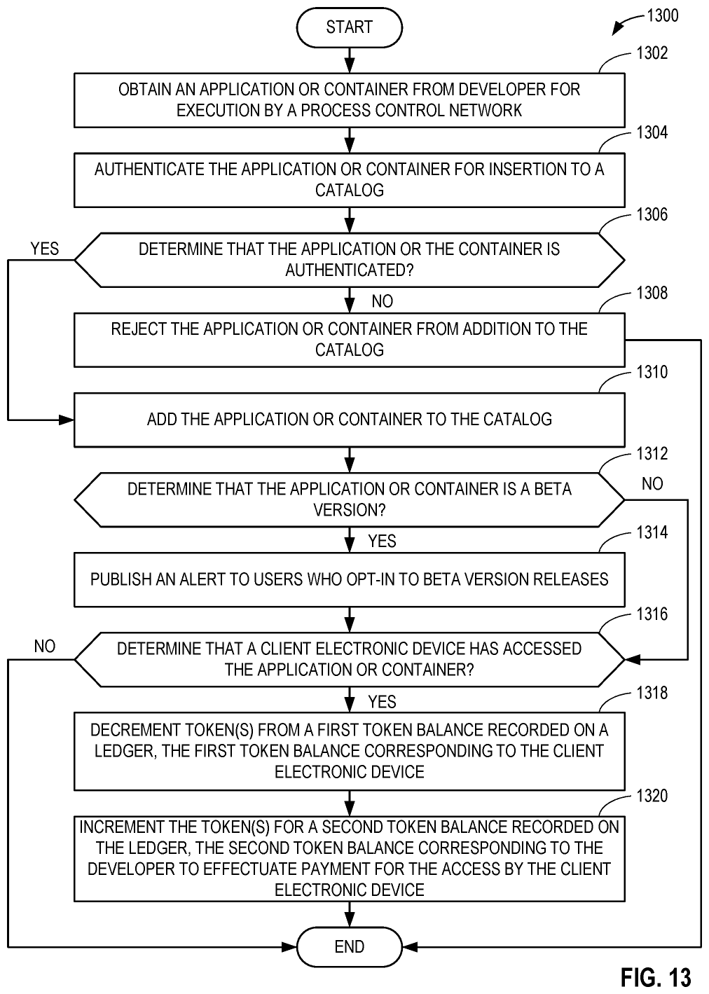

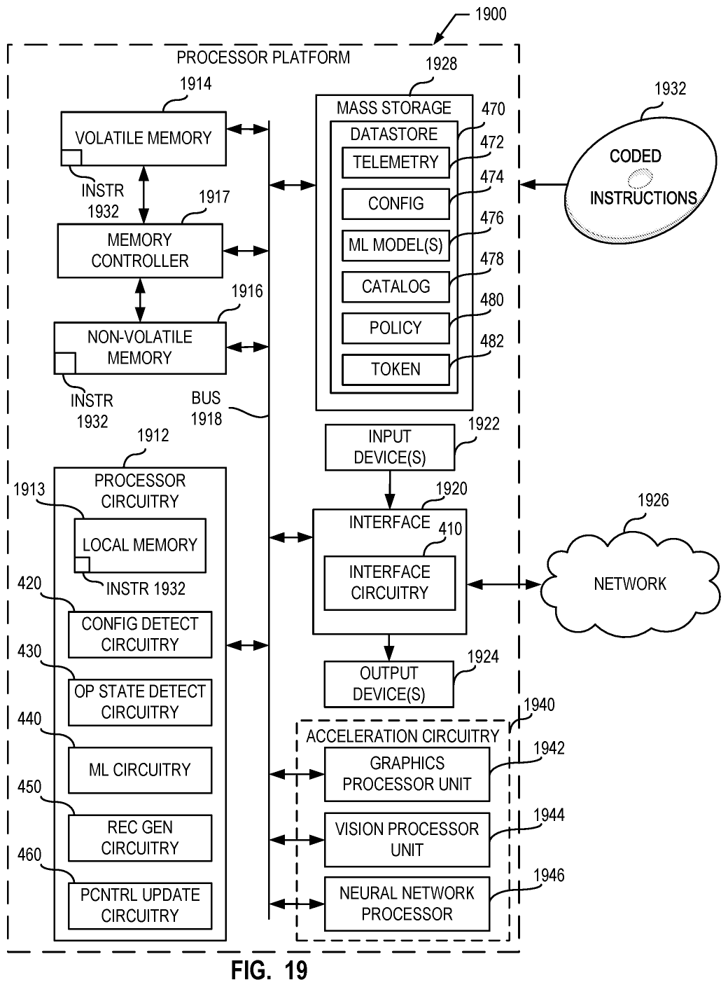

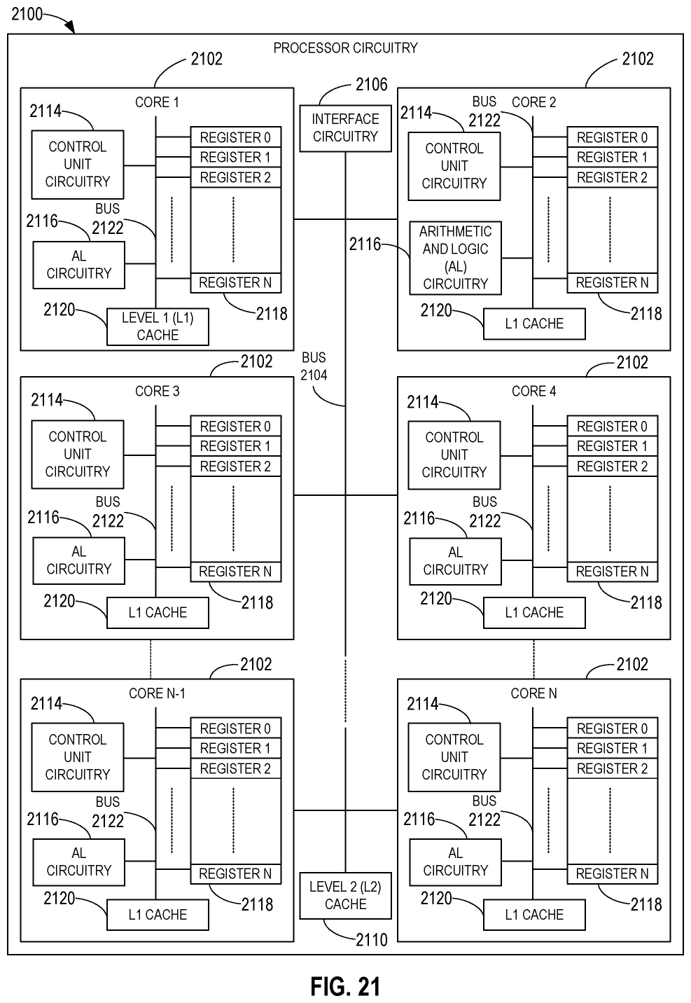

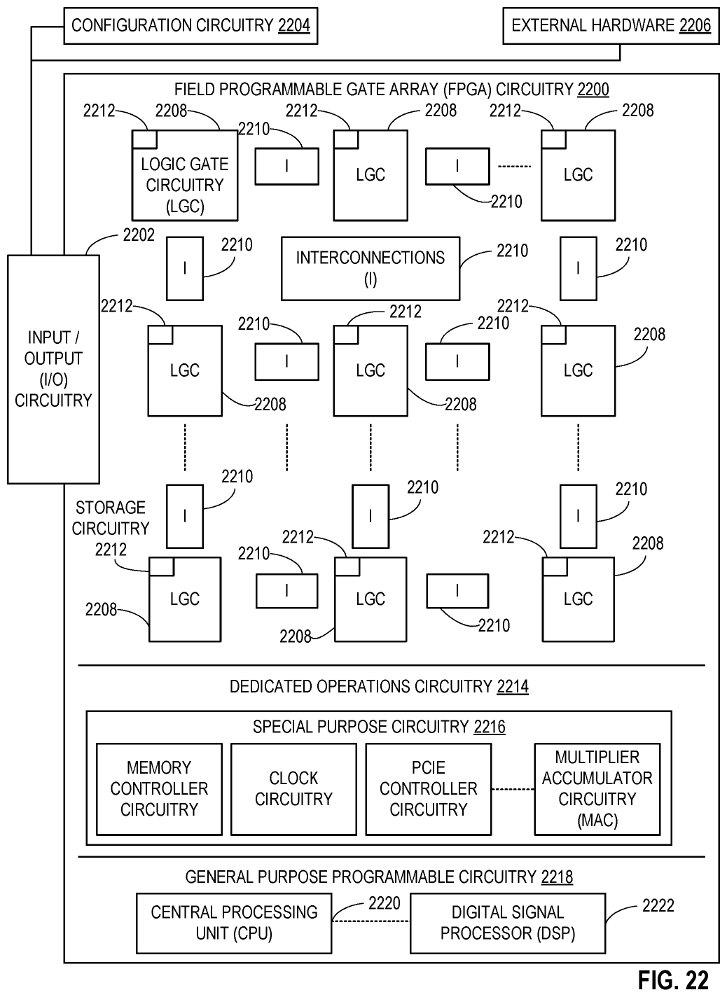

In some examples, the recommendation engine circuitry 400 includes means for obtaining telemetry data. For example, the means for obtaining may be implemented by the interface circuitry 410. In some examples, the interface circuitry 410 may be instantiated by processor circuitry such as the example processor circuitry 1912 of FIG. 19. For instance, the interface circuitry 410 may be instantiated by the example microprocessor 2100 of FIG. 21 executing machine executable instructions such as those implemented by at least block 702 of FIG. 7, block 802 of FIG. 8, blocks 903, 916 of FIG. 9, block 1010 of FIG. 10, blocks 1102, 1108, 1112 of FIG. 11, blocks 1202, 1208 of FIG. 12, and/or blocks 1302, 1314, 1316 of FIG. 13. In some examples, the interface circuitry 410 may be instantiated by hardware logic circuitry, which may be implemented by an ASIC, XPU, or the FPGA circuitry 2200 of FIG. 22 structured to perform operations corresponding to the machine readable instructions. Additionally or alternatively, the interface circuitry 410 may be instantiated by any other combination of hardware, software, and/or firmware. For example, the interface circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the recommendation engine circuitry 400 includes means for detecting a configuration of a process control system. In some examples, the means for detecting is first means for detecting. For example, the means for detecting may be implemented by the configuration detection circuitry 420. In some examples, the configuration detection circuitry 420 may be instantiated by processor circuitry such as the example processor circuitry 1912 of FIG. 19. For instance, the configuration detection circuitry 420 may be instantiated by the example microprocessor 2100 of FIG. 21 executing machine executable instructions such as those implemented by at least block 602 of FIG. 6, block 704 of FIG. 7, blocks 806, 808 of FIG. 8, block 1002 of FIG. 10, and/or blocks 1104, 1106, 1110 of FIG. 11. In some examples, the configuration detection circuitry 420 may be instantiated by hardware logic circuitry, which may be implemented by an ASIC, XPU, or the FPGA circuitry 2200 of FIG. 22 structured to perform operations corresponding to the machine readable instructions. Additionally or alternatively, the configuration detection circuitry 420 may be instantiated by any other combination of hardware, software, and/or firmware. For example, the configuration detection circuitry 420 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the recommendation engine circuitry 400 includes means for detecting a state of operation of a process control system. In some examples, the means for detecting is second means for detecting. For example, the means for detecting may be implemented by the operation state detection circuitry 430. In some examples, the operation state detection circuitry 430 may be instantiated by processor circuitry such as the example processor circuitry 1912 of FIG. 19. For instance, the operation state detection circuitry 430 may be instantiated by the example microprocessor 2100 of FIG. 21 executing machine executable instructions such as those implemented by at least block 602 of FIG. 6, block 706 of FIG. 7, and/or blocks 904, 908, 912 of FIG. 9. In some examples, the operation state detection circuitry 430 may be instantiated by hardware logic circuitry, which may be implemented by an ASIC, XPU, or the FPGA circuitry 2200 of FIG. 22 structured to perform operations corresponding to the machine readable instructions. Additionally or alternatively, the operation state detection circuitry 430 may be instantiated by any other combination of hardware, software, and/or firmware. For example, the operation state detection circuitry 430 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the recommendation engine circuitry 400 includes means for executing a machine learning model. For example, the means for executing may be implemented by the machine learning circuitry 440. In some examples, the machine learning circuitry 440 may be instantiated by processor circuitry such as the example processor circuitry 1912 of FIG. 19. For instance, the machine learning circuitry 440 may be instantiated by the example microprocessor 2100 of FIG. 21 executing machine executable instructions such as those implemented by at least block 604 of FIG. 6, block 708 of FIG. 7, and/or block 804 of FIG. 8. In some examples, the machine learning circuitry 440 may be instantiated by hardware logic circuitry, which may be implemented by an ASIC, XPU, or the FPGA circuitry 2200 of FIG. 22 structured to perform operations corresponding to the machine readable instructions. Additionally or alternatively, the machine learning circuitry 440 may be instantiated by any other combination of hardware, software, and/or firmware. For example, the machine learning circuitry 440 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the recommendation engine circuitry 400 includes means for generating a recommendation to change a process control system. For example, the means for generating may be implemented by the recommendation generation circuitry 450. In some examples, the recommendation generation circuitry 450 may be instantiated by processor circuitry such as the example processor circuitry 1912 of FIG. 19. For instance, the recommendation generation circuitry 450 may be instantiated by the example microprocessor 2100 of FIG. 21 executing machine executable instructions such as those implemented by at least block 710 of FIG. 7, blocks 810, 812 of FIG. 8, and/or blocks 906, 910, 914 of FIG. 9. In some examples, the recommendation generation circuitry 450 may be instantiated by hardware logic circuitry, which may be implemented by an ASIC, XPU, or the FPGA circuitry 2200 of FIG. 22 structured to perform operations corresponding to the machine readable instructions. Additionally or alternatively, the recommendation generation circuitry 450 may be instantiated by any other combination of hardware, software, and/or firmware. For example, the recommendation generation circuitry 450 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the recommendation engine circuitry 400 includes means for updating a process control system. For example, the means for updating may be implemented by the process control update circuitry 460. In some examples, the process control update circuitry 460 may be instantiated by processor circuitry such as the example processor circuitry 1912 of FIG. 19. For instance, the process control update circuitry 460 may be instantiated by the example microprocessor 2100 of FIG. 21 executing machine executable instructions such as those implemented by at least block 606 of FIG. 6, blocks 712, 714, 716, 718, 720 of FIG. 7, blocks 814, 816 of FIG. 8, blocks 1004, 1006, 1008, 1012 of FIG. 10, blocks 1204, 1206, 1210, 1212, 1214, 1216 of FIG. 12, and/or blocks 1304, 1306, 1308, 1310, 1312, 1318, 1320 of FIG. 13. In some examples, the process control update circuitry 460 may be instantiated by hardware logic circuitry, which may be implemented by an ASIC, XPU, or the FPGA circuitry 2200 of FIG. 22 structured to perform operations corresponding to the machine readable instructions. Additionally or alternatively, the process control update circuitry 460 may be instantiated by any other combination of hardware, software, and/or firmware. For example, the process control update circuitry 460 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the recommendation engine 150 of FIGS. 1 and/or 2 is illustrated in FIG. 4, one or more of the elements, processes, and/or devices illustrated in FIG. 4 may be combined, divided, re-arranged, omitted, eliminated, and/or implemented in any other way. Further, the interface circuitry 410, the configuration detection circuitry 420, the operation state detection circuitry 430, the ML circuitry 440, the recommendation generation circuitry 450, the process control update circuitry 460, the datastore 470, and/or, more generally, the recommendation engine 150 of FIGS. 1 and/or 2, may be implemented by hardware alone or by hardware in combination with software and/or firmware. Thus, for example, any of the interface circuitry 410, the configuration detection circuitry 420, the operation state detection circuitry 430, the ML circuitry 440, the recommendation generation circuitry 450, the process control update circuitry 460, the datastore 470, and/or, more generally, the example recommendation engine 150, could be implemented by processor circuitry, analog circuit(s), digital circuit(s), logic circuit(s), programmable processor(s), programmable microcontroller(s), GPU(s), DSP(s), ASIC(s), PLD(s), and/or FPLD(s) such as FPGAs. Further still, the example recommendation engine 150 of FIGS. 1 and/or 2 may include one or more elements, processes, and/or devices in addition to, or instead of, those illustrated in FIG. 4, and/or may include more than one of any or all of the illustrated elements, processes and devices.

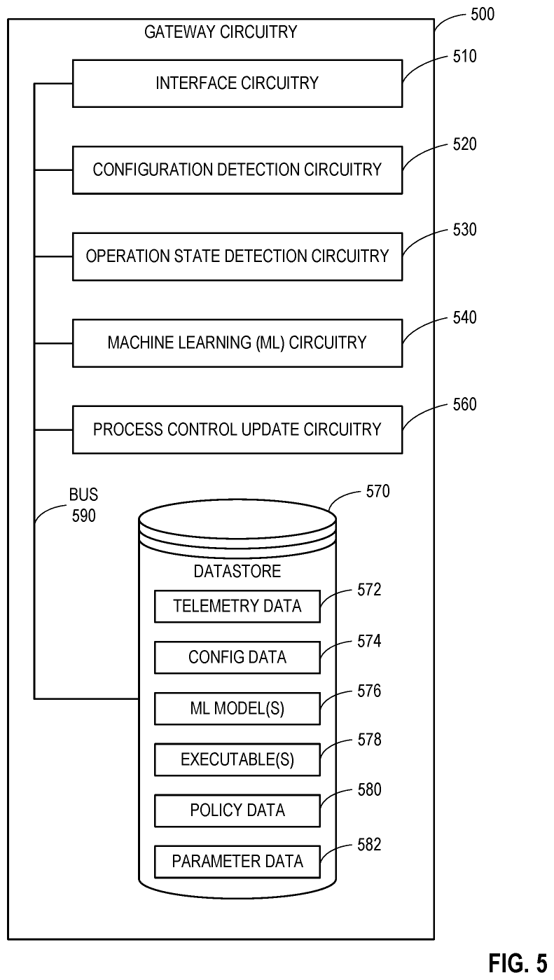

FIG. 5 is a block diagram of example gateway circuitry 500 to effectuate a recommendation to change portion(s) of the process control system 102 for increased efficiency and/or otherwise improved operation of the process control system 102. In some examples, one(s) of the field gateways 140 and/or one(s) of the edge gateways 142 of FIGS. 1 and/or 2 can be implemented by the gateway circuitry 500. In some examples, one(s) of the workstations 134, 136 can be implemented by the gateway circuitry 500. In some examples, one(s) of the controllers 126, 130, the I/O cards 128, 132, and/or, more generally, the PLC racks 122, 124, can be implemented by the gateway circuitry 500. In some examples, the installation agent 156 can be implemented by the gateway circuitry 500.

The gateway circuitry 500 of FIG. 5 may be instantiated (e.g., creating an instance of, bring into being for any length of time, materialize, implement, etc.) by processor circuitry such as a central processing unit executing instructions. Additionally or alternatively, gateway circuitry 500 of FIG. 5 may be instantiated (e.g., creating an instance of, bring into being for any length of time, materialize, implement, etc.) by an ASIC or an FPGA structured to perform operations corresponding to the instructions. It should be understood that some or all of the gateway circuitry 500 of FIG. 5 may, thus, be instantiated at the same or different times. Some or all of the gateway circuitry 500 of FIG. 5 may be instantiated, for example, in one or more threads executing concurrently on hardware and/or in series on hardware. Moreover, in some examples, some or all of the gateway circuitry 500 of FIG. 5 may be implemented by microprocessor circuitry executing instructions to implement one or more virtual machines and/or containers.

The gateway circuitry 500 includes example interface circuitry 510, example configuration detection circuitry 520, example operation state detection circuitry 530, example ML circuitry 540, example process control update circuitry 560, an example datastore 570, and an example bus 590. In the illustrated example of FIG. 5, the datastore 570 includes and/or otherwise stores example telemetry data 572, example configuration data 574 (identified by CONFIG DATA), example ML model(s) 576, example executable(s) 578, example policy data 580, and example parameter data 582. In some examples, the telemetry data 572 of FIG. 5, or portion(s) thereof, can correspond to the telemetry data 472 of FIG. 4, or portion(s) thereof. In some examples, the configuration data 574 of FIG. 5, or portion(s) thereof, can correspond to the configuration data 474 of FIG. 4, or portion(s) thereof. In some examples, the ML model(s) 576 of FIG. 5, or portion(s) thereof, can correspond to the ML model(s) 476 of FIG. 4, or portion(s) thereof. In some examples, the policy data 580 of FIG. 5, or portion(s) thereof, can correspond to the policy data 480 of FIG. 4, or portion(s) thereof.

In the illustrated example of FIG. 5, the interface circuitry 510, the configuration detection circuitry 520, the operation state detection circuitry 530, the ML circuitry 540, the process control update circuitry 560, and/or the datastore 570 are in communication with one(s) of each other via the bus 590. For example, the bus 590 can be implemented by at least one of an I2C bus, a SPI bus, a PCI bus, or a PCIe/PCIE bus. Additionally or alternatively, the bus 590 can be implemented by any other type of computing or electrical bus.

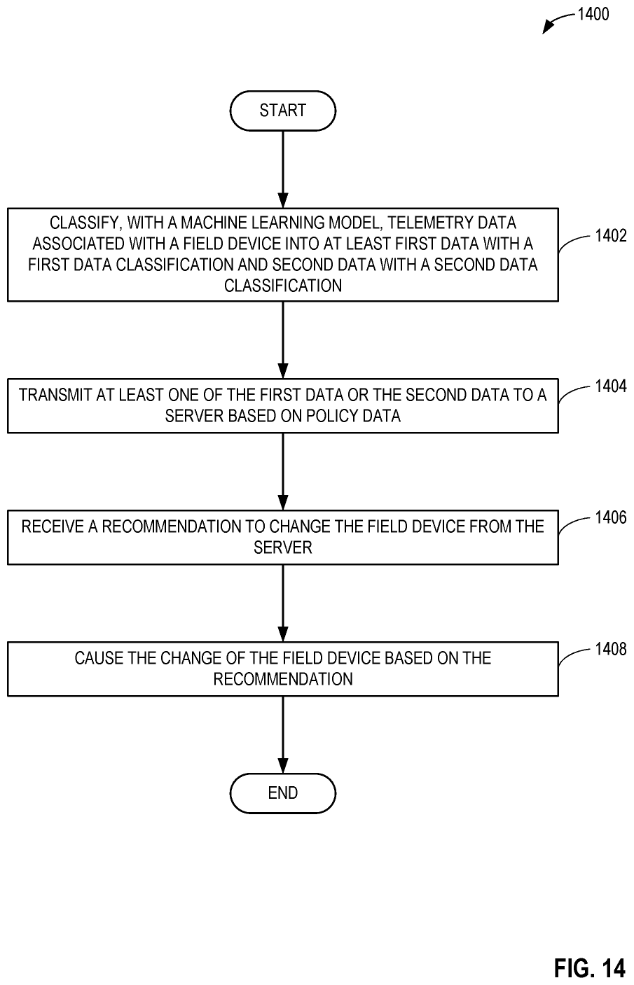

The gateway circuitry 500 of the illustrated example of FIG. 5 includes the interface circuitry 510 to receive and/or transmit data. In some examples, the interface circuitry 510 is instantiated by processor circuitry executing interface instructions and/or configured to perform operations such as those represented by the flowcharts of FIGS. 14, 15, 16, 17, and/or 18.

In some examples, the interface circuitry 510 collects, receives, and/or otherwise obtains the telemetry data 572 of the process control system 102 and/or stores the telemetry data 572 in the datastore 570. For example, the interface circuitry 510 can obtain (e.g., asynchronously obtain, synchronously obtain, aperiodically obtain, periodically obtain, etc.) the telemetry data 572 from at least one(s) of the first field device 110, the second field device 116, the first controllers 126, the second controllers 130, the first I/O devices 128, the second I/O devices 132, the first workstation 134, the second workstation 136, one(s) of the field gateways 140, or one(s) of the edge gateways 142. For example, the interface circuitry 510 can collect the telemetry data 572, which can include process parameter data (e.g., the parameter data 582), configuration data, hardware versions, software versions, firmware versions, the configuration data 574, software licenses, environment data, stage of operation data, operator identification data, etc., and/or any combination(s) thereof.

In some examples, the interface circuitry 510 receives a recommendation from the cloud data center 146 to change a field device, such as the first field device 110 and/or the second field device 116. In some examples, the interface circuitry 510 determines whether to continue collecting telemetry data associated with the process control system 102. In some examples, the interface circuitry 510 determines whether to continue monitoring the process control system 102.

In some examples, the interface circuitry 510 transmits portion(s) of the telemetry data 572 to a server based on the policy data 580. For example, the interface circuitry 510 can transmit portion(s) of the telemetry data 572 that have a particular type of data classification defined by the policy data 580 to the cloud data center 146. In some examples, the interface circuitry 510 transmits data representative of a request for a recovery operation to the cloud data center 146. For example, after a detection of a failure or non-responsiveness of the first controllers 126, the interface circuitry 510 can request a hardware configuration and/or firmware of a particular version from the catalog 478 of FIG. 4 that corresponds to the first controllers 126.

The gateway circuitry 500 of the illustrated example of FIG. 5 includes the configuration detection circuitry 520 to detect a configuration of the process control system 102, or portion(s) thereof, and store the configuration in the datastore 570 as the configuration data 574. In some examples, the configuration detection circuitry 520 is instantiated by processor circuitry executing configuration detection instructions and/or configured to perform operations such as those represented by the flowcharts of FIGS. 14, 15, 16, 17, and/or 18.

In some examples, the configuration detection circuitry 520 can detect and/or otherwise identify process parameter data (e.g., the parameter data 582), hardware versions, software versions, firmware versions, makes/models of components, software licenses, environment data, stage of operation data, operator identification data, etc., and/or any combination(s) thereof, and store such data in the datastore 570 as the configuration data 574.

In some examples, the configuration detection circuitry 520 can determine whether to store data specific to application(s), container(s), etc., of the process control system 102 in the cloud data center 146. Advantageously, such cloud-based storage achieves persistent storage facility to allow data to remain during application lifecycle events, such as uninstallation, reinstallation, or recovery from a failure or non-responsive event.

The gateway circuitry 500 of the illustrated example of FIG. 5 includes the operation state detection circuitry 530 to detect a state of operation of the process control system 102, or portion(s) thereof (e.g., state of operation of a component of the process control system 102). In some examples, the operation state detection circuitry 530 is instantiated by processor circuitry executing operation state detection instructions and/or configured to perform operations such as those represented by the flowcharts of FIGS. 14, 15, 16, 17, and/or 18.

In some examples, the operation state detection circuitry 530 can detect that the first field device 110 has failed and/or is non-responsive (e.g., processor circuitry of the first field device 110 encountered a runtime error and may need to be rebooted and/or firmware of the processor circuitry is to be reinstalled or reflashed). In some examples, the operation state detection circuitry 530 can determine that a recovery operation is needed after the detection of the failure/non-responsiveness. In some examples, the operation state detection circuitry 530 can store an identification of the failure/non-responsiveness in the datastore 570 as the telemetry data 572.

The gateway circuitry 500 of the illustrated example of FIG. 5 includes the ML circuitry 540 to classify, with the ML model(s) 576, the telemetry data 572 into at least first data with a first data classification and second data with a second data classification. In some examples, the ML circuitry 540 is instantiated by processor circuitry executing ML instructions and/or configured to perform operations such as those represented by the flowcharts of FIGS. 14, 15, 16, 17, and/or 18.

In some examples, the ML circuitry 540 can classify the telemetry data 572 by executing the ML model(s) 576 with the telemetry data 572 as input(s) (e.g., model input(s), ML model input(s), ML input(s), etc.) to generate output(s) (e.g., model output(s), ML model output(s), ML output(s), etc.), which can include data classification(s) of the telemetry data 572. For example, the ML model(s) 576 can be neural network model(s) or any type of machine learning classification model. In some examples, the ML model(s) 576 is/are generated, trained, and/or compiled by the cloud data center 146. For example, the ML circuitry 440 of FIG. 4 can generate, train, and/or compile the ML model(s) 476 of FIG. 4 as lightweight ML model(s) that can be stored in the datastore 570 of FIG. 5 as the ML model(s) 576. For example, the ML model(s) 576 of FIG. 5 can have fewer layers, neurons, etc., than the ML model(s) 476 of FIG. 4. In some examples, the ML model(s) 576 of FIG. 5 is/are the same as the ML model(s) 476 of FIG. 4.

The gateway circuitry 500 of the illustrated example of FIG. 5 includes the process control update circuitry 560 to cause a change of portion(s) of the process control system 102 based on a recommendation from the recommendation engine 150 of FIGS. 1 and/or 2. In some examples, the process control update circuitry 560 is instantiated by processor circuitry executing process control update instructions and/or configured to perform operations such as those represented by the flowcharts of FIGS. 14, 15, 16, 17, and/or 18.

In some examples, the process control update circuitry 560 can cause change(s) to the process control system 102 by directing, instructing, and/or otherwise invoking corresponding one(s) of the installation agent 156 of FIGS. 1 and/or 2 to implement the change(s). For example, the process control update circuitry 560 can cause an update of an application on the first workstation 134 by directing the installation agent 156 executed and/or instantiated by the first workstation 134 to update the application.

In some examples, the process control update circuitry 560 can identify portion(s) of the telemetry data 572 to send to the cloud data center 146 based on the policy data 580. For example, the policy data 580 can include a policy, an SLA, etc., associated with the process control system 102. In some examples, the policy, the SLA, etc., can define a manner in which changes to the process control system 102 can be carried out. In some examples, the policy data 580 can identify a first type of data to have a first data classification, a second type of data to have a second data classification, etc. For example, the first type of data can be the parameter data 582 and the first data classification can be a parameter data classification. In some examples, the parameter data 582 can include sensor measurements, values of process parameters (e.g., a value of a fluid pressure, a value of a fluid temperature, a value of a fluid flow rate, etc.), etc. In some examples, the second type of data can be the configuration data 574 and the second data classification can be a configuration data classification. For example, the configuration data 574 can include a version of a hardware configuration of the first controllers 126. In some examples, the policy data 580 can define, specific, indicate, etc., that the first data classification is not to be shared externally to the process control system 102 and the second data classification may be shared externally to the process control system 102. For example, the policy data 580 can implement a data privacy policy to achieve enhanced security of the process control system 102.

In some examples, the process control update circuitry 560 can determine a level of permission access needed to change portion(s) of the process control system 102. For example, the process control update circuitry 560 can determine the level of permission access based on the policy data 580. In some examples, the process control update circuitry 560 can determine that the permission access is an automatic permission access (e.g., no human or user intervention needed), a semiautomatic permission access (e.g., a portion of the change process may need human or user intervention), or a manual permission access (e.g., the entirety of the change process may need human or user intervention). In some examples, the process control update circuitry 560 can change the portion(s) of the process control system 102 after a determination that the portion(s) is/are in at least one of a standby or maintenance stage of operation due to safety considerations. In some examples, the process control update circuitry 560 can change the portion(s) of the process control system 102 via a staged upgrade process in which one or more portions is/are complete without human/user intervention and/or one or more portions is/are complete with human/user intervention in a particular arrangement or sequence.

The gateway circuitry 500 of the illustrated example of FIG. 5 includes the datastore 570 to record data, such as the telemetry data 572, the configuration data 574, the ML model(s) 576, the executable(s) 578, the policy data 580, and the parameter data 582. In some examples, the datastore 570 is instantiated by processor circuitry executing datastore instructions and/or configured to perform operations such as those represented by the flowcharts of FIGS. 14, 15, 16, 17, and/or 18. In some examples, the executable(s) 578 is/are executable constructs, such as executable binary file(s), that, when executed and/or instantiated, can run application(s), container(s), service(s), etc. For example, the executable(s) 578 can be used to run an application (e.g., a process control application to run diagnostic operations on the first fluid flow control assembly 106, a process control application to program the first PLC rack 122, etc.) on the first workstation 134 and/or the second workstation 136. In some examples, the executable(s) 578 can be used to run the marketplace application 154. In some examples, the executable(s) 578 can be used to run the installation agent 156.

The datastore 570 can be implemented by a volatile memory (e.g., an SDRAM, DRAM, RDRAM, etc.) and/or a non-volatile memory (e.g., flash memory). The datastore 570 may additionally or alternatively be implemented by one or more DDR memories, such as DDR, DDR2, DDR3, DDR4, DDR5, mDDR, DDR SDRAM, etc. The datastore 570 may additionally or alternatively be implemented by one or more mass storage devices such as hard disk drive(s) (HDD(s)), CD drive(s), DVD drive(s), SSD drive(s), SD card(s), CF card(s), etc. While in the illustrated example the datastore 570 is illustrated as a single datastore, the datastore 570 may be implemented by any number and/or type(s) of datastores. Furthermore, the data stored in the datastore 570 may be in any data format such as, for example, binary data, comma delimited data, tab delimited data, SQL structures, etc. In some examples, the datastore 570 can implement one or more databases, which can store the telemetry data 572, the configuration data 574, the ML model(s) 576, the executable(s) 578, the policy data 580, and the parameter data 582.

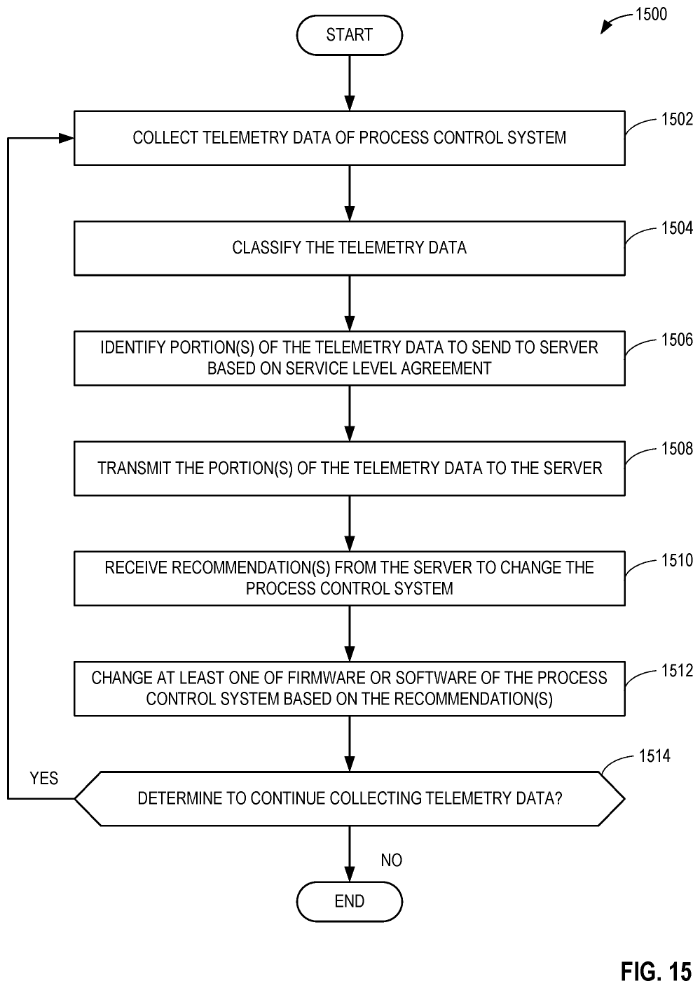

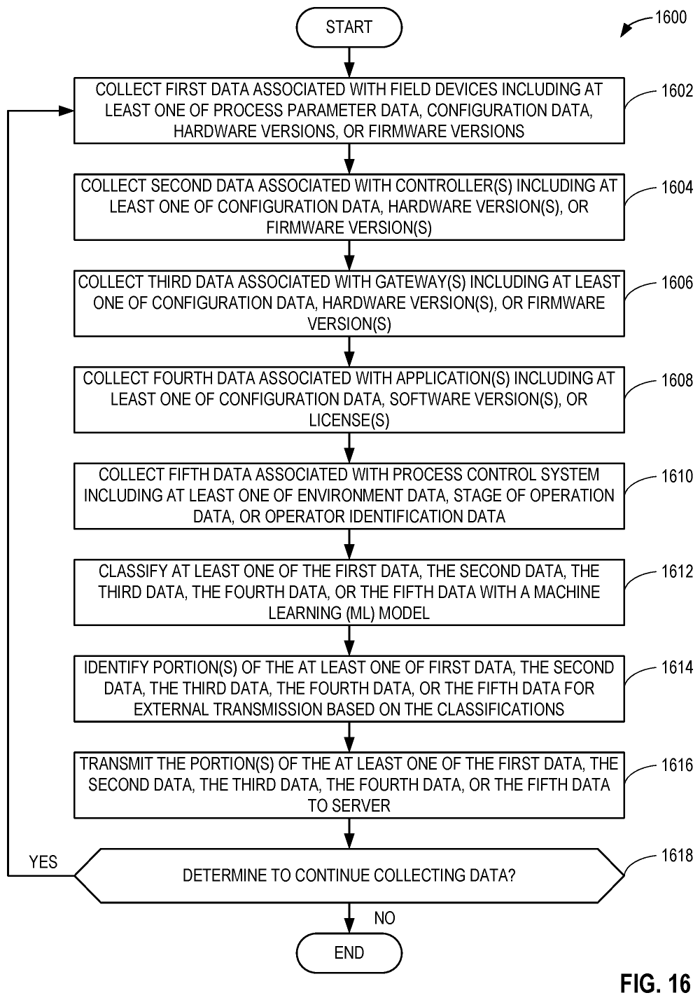

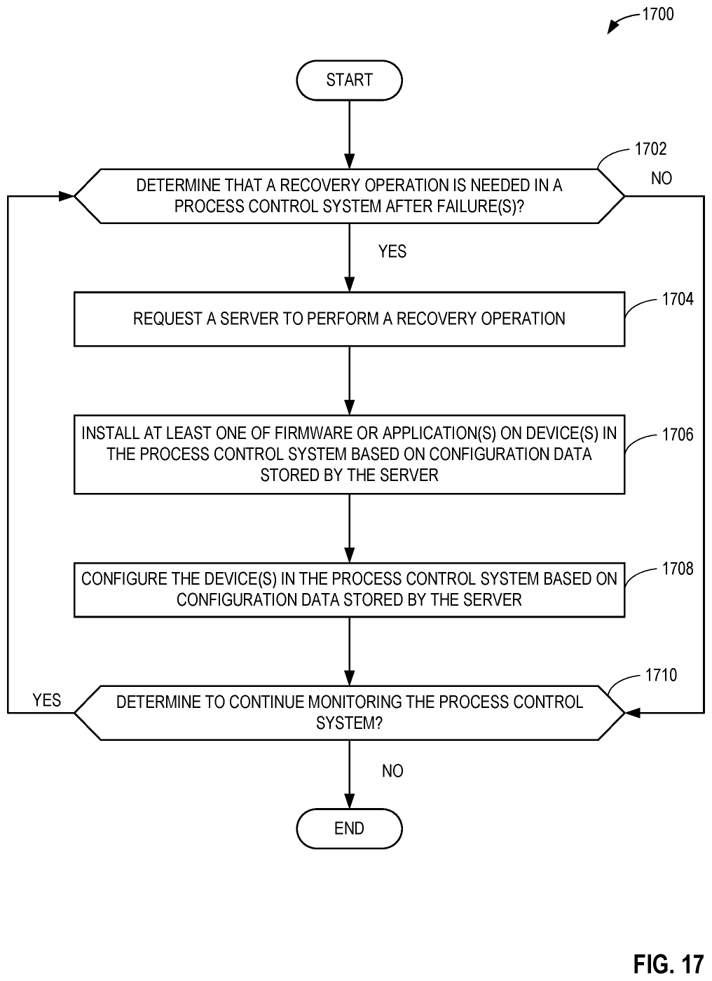

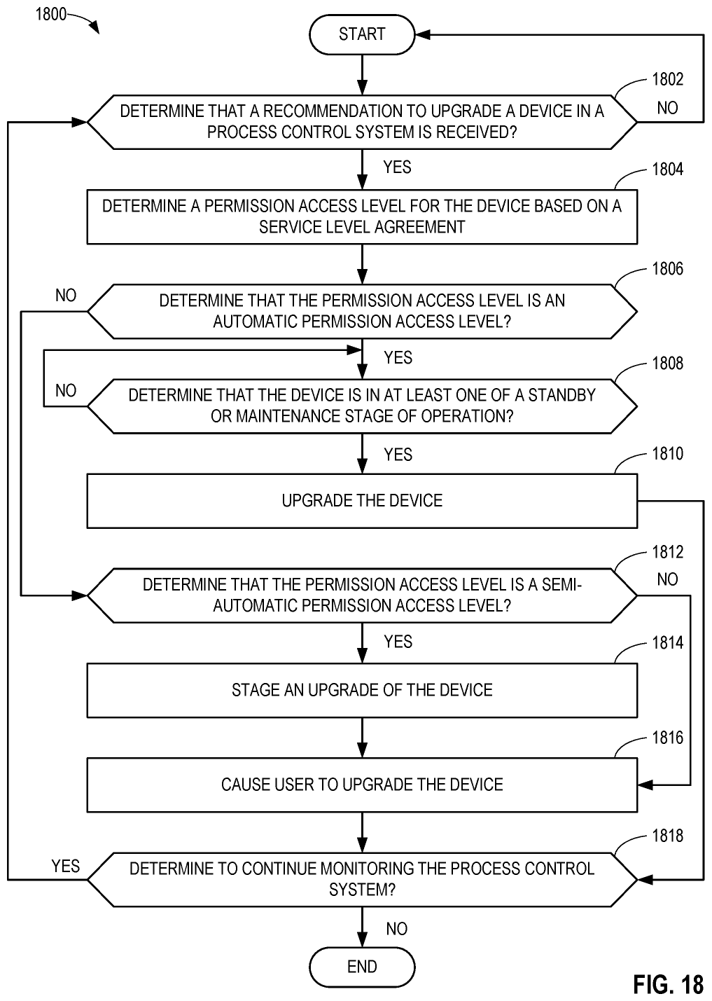

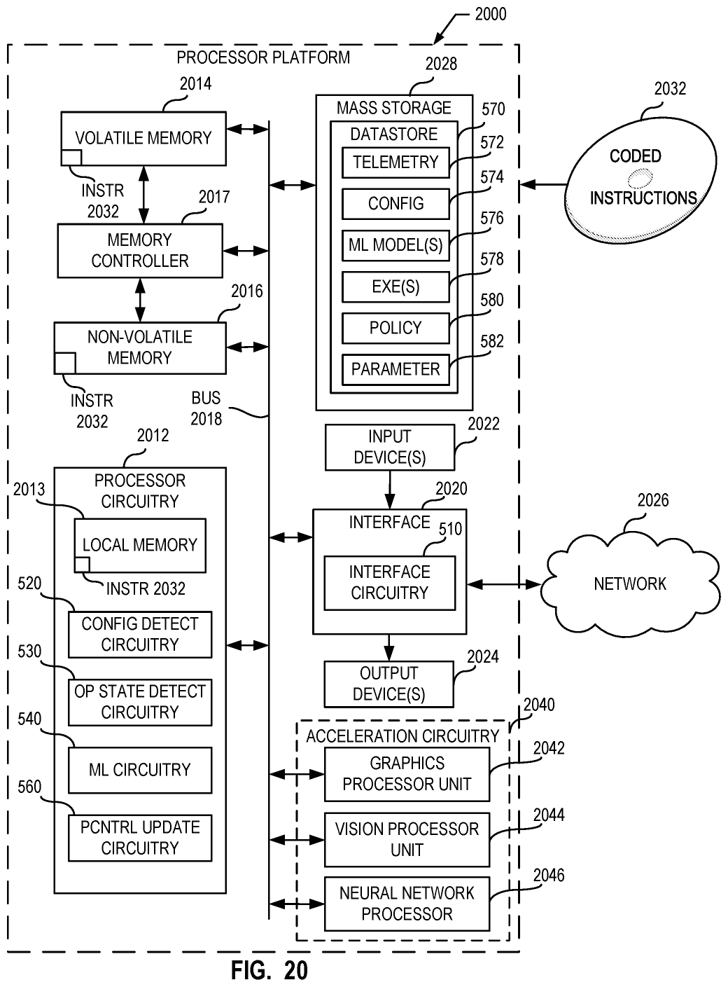

In some examples, the gateway circuitry 500 includes means for transmitting data to a server. For example, the means for transmitting may be implemented by the interface circuitry 510. In some examples, the gateway circuitry 500 includes means for collecting telemetry data. For example, the means for transmitting may be implemented by the interface circuitry 510. In some examples, the interface circuitry 510 may be instantiated by processor circuitry such as the example processor circuitry 2012 of FIG. 20. For instance, the interface circuitry 510 may be instantiated by the example microprocessor 2100 of FIG. 21 executing machine executable instructions such as those implemented by at least blocks 1404, 1406 of FIG. 14, blocks 1502, 1508, 1510, 1514 of FIG. 15, blocks 1602, 1604, 1606, 1608, 1610, 1616 of FIG. 16, blocks 1704, 1710 of FIG. 17, and/or block 1802 of FIG. 18. In some examples, the interface circuitry 510 may be instantiated by hardware logic circuitry, which may be implemented by an ASIC, XPU, or the FPGA circuitry 2200 of FIG. 22 structured to perform operations corresponding to the machine readable instructions. Additionally or alternatively, the interface circuitry 510 may be instantiated by any other combination of hardware, software, and/or firmware. For example, the interface circuitry 510 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the gateway circuitry 500 includes means for detecting a state of operation of a process control system. For example, the means for detecting may be implemented by the operation state detection circuitry 530. In some examples, the operation state detection circuitry 530 may be instantiated by processor circuitry such as the example processor circuitry 2012 of FIG. 20. For instance, the operation state detection circuitry 530 may be instantiated by the example microprocessor 2100 of FIG. 21 executing machine executable instructions such as those implemented by at least block 1702 of FIG. 17 and/or block 1808 of FIG. 18. In some examples, the operation state detection circuitry 530 may be instantiated by hardware logic circuitry, which may be implemented by an ASIC, XPU, or the FPGA circuitry 2200 of FIG. 22 structured to perform operations corresponding to the machine readable instructions. Additionally or alternatively, the operation state detection circuitry 530 may be instantiated by any other combination of hardware, software, and/or firmware. For example, the operation state detection circuitry 530 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the gateway circuitry 500 includes means for executing a machine learning model. For example, the means for executing may be implemented by the machine learning circuitry 540. In some examples, the machine learning circuitry 540 may be instantiated by processor circuitry such as the example processor circuitry 2012 of FIG. 20. For instance, the machine learning circuitry 540 may be instantiated by the example microprocessor 2100 of FIG. 21 executing machine executable instructions such as those implemented by at least block 1402 of FIG. 14, block 1504 of FIG. 15, and/or block 1612 of FIG. 16. In some examples, the machine learning circuitry 540 may be instantiated by hardware logic circuitry, which may be implemented by an ASIC, XPU, or the FPGA circuitry 2200 of FIG. 22 structured to perform operations corresponding to the machine readable instructions. Additionally or alternatively, the machine learning circuitry 540 may be instantiated by any other combination of hardware, software, and/or firmware. For example, the machine learning circuitry 540 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the gateway circuitry 500 includes means for updating a process control system. For example, the means for updating may be implemented by the process control update circuitry 560. In some examples, the process control update circuitry 560 may be instantiated by processor circuitry such as the example processor circuitry 2012 of FIG. 20. For instance, the process control update circuitry 560 may be instantiated by the example microprocessor 2100 of FIG. 21 executing machine executable instructions such as those implemented by at least block 1408 of FIG. 14, blocks 1506, 1512 of FIG. 15, block 1614 of FIG. 16, blocks 1706, 1708 of FIG. 17, and/or blocks 1804, 1806, 1810, 1812, 1814, 1816, 1818 of FIG. 18. In some examples, the process control update circuitry 560 may be instantiated by hardware logic circuitry, which may be implemented by an ASIC, XPU, or the FPGA circuitry 2200 of FIG. 22 structured to perform operations corresponding to the machine readable instructions. Additionally or alternatively, the process control update circuitry 560 may be instantiated by any other combination of hardware, software, and/or firmware. For example, the process control update circuitry 560 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing one(s) of the field gateways 140 and/or one(s) of the edge gateways 142 of FIGS. 1 and/or 2 is/are illustrated in FIG. 5, one or more of the elements, processes, and/or devices illustrated in FIG. 5 may be combined, divided, re-arranged, omitted, eliminated, and/or implemented in any other way. Further, the interface circuitry 510, the configuration detection circuitry 520, the operation state detection circuitry 530, the ML circuitry 540, the process control update circuitry 560, the datastore 570, and/or, more generally, the one(s) of the field gateways 140 and/or one(s) of the edge gateways 142 of FIGS. 1 and/or 2, may be implemented by hardware alone or by hardware in combination with software and/or firmware. Thus, for example, any of the interface circuitry 510, the configuration detection circuitry 520, the operation state detection circuitry 530, the ML circuitry 540, the process control update circuitry 560, the datastore 570, and/or, more generally, the one(s) of the field gateways 140 and/or one(s) of the edge gateways 142 of FIGS. 1 and/or 2, could be implemented by processor circuitry, analog circuit(s), digital circuit(s), logic circuit(s), programmable processor(s), programmable microcontroller(s), GPU(s), DSP(s), ASIC(s), PLD(s), and/or FPLD(s) such as FPGAs. Further still, the one(s) of the field gateways 140 and/or one(s) of the edge gateways 142 of FIGS. 1 and/or 2 of FIG. 1 may include one or more elements, processes, and/or devices in addition to, or instead of, those illustrated in FIG. 5, and/or may include more than one of any or all of the illustrated elements, processes and devices.

Flowcharts representative of example machine readable instructions, which may be executed to configure processor circuitry to implement the recommendation engine circuitry 400 of FIG. 4 and/or the gateway circuitry 500 of FIG. 5, are shown in FIGS. 6-18. The machine readable instructions may be one or more executable programs or portion(s) of an executable program for execution by processor circuitry, such as the processor circuitry 1912 shown in the example processor platform 1900 discussed below in connection with FIG. 19, the processor circuitry 2012 shown in the example processor platform 2000 discussed below in connection with FIG. 20, and/or the example processor circuitry discussed below in connection with FIGS. 21 and/or 22. The program(s) may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is/are described with reference to the flowcharts illustrated in FIGS. 6-18, many other methods of implementing the example recommendation engine circuitry 400 and/or the gateway circuitry 500 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-18 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed and/or instantiated by processor circuitry to cause a change in a portion of a process control system based on a recommendation. The example machine readable instructions and/or the example operations 600 of FIG. 6 begin at block 602, at which the recommendation engine circuitry 400 detects at least one of a configuration or a state of operation of a process control system based on telemetry data associated with the process control system. For example, the interface circuitry 410 (FIG. 4) can obtain telemetry data associated with an application installed on the first workstation 134, and/or, more generally, the process control system 102. In some examples, the interface circuitry 410 can store the obtained telemetry data in the datastore 470 (FIG. 4) as the telemetry data 472 (FIG. 4). In some examples, the configuration detection circuitry 420 (FIG. 4) can detect a configuration of the process control system 102 based on the telemetry data. For example, the configuration detection circuitry 420 can determine that the configuration of the process control system 102 includes the application, such as a software version of the application, a developer or vendor of the application, etc. In some examples, the operation state detection circuitry 430 (FIG. 4) can detect that the process control system 102 is in a maintenance state of operation. For example, the operation state detection circuitry 430 can identify that the application on the first workstation 134 stores data indicative of the maintenance state of operation. In some examples, the stored data can indicate, be representative of, and/or otherwise correspond to the first field device 110 reporting that the first fluid flow control assembly 106 is in a safety state, a standby state, an offline state, and/or a maintenance state of operation.

At block 604, the recommendation engine circuitry 400 executes a machine learning model to generate an output based on the at least one of the configuration or the state of operation, the output to be representative of a recommendation to change a portion of the process control system. For example, the ML circuitry 440 (FIG. 4) can execute the ML model(s) 476 with the telemetry data 472 as input(s) to generate output(s), which can include a recommendation to upgrade the application from a first software version to a second software version. In some examples, the ML circuitry 440 can determine, based on the output(s), that the second software version is available in the catalog 478 (FIG. 4); that the second software version is applicable to the first software version; and the first software version is executed and/or instantiated on the first workstation 134 based on the telemetry data 472 and/or the configuration data 474 (FIG. 4).

At block 606, the recommendation engine circuitry 400 causes a change of the portion of the process control system based on the recommendation. For example, the process control update circuitry 460 can transmit the recommendation to one(s) of the field gateways 140 of FIGS. 1 and/or 2. In some examples, the one(s) of the field gateways 140 can transmit a command, an instruction, etc., to the installation agent 156 of the first workstation 134 to update application from the first software version to the second version. In some examples, the one(s) of the field gateways 140 can determine to cause the installation agent 156 to update the application after a determination that the state of operation of portion(s) of the process control system 102 that correspond to the application are in a maintenance state of operation or other state of operation indicative that the update can proceed safely. In response to causing a change of the portion of the process control system based on the recommendation at block 606, the example machine readable instructions and/or the example operations 600 of FIG. 6 conclude.

FIG. 7 is a flowchart representative of example machine readable instructions and/or example operations 700 that may be executed and/or instantiated by processor circuitry to cause an update of a process control system based on a recommendation. The example machine readable instructions and/or the example operations 700 of FIG. 7 begin at block 702, at which the recommendation engine circuitry 400 obtains telemetry data associated with a process control system. For example, the interface circuitry 410 (FIG. 4) can obtain telemetry data associated with the first controllers 126 of FIG. 1. In some examples, the telemetry data can include a firmware version of firmware executed and/or instantiated by the first controllers 126. The interface circuitry 410 can store the telemetry data in the datastore 470 (FIG. 4) as the telemetry data 472 (FIG. 4).

At block 704, the recommendation engine circuitry 400 detects a configuration of the process control system based on the telemetry data. For example, the configuration detection circuitry 420 can detect the configuration of the process control system 102, such as the firmware version of the first controllers 126. In some examples, the configuration detection circuitry 420 can store the firmware version in the configuration data 474 (FIG. 4). In some examples, the configuration detection circuitry 420 can compare the firmware version of the first controllers 126 with a firmware version of the first controllers 126 in the configuration data 474 previously detected and/or stored.

At block 706, the recommendation engine circuitry 400 detects a state of operation of the process control system based on the telemetry data. For example, the operation state detection circuitry 430 (FIG. 4) can determine a state of operation associated with the first controllers 126 based on the telemetry data. For example, the operation state detection circuitry 430 can determine that the telemetry data includes data representative of the first controllers 126 in a maintenance state of operation. For example, the data can be a value of a state of operation parameter (e.g., a parameter that can have a value of run, start, stop, idle, offline, etc.) stored in the first controllers 126.

At block 708, the recommendation engine circuitry 400 executes a machine learning (ML) model with at least one of the configuration or the state of operation as ML input(s) to generate ML output(s). For example, the ML circuitry 440 (FIG. 4) can execute the ML model(s) 476 with at least one of the telemetry data 472 or the configuration data 474 as input(s) to generate output(s).

At block 710, the recommendation engine circuitry 400 generates a recommendation to change the process control system based on the ML output(s). For example, the recommendation generation circuitry 450 (FIG. 4) can generate a recommendation based on the output(s) of the ML model(s) 476. In some examples, the output(s) of the ML model(s) 476 can include data that identifies a newer version of the firmware of the first controllers 126.

At block 712, the recommendation engine circuitry 400 determines whether the recommendation is to be implemented without intervention based on a policy. For example, the process control update circuitry 460 (FIG. 4) can determine that the process control system 102 is associated with a policy, which can be stored in the policy data 480 (FIG. 4). In some examples, the process control update circuitry 460 can determine that the policy specifies that the first controllers 126 are to be upgraded with or without intervention (e.g., partial intervention, full intervention, etc.) by a user, operator, etc.

If, at block 712, the recommendation engine circuitry 400 determines that the recommendation is to be implemented without intervention based on a policy, control proceeds to block 718. If, at block 712, the recommendation engine circuitry 400 determines that the recommendation is to be implemented with intervention based on a policy, control proceeds to block 714.

At block 714, the recommendation engine circuitry 400 requests authorization to implement the recommendation. For example, the process control update circuitry 460 can transmit a request for authorization to the installation agent 156 of the first controllers 126 to carry out the authorization. In some examples, the request for authorization can be presented to a user, such as through a display of the first workstation 134.

At block 716, the recommendation engine circuitry 400 determines whether authorization for the recommendation is received. For example, the installation agent 156 of the first workstation 134 and/or the user can determine that the first controllers 126 are offline or in a maintenance state of operation. In some examples, after the determination that the first controllers 126 are offline or in the maintenance state of operation (e.g., a state of operation indicative of being safe to proceed with an update or upgrade), the installation agent 156 and/or the user can grant the request for authorization to proceed with implementing the recommendation (e.g., upgrading the firmware of the first controllers 126).

If, at block 716, the recommendation engine circuitry 400 determines that the authorization for the recommendation is not received, control returns to block 714, otherwise control proceeds to block 718.

At block 718, the recommendation engine circuitry 400 causes an update of the process control system based on the recommendation. For example, the process control update circuitry 460 can invoke the installation agent 156 of the first controllers 126 to upgrade the firmware of the first controllers 126 based on the recommendation.

At block 720, the recommendation engine circuitry 400 determines whether to continue monitoring the process control system. For example, the process control update circuitry 460 can determine whether to continue obtaining telemetry data associated with the process control system. If, at block 720, the recommendation engine circuitry 400 determines to continue monitoring the process control system, control returns to block 702, otherwise the example machine readable instructions and/or the example operations 700 of FIG. 7 conclude.

FIG. 8 is a flowchart representative of example machine readable instructions and/or example operations 800 that may be executed and/or instantiated by processor circuitry to cause an update of a first process control system based on a second process control system. The example machine readable instructions and/or the example operations 800 of FIG. 8 begin at block 802, at which the recommendation engine circuitry 400 obtains telemetry data of a first process control system. For example, the interface circuitry 410 (FIG. 4) can obtain telemetry data from the process control system 102 of FIGS. 1 and/or 2. In some examples, the interface circuitry 410 can retrieve telemetry data associated with the process control system 102 from the telemetry data 472 stored in the datastore 470.

At block 804, the recommendation engine circuitry 400 executes a machine learning (ML) model using the telemetry data as ML input(s) to output ML output(s) including data classification(s). For example, the ML circuitry 440 (FIG. 4) can execute the ML model(s) 476 with obtained telemetry data and/or the telemetry data 472 in the datastore 470 as input(s) to generate output(s), which can include data classification(s) of the obtained telemetry data and/or the telemetry data 472 in the datastore 470. For example, the output(s) can include a first data classification of a first portion of the telemetry data 472, a second data classification of a second portion of the telemetry data 472, etc.

At block 806, the recommendation engine circuitry 400 identifies a second process control system based on the data classification(s). For example, the configuration detection circuitry 420 (FIG. 4) can identify a different process control system than the process control system 102 of FIGS. 1 and/or 2 based on the first data classification, the second data classification, etc. In some examples, the configuration detection circuitry 420 can identify another process control system in communication with the cloud data center 146 of FIGS. 1 and/or 2 based on the identified process control system having the same or substantially similar data classifications of telemetry data as the process control system 102 of FIGS. 1 and/or 2. For example, the configuration detection circuitry 420 can determine that the identified process control system is associated with and/or similar to (e.g., substantially similar to, matching one or more data classifications of telemetry data, etc.) the process control system 102 of FIGS. 1 and/or 2.

At block 808, the recommendation engine circuitry 400 identifies a configuration of the second process control system. For example, the configuration detection circuitry 420 can identify a configuration of the identified process control system. In some examples, the interface circuitry 410 can obtain the configuration from the identified process control system and/or retrieve the configuration from the configuration data 474 in the datastore 470.

At block 810, the recommendation engine circuitry 400 identifies change(s) to the first process control system based on the configuration of the second process control system. For example, the recommendation generation circuitry 450 (FIG. 4) can identify an application utilized by the identified process control system that is not utilized by the process control system 102 based on a comparison of the respective configurations.

At block 812, the recommendation engine circuitry 400 generates a recommendation to change the first process control system. For example, the recommendation generation circuitry 450 can generate a recommendation indicative of the process control system 102 downloading and/or otherwise utilizing the application.

At block 814, the recommendation engine circuitry 400 causes an update of the first process control system based on the recommendation. For example, the process control update circuitry 460 (FIG. 4) can transmit the recommendation to one(s) of the field gateways 140 of FIGS. 1 and/or 2. In some examples, the recommendation can cause the one(s) of the field gateways 140 to invoke the installation agent of the first workstation 134 and/or the second workstation 136 to download, install, and/or run the application. Advantageously, after a successful download and installation of the application, the first workstation 134 and/or the second workstation 136 can run the application to access and/or enable functionality not previously available to the process control system 102 of FIGS. 1 and/or 2. Advantageously, the recommendation generated in response to the execution of the ML model(s) 476 can improve an efficiency of electronic device(s) of the process control system 102 by being equipped to provide an increased number of features, functions, etc., without increasing the number of electronic device(s).

At block 816, the recommendation engine circuitry 400 determines whether continue monitoring the first process control system. For example, the process control update circuitry 460 can determine whether to continue obtaining telemetry data associated with the process control system 102. If, at block 816, the recommendation engine circuitry 400 determines to continue monitoring the first process control system, control returns to block 802, otherwise the example machine readable instructions and/or the example operations 800 of FIG. 8 conclude.

FIG. 9 is a flowchart representative of example machine readable instructions and/or example operations 900 that may be executed and/or instantiated by processor circuitry to generate a recommendation of application(s) based on a state of operation of a process control system. The example machine readable instructions and/or the example operations 900 of FIG. 9 begin at block 902, at which the recommendation engine circuitry 400 obtains telemetry data of process control system. For example, the interface circuitry 410 (FIG. 4) can obtain telemetry data associated with the first field device 110 of FIGS. 1 and/or 2, and/or, more generally, the first fluid flow control assembly 106 of FIGS. 1 and/or 2. In some examples, the telemetry data can include a quantity and/or type of components of the process control system 102 or components to be added to the process control system 102. In some examples, the telemetry data can include a state of operation of the process control system 102, or portion(s) thereof, such as whether the process control system 102 is in a design state of operation, a fully operational state of operation, a maintenance state of operation, etc.

At block 904, the recommendation engine circuitry 400 detects whether the process control system is in a design operation state. For example, the operation state detection circuitry 430 (FIG. 4) can detect, identify, and/or otherwise determine that the process control system 102 is in a design operation state. If, at block 904, the recommendation engine circuitry 400 detects that the process control system is not in a design operation state, control proceeds to block 908, otherwise control proceeds to block 906.

At block 906, the recommendation engine circuitry 400 generates a recommendation of application(s) associated with a process control system in a design operation state. For example, the recommendation generation circuitry 450 (FIG. 4) can generate a recommendation of application(s), container(s), etc., in the catalog 478 (FIG. 4) that can be executed and/or instantiated by the process control system 102 based on the telemetry data. In some examples, the recommendation can include an application and/or container that can be executed and/or instantiated to design a process control system, configure a process control system, program portion(s) of a process control system, etc., and/or any combination(s) thereof. After generating a recommendation of application(s) associated with a process control system in a design operation state at block 906, control proceeds to block 908.

At block 908, the recommendation engine circuitry 400 detects whether the process control system is in a fully enabled operation state. For example, the operation state detection circuitry 430 can detect, identify, and/or otherwise determine that the process control system 102 is in a fully enabled operation state. If, at block 908, the recommendation engine circuitry 400 detects that the process control system is not in a fully enabled operation state, control proceeds to block 912, otherwise control proceeds to block 910.

At block 910, the recommendation engine circuitry 400 generates a recommendation of application(s) associated with a process control system in a fully enabled operation state. For example, the recommendation generation circuitry 450 can generate a recommendation of application(s), container(s), etc., in the catalog 478 that can be executed and/or instantiated by the process control system 102 based on the telemetry data. In some examples, the recommendation can include an application and/or container that can be executed and/or instantiated to collect telemetry data associated with a process control system, share and/or store process parameter data, effectuate prognostic health monitoring of process control components based on process parameter data, etc., and/or any combination(s) thereof. After generating a recommendation of application(s) associated with a process control system in a fully enabled operation state at block 910, control proceeds to block 912.

At block 912, the recommendation engine circuitry 400 detects whether the process control system is in a maintenance operation state. For example, the operation state detection circuitry 430 can detect, identify, and/or otherwise determine that the process control system 102 is in a maintenance operation state. If, at block 912, the recommendation engine circuitry 400 detects that the process control system is not in a maintenance operation state, control proceeds to block 916, otherwise control proceeds to block 914.

At block 914, the recommendation engine circuitry 400 generates a recommendation of application(s) associated with a process control system in a maintenance operation state. For example, the recommendation generation circuitry 450 can generate a recommendation of application(s), container(s), etc., in the catalog 478 that can be executed and/or instantiated by the process control system 102 based on the telemetry data. In some examples, the recommendation can include an application and/or container that can be executed and/or instantiated to diagnose a process control component (e.g., the field devices 110, 116, the controllers 126, 130, etc.), change firmware version(s) of a process control component, change hardware configuration(s) of a process control component, etc., and/or any combination(s) thereof. After generating a recommendation of application(s) associated with a process control system in a maintenance operation state at block 914, control proceeds to block 916.

At block 916, the recommendation engine circuitry 400 determines whether to continue monitoring the process control system. For example, the interface circuitry 410 can determine whether to continue obtaining telemetry of the process control system 102. If, at block 916, the recommendation engine circuitry 400 determines to continue monitoring the process control system, control returns to block 902, otherwise the example machine readable instructions and/or the example operations 900 of FIG. 9 conclude.

FIG. 10 is a flowchart representative of example machine readable instructions and/or example operations 1000 that may be executed and/or instantiated by processor circuitry to cause an update of a process control system based on a recommendation. The example machine readable instructions and/or the example operations 1000 of FIG. 10 begin at block 1002, at which the recommendation engine circuitry 400 identifies a configuration of a process control system based on at least one of telemetry data or stored configuration. For example, the configuration detection circuitry 420 (FIG. 4) can identify a configuration of the process control system 102 based on at least one of (i) the telemetry data 472 that corresponds to the process control system 102 or (ii) a configuration in the configuration data 474 that corresponds to the process control system 102. In some examples, the configuration detection circuitry 420 can determine that the configuration of the process control system 102 includes an application with a first software version and a first software license (e.g., a software license to enable or active one or more first software features).

At block 1004, the recommendation engine 400 detects whether there is/are new version(s) of application(s) associated with the configuration. For example, the process control update circuitry 460 (FIG. 4) can detect a second software version in the catalog 478 (FIG. 4) that correspond(s) to the application.

If, at block 1004, the recommendation engine 400 detects that there is/are no new version(s) of application(s) associated with the configuration, control proceeds to block 1008, otherwise control proceeds to block 1006.

At block 1006, the recommendation engine 400 facilitates upgrade(s) of the application(s) based on a service level agreement. For example, the process control update circuitry 460 can cause the installation agent 156 of the first workstation 134 and/or the second workstation 136 to upgrade the application to the second software version based on an SLA included in the policy data 480 (FIG. 4) that corresponds to the process control system 102. In some examples, the process control update circuitry 460 can determine that the SLA sets forth that upgrades are to be carried out automatically, semiautomatically, or manually.

At block 1008, the recommendation engine 400 detects whether new software licenses is/are applicable to the configuration. For example, the process control update circuitry 460 can detect a second software license (e.g., a software license to enable or active one or more second software features that may be different from one(s) of the one or more first software features) in the catalog 478 that correspond(s) to the application.

If, at block 1008, the recommendation engine 400 detects that new software licenses is/are not applicable to the configuration, control proceeds to block 1012, otherwise control proceeds to block 1010.

At block 1010, the recommendation engine circuitry 400 transmits an alert to the process control system indicative of availability of the new software license(s). For example, the interface circuitry 410 (FIG. 4) can transmit an alert, a message, etc., including data representative of a notification of availability of the second software license to one(s) of the field gateways 140 of FIGS. 1 and/or 2. In some examples, the one(s) of the field gateways 140 can provide the alert, the message, etc., or portion(s) thereof, to one(s) of the workstations 134, 136 for display or presentation to a user.

At block 1012, the recommendation engine 400 determines whether to continue monitoring the process control system. For example, the process control update circuitry 460 can determine whether to verify if the configuration of the process control system 102 has changed and/or if change(s) to the configuration is/are available.

If, at block 1012, the recommendation engine 400 determines to continue monitoring the process control system, control returns to block 1002, otherwise the example machine readable instructions and/or the example operations 1000 of FIG. 10 conclude.

FIG. 11 is a flowchart representative of example machine readable instructions and/or example operations 1100 that may be executed and/or instantiated by processor circuitry to effectuate a recovery of a process control system after a failure of the process control system. The example machine readable instructions and/or the example operations 1100 of FIG. 11 begin at block 1102, at which the recommendation engine 400 determines whether a request for recovery of process control system has been received after failure of the process control system. For example, the interface circuitry 410 (FIG. 4) can determine that a request is received from the process control system 102 to recover portion(s) of the process control system 102 after a failure associated with the process control system 102 has occurred.

If, at block 1102, the recommendation engine 400 determines that a request for recovery of process control system has been not received after failure of the process control system, control waits, such as waiting for time period after which another determination can be made.

If, at block 1102, the recommendation engine 400 determines that a request for recovery of process control system has been received after failure of the process control system, control proceeds to block 1104.

At block 1104, the recommendation engine circuitry 400 identifies a configuration of the process control system based on at least one of telemetry data or a stored configuration. For example, the configuration detection circuitry 420 (FIG. 4) can identify a configuration of the process control system 102 based on at least one of the telemetry data 472 (FIG. 4) or the configuration data 474 (FIG. 4).

At block 1106, the recommendation engine circuitry 400 identifies application(s) corresponding to the configuration. For example, the configuration detection circuitry 420 can identify an application, a container, firmware, a hardware configuration, etc., corresponding to the configuration of the process control system 102.

At block 1108, the recommendation engine circuitry 400 distributes the application(s) to the process control system to cause the recovery of the process control system. For example, the interface circuitry 410 can transmit and/or otherwise distribute the application, the container, the firmware, the hardware configuration, etc., from the catalog 478 (FIG. 4) to the process control system 102 via at least one of the edge gateways 142 or the field gateways 140 of FIGS. 1 and/or 2. In some examples, the at least one of the edge gateways 142 or the field gateways 140 can transmit and/or otherwise distribute the application, the container, the firmware, the hardware configuration, etc., to the installation agents 156 of corresponding one(s) of the controllers 126, 130, the workstations 134, 136, or the field gateways 140 for installation, configuration, and/or deployment to cause the recovery of the process control system 102.

At block 1110, the recommendation engine circuitry 400 detects whether the process control system has recovered. For example, the configuration detection circuitry 420 can detect whether one(s) of the controllers 126, 130, the workstations 134, 136, or the field gateways 140 are operational (e.g., telemetry data is received from such component(s)) after reinstallation of the application, the container, the firmware, the hardware configuration, etc.

If, at block 1110, the recommendation engine circuitry 400 detects that the process control system has not recovered, control returns to block 1108, otherwise control proceeds to block 1112.

At block 1112, the recommendation engine circuitry 400 determines whether to continue monitoring the process control system. For example, the interface circuitry 410 can determine whether another request for a recovery operation has been received. If, at block 1112, the recommendation engine circuitry 400 determines to continue monitoring the process control system, control returns to block 1102, otherwise the example machine readable instructions and/or the example operations 1100 of FIG. 11 conclude.

FIG. 12 is a flowchart representative of example machine readable instructions and/or example operations 1200 that may be executed and/or instantiated by processor circuitry to effectuate execution of an application on at least one of a cloud host or a client electronic device. The example machine readable instructions and/or the example operations 1200 of FIG. 12 begin at block 1202, at which the recommendation engine circuitry 400 determines whether a request to access an application is received. For example, the interface circuitry 410 (FIG. 4) can determine that a request has been received from the process control system 102 to access an application from the catalog 478 (FIG. 4).

If, at block 1202, the recommendation engine circuitry 400 determines that a request to access an application is not received, control waits, such as waiting for a time period after which another determination can be made. If, at block 1202, the recommendation engine circuitry 400 determines that a request to access an application is received, control proceeds to block 1204.

At block 1204, the recommendation engine circuitry 400 determines whether the request indicates the access is for execution of the application by a cloud host. For example, the process control update circuitry 460 (FIG. 4) can determine that the request includes data indicative of executing an application to be hosted by a cloud host (e.g., a server, a virtualized server instantiated by the server, a virtual machine instantiated by the server, a container instantiated by the server, etc.) instantiated by the cloud data center 146. In some examples, the execution of the application to be hosted by the cloud data center 146 can be implemented via a web browser application, a web browser plug-in application, etc.

If, at block 1204, the recommendation engine circuitry 400 determines that the request indicates that the access is for execution of the application by a cloud host, control proceeds to block 1206. At block 1206, the recommendation engine circuitry 400 instantiates the application on the cloud host for remote execution. For example, the process control update circuitry 460 can instruct the cloud data center 146 to execute and/or instantiate the requested application. In some examples, the workstations 134, 136 of the process control system 102 can interact with the application on the cloud host via a web browser to implement remote execution of the application. After instantiating the application on the cloud host for remote execution at block 1206, control proceeds to block 1210.

If, at block 1204, the recommendation engine circuitry 400 determines that the request does not indicate that the access is for execution of the application by a cloud host, control proceeds to block 1208.

At block 1208, the recommendation engine circuitry 400 causes a download of the application to a client electronic device for local execution. For example, the interface circuitry 410 can cause the workstations 134, 136 to download the application for execution on the workstations 134, 136 to implement local execution of the application.

After causing a download of the application to a client electronic device for local execution at block 1208, control proceeds to block 1210.

At block 1210, the recommendation engine circuitry 400 determines whether feedback associated with the application is identified. For example, the process control update circuitry 460 can determine that an online message board, blog, discussion forum, etc., which can be hosted by the cloud data center 146, identifies the application. In some examples, the process control update circuitry 460 can determine that the application is associated with feedback (e.g., user feedback), review(s) (e.g., user review(s)), etc., of feature(s) of the application and/or, more generally, the application.

If, at block 1210, the recommendation engine circuitry 400 determines that feedback associated with the application is not identified, control proceeds to block 1216, otherwise control proceeds to block 1212.

At block 1212, the recommendation engine circuitry 400 identifies change(s) to the application based on the feedback. For example, the process control update circuitry 460 can parse language from the feedback, review(s), etc., using natural language processing techniques into machine readable data. In some examples, the process control update circuitry 460 can identify feature(s) associated with the application based on the machine readable data. In some examples, the process control update circuitry 460 can identify change(s) implicated by the feedback, the review(s), etc., based on a comparison of the identified feature(s) and portion(s) of the feedback, the review(s), etc.

At block 1214, the recommendation engine circuitry 400 redeploys the application for access based on the change(s). For example, the process control update circuitry 460 can recompile the application to include and/or otherwise implement the change(s). In some examples, the process control update circuitry 460 can provide the change(s) to a developer; the developer can recompile the application with the changes; and provide the recompiled application to the process control update circuitry 460 for authentication and/or storage in the catalog 478. In some examples, the interface circuitry 410 can propagate an alert, a notification, etc., that is indicative of a new version of the application ready for use. In some examples, the interface circuitry 410 can propagate the alert, the notification, etc., to process control system(s), such as the process control system 102 of FIGS. 1 and/or 2, that are utilizing the application.

At block 1216, the recommendation engine circuitry 400 determines whether to continue monitoring for requests to access an application. For example, the process control update circuitry 460 can determine whether another request to access an application is received. If, at block 1216, the recommendation engine circuitry 400 determines to continue monitoring for requests to access an application, control returns to block 1202, otherwise the example machine readable instructions and/or the example operations 1200 of FIG. 12 conclude.

FIG. 13 is a flowchart representative of example machine readable instructions and/or example operations 1300 that may be executed and/or instantiated by processor circuitry to implement a process control system marketplace. The example machine readable instructions and/or the example operations 1300 of FIG. 13 begin at block 1302, at which the recommendation engine circuitry 400 obtains an application or container from developer for execution by process control network. For example, the interface circuitry 410 (FIG. 4) can obtain an application, container, firmware, hardware configuration, etc., from a developer associated with the cloud data center 146 or not associated with the cloud data center 146 (e.g., a third-party hardware, software, and/or firmware developer). In some examples, the application, the container, the firmware, the hardware configuration, etc., can be utilized by the process control system 102 to carry out, perform, etc., a process control operation.

At block 1304, the recommendation engine circuitry 400 authenticates the application or container for insertion to a catalog. For example, the process control update circuitry 460 (FIG. 4) can authenticate an application from a developer by determining whether the application and/or the developer satisfy the terms and conditions associated with adding the application to the catalog 478 (FIG. 4).

At block 1306, the recommendation engine circuitry 400 determines whether the application or the container is authenticated. For example, the process control update circuitry 460 can determine that the application is authenticated based on the application and/or the developer satisfying the terms and conditions associated with adding the application to the catalog 478.

If, at block 1306, the recommendation engine circuitry 400 determines that the application or the container is not authenticated, control proceeds to block 1308. At block 1308, the recommendation engine circuitry 400 rejects the application or container from addition to the catalog. For example, the process control update circuitry 460 can prevent the application from being added to the catalog 478 after a determination that the application and/or the developer do not conform to the terms and conditions associated with adding the application to the catalog 478. After rejecting the application or container from addition to the catalog at block 1308, control proceeds to block 1316.

If, at block 1306, the recommendation engine circuitry 400 determines that the application or the container is authenticated, control proceeds to block 1310.

At block 1310, the recommendation engine circuitry 400 adds the application or container to the catalog. For example, the process control update circuitry 460 can add the application to the catalog 478 after a determination that the application and/or the developer conform to the terms and conditions associated with adding the application to the catalog 478. After adding the application or container to the catalog at block 1310, control proceeds to block 1312.

At block 1312, the recommendation engine circuitry 400 determines whether the application or container is a beta version. For example, the process control update circuitry 460 can determine that the application is a beta version, such as a version of the application that is not available for general use and may be used by users who opt-ed into using beta versions of applications.

If, at block 1312, the recommendation engine circuitry 400 determines that the application or container is not a beta version, control proceeds to block 1316, otherwise control proceeds to block 1314.

At block 1314, the recommendation engine circuitry 400 publishes an alert to users who opt-in to beta version releases. For example, the interface circuitry 410 can transmit an alert indicative of the availability of a beta version of the application to user(s) who opted-in to trying out and/or otherwise accessing beta versions of process control applications. After publishing an alert to users who opt-in to beta version releases at block 1314, control proceeds to block 1316.

At block 1316, the recommendation engine circuitry 400 determines whether a client electronic device has accessed the application or container. For example, the interface circuitry 410 can obtain telemetry data from the first workstation 134 in response to the first workstation 134 accessing the application. In some examples, the application may include machine readable code that, when executed and/or instantiated, cause the first workstation 134 to transmit telemetry data associated with the application to the cloud data center 146.

If, at block 1316, the recommendation engine circuitry 400 determines that a client electronic device has not accessed the application or container, the example machine readable instructions and/or the example operations 1300 conclude.

If, at block 1316, the recommendation engine circuitry 400 determines that a client electronic device has accessed the application or container, control proceeds to block 1318.

At block 1318, the recommendation engine circuitry 400 decrements token(s) from a first token balance recorded on a ledger, the first token balance corresponding to the client electronic device. For example, the process control update circuitry 460 can determine that the access of the application costs and/or otherwise is associated with a consumption of 50 tokens. In some examples, the process control update circuitry 460 can identify a first token balance recorded on a ledger, such as a blockchain, that corresponds to the first workstation 134, and/or, more generally, an entity (e.g., a logical entity, a corporate entity, a user entity, etc.) associated with the first workstation 134. For example, the process control update circuitry 460 can decrement 50 tokens from the first token balance to effectuate payment (e.g., payment through digital or electronic processes) for the access of the application.

At block 1320, the recommendation engine circuitry 400 increments the token(s) for a second token balance recorded on the ledger, the second token balance corresponding to the developer to effectuate payment for the access by the client electronic device. For example, the process control update circuitry 460 can identify a second token balance recorded on the ledger that corresponds to a developer of the application. In some examples, the process control update circuitry 460 can increment and/or otherwise add 50 tokens to the second token balance to effectuate payment (e.g., payment through digital or electronic processes) for the access of the application by the first workstation 134. After incrementing the token(s) for a second token balance recorded on the ledger at block 1320, the example machine readable instructions and/or the example operations 1300 of FIG. 13 conclude.

FIG. 14 is a flowchart representative of example machine readable instructions and/or example operations 1400 that may be executed and/or instantiated by processor circuitry to cause a change of a field device based on a recommendation. The example machine readable instructions and/or the example operations 1400 of FIG. 14 begin at block 1402, at which the gateway circuitry 500 classifies, with a machine learning model, telemetry data associated with a field device into at least first data with a first data classification and second data with a second data classification. For example, the interface circuitry 510 (FIG. 5) can collect and/or otherwise obtain the telemetry data 572 from a field device, such as the controllers 126, 130 of FIGS. 1 and/or 2. For example, the ML circuitry 540 (FIG. 5) can execute the ML model(s) 576 with the telemetry data 572 as input(s) to generate output(s), which can include a first data classification of the telemetry data 572 and a second data classification of the telemetry data 572.

At block 1404, the gateway circuitry 500 transmits at least one of the first data or the second data to a server based on policy data. For example, the process control update circuitry 560 (FIG. 5) can determine that data having the first data classification is to remain within the process control system 102 based on a data security policy included in the policy data 580 (FIG. 5). In some examples, the process control update circuitry 560 can determine that data having the second data classification may be shared with the cloud data center 146 of FIGS. 1 and/or 2 based on the data security policy. For example, the process control update circuitry 560 can invoke the interface circuitry 510 to transmit the second data with the second data classification to the cloud data center 146. In some examples, the second data can include a first firmware version of firmware installed on the controllers 126, 130.

At block 1406, the gateway circuitry 500 receives a recommendation to change the field device from the server. For example, the cloud data center 146 can generate a recommendation to change the first firmware to a second firmware version, which can be newer or later than the first firmware version.

At block 1408, the gateway circuitry 500 causes the change of the field device based on the recommendation. For example, the process control update circuitry 560 can instruct the installation agent 156 of the controllers 126, 130 to change the firmware of the controllers 126, 130 from the first firmware version to the second firmware version. After causing the change of the field device based on the recommendation at block 1408, the example machine readable instructions and/or the example operations 1400 of FIG. 14 conclude.

FIG. 15 is a flowchart representative of example machine readable instructions and/or example operations 1500 that may be executed and/or instantiated by processor circuitry to cause a change of at least one of firmware or software of a process control system based on recommendation(s). The example machine readable instructions and/or the example operations 1500 of FIG. 15 begin at block 1502, at which the gateway circuitry 500 collects telemetry data of process control system. For example, the interface circuitry 510 (FIG. 5) can obtain telemetry data associated with the first workstation 134 of FIGS. 1 and/or 2 and store the telemetry data in the datastore 570 (FIG. 5) as the telemetry data 572 (FIG. 5).

At block 1504, the gateway circuitry 500 classifies the telemetry data. For example, the ML circuitry 540 (FIG. 5) can execute the ML model(s) 576 with the telemetry data 572 as data input(s) to generate data output(s), which can include a first data classification of first data of the telemetry data 572 and a second data classification of second data of the telemetry data 572. In some examples, the first data classification and the second data classification can be specified and/or otherwise defined by a policy, such as an SLA, that is stored as part of the policy data 580 (FIG. 5).

At block 1506, the gateway circuitry 500 identifies portion(s) of the telemetry data to send to server based on service level agreement. For example, the process control update circuitry 560 (FIG. 5) can identify the first data as not to be transmitted to the cloud data center 146 of FIGS. 1 and/or 2 after a determination that the first data has the first data classification, which is defined to not be sent external to the process control system 102 per the SLA. In some examples, the process control update circuitry 560 can identify the second data as to be transmitted to the cloud data center 146 after a determination that the second data has the second data classification, which is defined to be sent external to the process control system 102 per the SLA.

At block 1508, the gateway circuitry 500 transmits the portion(s) of the telemetry data to the server. For example, the interface circuitry 510 can transmit the second data with the second data classification to the cloud data center 146. In some examples, the cloud data center 146 can generate a recommendation of change(s) to the first workstation 134, and/or, more generally, the process control system 102, based on the second data.

At block 1510, the gateway circuitry 500 receives recommendation(s) from the server to change the process control system. For example, the interface circuitry 510 can obtain data from the cloud data center 146. In some examples, the data can be representative of a recommendation to install an application not yet installed on the first workstation 134.

At block 1512, the gateway circuitry 500 changes at least one of firmware or software of the process control system based on the recommendation(s). For example, the process control update circuitry 560 can instruct the installation agent 156 of the first workstation 134 to install the application to unlock and/or enable new features (e.g., field device control features, field device diagnostic features, field device data collection features, data analysis features, prognostic health monitoring features, etc.) that may not have been previously available to the process control system 102.

At block 1514, the gateway circuitry 500 determines whether to continue collecting telemetry data. For example, the interface circuitry 510 can determine whether to continue collecting telemetry data. If, at block 1514, the gateway circuitry 500 determines to continue collecting telemetry data, control returns to block 1502, otherwise the example machine readable instructions and/or the example operations 1500 of FIG. 15 conclude.

FIG. 16 is a flowchart representative of example machine readable instructions and/or example operations 1600 that may be executed and/or instantiated by processor circuitry to transmit telemetry data to a server. The example machine readable instructions and/or the example operations 1600 of FIG. 16 begin at block 1602, at which the gateway circuitry 500 collects first data associated with field devices including at least one of process parameter data, configuration data, hardware versions, or firmware versions. For example, the interface circuitry 510 (FIG. 5) can obtain telemetry data associated with the field devices 110, 116 of FIGS. 1 and/or 2, such as a firmware version, a hardware configuration, process parameter data (e.g., pressure sensor measurement data values, analog current measurements corresponding to sensor measurements, voltage measurements corresponding to sensor measurements, etc.), etc. In some examples, the telemetry data associated with the field devices 110, 116 can be stored in the datastore 570 (FIG. 5) as the telemetry data 572 (FIG. 5).

At block 1604, the gateway circuitry 500 collects second data associated with controller(s) including at least one of configuration data, hardware version(s), or firmware version(s). For example, the interface circuitry 510 can collect telemetry data associated with the controllers 126, 130 of FIGS. 1 and/or 2, such as a firmware version, a hardware version, a hardware configuration, etc. In some examples, the telemetry data associated with the controllers 126, 130 can be stored in the datastore 570 as the telemetry data 572.

At block 1606, the gateway circuitry 500 collects third data associated with gateway(s) including at least one of configuration data, hardware version(s), or firmware version(s). For example, the interface circuitry 510 can collect telemetry data associated with one(s) of the field gateways 140 and/or one(s) of the edge gateways 142 of FIGS. 1 and/or 2, such as a firmware version, a hardware version, a hardware configuration, etc. In some examples, the telemetry data associated with the one(s) of the field gateways 140 and/or the one(s) of the edge gateways 142 can be stored in the datastore 570 as the telemetry data 572.

At block 1608, the gateway circuitry 500 collects fourth data associated with application(s) including at least one of configuration data, software version(s), or license(s). For example, the interface circuitry 510 can collect telemetry data associated with the first workstation 134 and/or the second workstation 136 of FIGS. 1 and/or 2, such as software version(s) of installed application(s), configuration data associated with the process control system 102, license(s) assigned to the first workstation 134 and/or the second workstation 136, etc. In some examples, the telemetry data associated with the first workstation 134 and/or the second workstation 136 can be stored in the datastore 570 as the telemetry data 572.

At block 1610, the gateway circuitry 500 collects fifth data associated with process control system including at least one of environment data, stage of operation data, or operator identification data. For example, the interface circuitry 510 can collect telemetry data associated with the process control system 102, which can include a stage of operation of the process control system 102 (or portion(s) thereof), an identifier of an operator of the process control system 102, environment data (e.g., ambient temperature data, precipitation amount data, light sensor data, wind speed data, a time of year, etc.) associated with the process control system 102, etc. In some examples, the telemetry data associated with the process control system 102 can be stored in the datastore 570 as the telemetry data 572.

At block 1612, the gateway circuitry 500 classifies at least one of the first data, the second data, the third data, the fourth data, or the fifth data with a machine learning (ML) model. For example, the ML circuitry 540 (FIG. 5) can classify, with the ML model(s) 576 (FIG. 5), at least one of the first data, the second data, the third data, the fourth data, or the fifth data into one or more data classifications.

At block 1614, the gateway circuitry 500 identifies portion(s) of the at least one of first data, the second data, the third data, the fourth data, or the fifth data for external transmission based on the classifications. For example, the process control update circuitry 560 (FIG. 5) can determine whether at least one of the first data, the second data, the third data, the fourth data, or the fifth data is to be transmitted to the cloud data center 146 based on the classifications.

At block 1616, the gateway circuitry 500 transmits the portion(s) of the at least one of the first data, the second data, the third data, the fourth data, or the fifth data to server. For example, the interface circuitry 510 can transmit at least one of the first data, the second data, the third data, the fourth data, or the fifth data to the cloud data center 146 based on the classifications.

At block 1618, the gateway circuitry 500 determines whether to continue collecting data. For example, the interface circuitry 510 can determine whether to continue collecting telemetry data associated with the process control system 102. If, at block 1618, the gateway circuitry 500 determines to continue collecting data, control returns to block 1602, otherwise the example machine readable instructions and/or the example operations 1600 of FIG. 16 conclude.

FIG. 17 is a flowchart representative of example machine readable instructions and/or example operations 1700 that may be executed and/or instantiated by processor circuitry to carry out a recovery operation. The example machine readable instructions and/or the example operations 1700 of FIG. 17 begin at block 1702, at which the gateway circuitry 500 determines whether a recovery operation is needed in a process control system after failure(s). For example, the operation state detection circuitry 530 (FIG. 5) can determine that portion(s) of the process control system 102 experienced a failure or is/are offline or non-responsive to commands, requests, etc.

If, at block 1702, the gateway circuitry 500 determines that a recovery operation is not needed in a process control system after failure(s), control proceeds to block 1710, otherwise control proceeds to block 1704.

At block 1704, the gateway circuitry 500 requests a server to perform a recovery operation. For example, the interface circuitry 510 (FIG. 5) can transmit a request to the cloud data center 146 to carry out a recovery operation associated with failed, offline, or non-responsive portion(s) of the process control system 102.

At block 1706, the gateway circuitry 500 installs at least one of firmware or application(s) on device(s) in the process control system based on configuration data stored by the server. For example, the process control update circuitry 560 (FIG. 5) can obtain at least one of firmware or application(s) to be installed (or reinstalled) on the failed, offline, or non-responsive portion(s) of the process control system 102. For example, the process control update circuitry 560 can cause the installation agent 156 of the first workstation 134 to install (or reinstall) one or more applications after a failure of the first workstation 134. In some examples, the installation agent 156 can install (or reinstall) the one or more applications based on the configuration data 474 of FIG. 4.

At block 1708, the gateway circuitry 500 configures the device(s) in the process control system based on configuration data stored by the server. For example, the process control update circuitry 560 can invoke the installation agent of the first workstation 134 to configure the one or more applications based on the configuration data 474 of FIG. 4.

At block 1710, the gateway circuitry 500 determines whether to continue monitoring the process control system. For example, the interface circuitry 510 can determine whether to continue monitoring the process control system 102, such as whether a failure is present. If, at block 1710, the gateway circuitry 500 determines to continue monitoring the process control system, control returns to block 1702, otherwise the example machine readable instructions and/or the example operations 1700 of FIG. 17 conclude.

FIG. 18 is a flowchart representative of example machine readable instructions and/or example operations 1800 that may be executed and/or instantiated by processor circuitry to upgrade a device of a process control system. The example machine readable instructions and/or the example operations 1800 of FIG. 18 begin at block 1802, at which the gateway circuitry 500 determines whether a recommendation to upgrade a device in a process control system is received. For example, the interface circuitry 510 (FIG. 5) can determine that a recommendation from the cloud data center 146 of FIGS. 1 and/or 2 is received. In some examples, the recommendation can include a change of a first firmware version of firmware of the first field device 110 of FIGS. 1 and/or 2 to a second firmware version to implement an upgrade of the first field device 110.

If, at block 1802, the gateway circuitry 500 determines that a recommendation to upgrade a device in a process control system is not received, control waits, such as waiting for a time period after which another determination may be made.

If, at block 1802, the gateway circuitry 500 determines that a recommendation to upgrade a device in a process control system is received, control proceeds to block 1804.

At block 1804, the gateway circuitry 500 determines a permission access level for the device based on a service level agreement. For example, the process control update circuitry 560 (FIG. 5) can determine that a permission access level for the first field device 110 is a manual permission access due to safety considerations of modifying the first field device 110 while the first field device 110 is in operation. In some examples, the permission access level can be defined and/or otherwise specified by or in an SLA of the policy data 580.

At block 1806, the gateway circuitry 500 determines whether the permission access level is an automatic permission access level. For example, the process control update circuitry 560 can determine that the permission access level associated with the first field device 110 is an automatic permission access level, which can indicate that the first field device 110 can be upgraded without user intervention.

If, at block 1806, the gateway circuitry 500 determines that the permission access level is an automatic permission access level, control proceeds to block 1808.

At block 1808, the gateway circuitry 500 determines whether the device is in at least one of a standby or maintenance stage of operation. For example, the operation state detection circuitry 530 (FIG. 5) can detect whether the first field device 110 is in at least one of a standby or maintenance stage of operation to ensure that an upgrade of the first field device 110 is carried out safely.

If, at block 1808, the gateway circuitry 500 determines that the device is not in at least one of a standby or maintenance stage of operation, control waits at block 1808 for a period of time after which another determination may be made before proceeding.

If, at block 1808, the gateway circuitry 500 determines that the device is in at least one of a standby or maintenance stage of operation, control proceeds to block 1810.

At block 1810, the gateway circuitry 500 upgrades the device. For example, the process control update circuitry 560 can send a message to the installation agent 156 of the first controllers 130 to cause the first controllers 130 to upgrade the firmware of the first field device 110 from the first firmware version to the second firmware version. In some examples, the message can include the second firmware version of the firmware. In some examples, the installation agent 156 can send a first message to the first field device 110 to initialize the firmware upgrade and a second message that includes the second firmware version of the firmware. In some examples in which a bank of controllers are used in the process control system 102, control logic or workloads being executed by first one(s) of the bank of controllers being upgraded can be moved to second available one(s) of the bank of controllers to enable the first one(s) safe to update. After upgrading the device at block 1810, control proceeds to block 1818.

If, at block 1806, the gateway circuitry 500 determines that the permission access level is not an automatic permission access level, control proceeds to block 1812. In some examples, automatic permission access level can be discovered through the configuration discovery process. For example, when a user is granted electronic signature authority, the user can be automatically granted permission access levels appropriate for the marketplace application 154. Similarly, user roles for the process control system 102 such as configuration engineer or reliability engineer that are contained with the user database of the process control system 102 can be automatically granted permission access levels during the configuration discovery process.

At block 1812, the gateway circuitry 500 determines whether the permission access level is a semi-automatic permission access level. For example, the process control update circuitry 560 can determine whether the permission access level associated with the first field device 110 as defined by the SLA can indicate that the permission access level is a semi-automatic permission access level. For example, the semi-automatic permission access level can correspond to a stage upgrade of the device in which one or more stages or operations are to be completed automatically (e.g., automatically via hardware, software, and/or firmware) and one or more stages or operations are to be completed manually by a user.

If, at block 1812, the gateway circuitry 500 determines that the permission access level is not a semi-automatic permission access level, control proceeds to block 1816, otherwise control proceeds to block 1814.

At block 1814, the gateway circuitry 500 stages an upgrade of the device. For example, the process control update circuitry 560 can execute one or more stages or operations of updating the firmware of the first field device 110 without user intervention.

At block 1816, the gateway circuitry 500 causes a user to upgrade the device. For example, the process control update circuitry 560 can alert a user to manually execute one or more stages or operations of updating the firmware of the first field device 110.

At block 1818, the gateway circuitry 500 determines whether to continue monitoring the process control system. For example, the interface circuitry 510 can determine whether to check if another recommendation to upgrade a device in the process control system 102 is received. If, at block 1818, the gateway circuitry 500 determines to continue monitoring the process control system, control returns to block 1802, otherwise the example machine readable instructions and/or the example operations 1800 of FIG. 18 conclude.

FIG. 19 is a block diagram of an example processor platform 1900 structured to execute and/or instantiate the example machine readable instructions and/or the example operations of FIGS. 6-13 to implement the recommendation engine circuitry 400 of FIG. 4. The processor platform 1900 can be, for example, a server, a personal computer, a workstation, a self-learning machine (e.g., a neural network), or any other type of computing device.

The processor platform 1900 of the illustrated example includes processor circuitry 1912. The processor circuitry 1912 of the illustrated example is hardware. For example, the processor circuitry 1912 can be implemented by one or more integrated circuits, logic circuits, FPGAs, microprocessors, CPUs, GPUs, DSPs, and/or microcontrollers from any desired family or manufacturer. The processor circuitry 1912 may be implemented by one or more semiconductor based (e.g., silicon based) devices. In this example, the processor circuitry 1912 implements the configuration detection circuitry 420 (identified by CONFIG DETECT CIRCUITRY), the operation state detection circuitry 430 (identified by OP STATE DETECT CIRCUITRY), the ML circuitry 440 (identified by ML circuitry), the recommendation generation circuitry 450 (identified by REC GEN CIRCUITRY), and the process control update circuitry 460 (identified by PCNTRL UPDATE CIRCUITRY) of FIG. 4.

The processor circuitry 1912 of the illustrated example includes a local memory 1913 (e.g., a cache, registers, etc.). The processor circuitry 1912 of the illustrated example is in communication with a main memory including a volatile memory 1914 and a non-volatile memory 1916 by a bus 1918. In some examples, the bus 1918 can implement the bus 490 of FIG. 4. The volatile memory 1914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1916 may be implemented by flash memory and/or any other desired type of memory device. Access to the main memory 1914, 1916 of the illustrated example is controlled by a memory controller 1917.

The processor platform 1900 of the illustrated example also includes interface circuitry 1920. The interface circuitry 1920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 1920 implements the interface circuitry 410 of FIG. 4.

In the illustrated example, one or more input devices 1922 are connected to the interface circuitry 1920. The input device(s) 1922 permit(s) a user to enter data and/or commands into the processor circuitry 1912. The input device(s) 1922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1924 are also connected to the interface circuitry 1920 of the illustrated example. The output device(s) 1924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1920 of the illustrated example, thus, typically includes a graphics driver card, a graphics driver chip, and/or graphics processor circuitry such as a GPU.

The interface circuitry 1920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1926. The communication can be by, for example, an Ethernet connection, a digital subscriber line (DSL) connection, a telephone line connection, a coaxial cable system, a satellite system, a line-of-site wireless system (e.g., a mesh wireless network), a cellular telephone system, an optical connection, etc.

The processor platform 1900 of the illustrated example also includes one or more mass storage devices 1928 to store software and/or data. Examples of such mass storage devices 1928 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 1928 implement the datastore 470, the telemetry data 472 (identified by TELEMETRY), the configuration data 474 (identified by CONFIG), the ML model(s) 476, the catalog 478, the policy data 480 (identified by POLICY), and the token repository 482 (identified by TOKEN).

The machine readable instructions 1932, which may be implemented by the machine readable instructions of FIGS. 6-13, may be stored in the mass storage device 1928, in the volatile memory 1914, in the non-volatile memory 1916, and/or on a removable non-transitory computer readable storage medium such as a CD or DVD.

The processor platform 1900 of the illustrated example of FIG. 19 includes example acceleration circuitry 1940, which includes an example graphics processing unit (GPU) 1942, an example vision processing unit (VPU) 1944, and an example neural network processor 1946. In this example, the GPU 1942, the VPU 1944, and the neural network processor 1946 are in communication with different hardware of the processor platform 1900, such as the volatile memory 1914, the non-volatile memory 1916, etc., via the bus 1918. In this example, the neural network processor 1946 can be implemented by one or more integrated circuits, logic circuits, microprocessors, GPUs, DSPs, or controllers from any desired family or manufacturer that can be used to execute an AI/ML model, such as a neural network, which may be implemented by the ML model(s) 476. In some examples, one or more of the configuration detection circuitry 420, the operation state detection circuitry 430, the ML circuitry 440, the recommendation generation circuitry 450, and/or the process control update circuitry 460 can be implemented in or with at least one of the GPU 1942, the VPU 1944, or the neural network processor 1946 instead of or in addition to the processor circuitry 1912.

FIG. 20 is a block diagram of an example processor platform 2000 structured to execute and/or instantiate the example machine readable instructions and/or the example operations of FIGS. 14-18 to implement the gateway circuitry 500 of FIG. 5. The processor platform 2000 can be, for example, a server, a personal computer, a workstation, a self-learning machine (e.g., a neural network), or any other type of computing device.

The processor platform 2000 of the illustrated example includes processor circuitry 2012. The processor circuitry 2012 of the illustrated example is hardware. For example, the processor circuitry 2012 can be implemented by one or more integrated circuits, logic circuits, FPGAs, microprocessors, CPUs, GPUs, DSPs, and/or microcontrollers from any desired family or manufacturer. The processor circuitry 2012 may be implemented by one or more semiconductor based (e.g., silicon based) devices. In this example, the processor circuitry 2012 implements the configuration detection circuitry 520 (identified by CONFIG DETECT CIRCUITRY), the operation state detection circuitry 530 (identified by OP STATE DETECT CIRCUITRY), the ML circuitry 540 (identified by ML circuitry), and the process control update circuitry 560 (identified by PCNTRL UPDATE CIRCUITRY) of FIG. 5.

The processor circuitry 2012 of the illustrated example includes a local memory 2013 (e.g., a cache, registers, etc.). The processor circuitry 2012 of the illustrated example is in communication with a main memory including a volatile memory 2014 and a non-volatile memory 2016 by a bus 2018. In some examples, the bus 2018 can implement the bus 590 of FIG. 5. The volatile memory 2014 may be implemented by SDRAM, DRAM, RDRAM®, and/or any other type of RAM device. The non-volatile memory 2016 may be implemented by flash memory and/or any other desired type of memory device. Access to the main memory 2014, 2016 of the illustrated example is controlled by a memory controller 2017.

The processor platform 2000 of the illustrated example also includes interface circuitry 2020. The interface circuitry 2020 may be implemented by hardware in accordance with any type of interface standard, such as an Ethernet interface, a USB interface, a Bluetooth® interface, an NFC interface, a PCI interface, and/or a PCIe interface. In this example, the interface circuitry 2020 implements the interface circuitry 510 of FIG. 5.

In the illustrated example, one or more input devices 2022 are connected to the interface circuitry 2020. The input device(s) 2022 permit(s) a user to enter data and/or commands into the processor circuitry 2012. The input device(s) 2022 can be implemented by, for example, an audio sensor, a microphone, a camera (still or video), a keyboard, a button, a mouse, a touchscreen, a track-pad, a trackball, an isopoint device, and/or a voice recognition system.

One or more output devices 2024 are also connected to the interface circuitry 2020 of the illustrated example. The output device(s) 2024 can be implemented, for example, by display devices (e.g., a LED, an OLED, an LCD, a CRT display, an IPS display, a touchscreen, etc.), a tactile output device, a printer, and/or speaker. The interface circuitry 2020 of the illustrated example, thus, typically includes a graphics driver card, a graphics driver chip, and/or graphics processor circuitry such as a GPU.

The interface circuitry 2020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 2000 of the illustrated example also includes one or more mass storage devices 2028 to store software and/or data. Examples of such mass storage devices 2028 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 2028 implement the datastore 570, the telemetry data 572 (identified by TELEMETRY), the configuration data 574 (identified by CONFIG), the ML model(s) 576, the executables 578 identified by (EXE(S)), the policy data 580 (identified by POLICY), and the parameter data 582 (identified by PARAMETER).

The machine readable instructions 2032, which may be implemented by the machine readable instructions of FIGS. 14-18, may be stored in the mass storage device 2028, in the volatile memory 2014, in the non-volatile memory 2016, and/or on a removable non-transitory computer readable storage medium such as a CD or DVD.

The processor platform 2000 of the illustrated example of FIG. 20 includes example acceleration circuitry 2040, which includes an example GPU 2042, an example VPU 2044, and an example neural network processor 2046. In this example, the GPU 2042, the VPU 2044, and the neural network processor 2046 are in communication with different hardware of the processor platform 2000, such as the volatile memory 2014, the non-volatile memory 2016, etc., via the bus 2018. In this example, the neural network processor 2046 can be implemented by one or more integrated circuits, logic circuits, microprocessors, GPUs, DSPs, or controllers from any desired family or manufacturer that can be used to execute an AI/ML model, such as a neural network, which may be implemented by the ML model(s) 576. In some examples, one or more of the configuration detection circuitry 520, the operation state detection circuitry 530, the ML circuitry 540, and/or the process control update circuitry 560 can be implemented in or with at least one of the GPU 2042, the VPU 2044, or the neural network processor 2046 instead of or in addition to the processor circuitry 2012.

FIG. 21 is a block diagram of an example implementation of the processor circuitry 1912 of FIG. 19 and/or the processor circuitry 2012 of FIG. 20. In this example, the processor circuitry 1912 of FIG. 19 and/or the processor circuitry 2012 of FIG. 20 is implemented by a microprocessor 2100. For example, the microprocessor 2100 may be a general purpose microprocessor (e.g., general purpose microprocessor circuitry). The microprocessor 2100 executes some or all of the machine readable instructions of the flowcharts of FIGS. 6-18 to effectively instantiate the recommendation engine circuitry 400 of FIG. 4 and/or the gateway circuitry 500 of FIG. 5 as logic circuits to perform the operations corresponding to those machine readable instructions. In some such examples, the recommendation engine circuitry 400 of FIG. 4 and/or the gateway circuitry 500 of FIG. 5 is instantiated by the hardware circuits of the microprocessor 2100 in combination with the instructions. For example, the microprocessor 2100 may be implemented by multi-core hardware circuitry such as a CPU, a DSP, a GPU, an XPU, etc. Although it may include any number of example cores 2102 (e.g., 1 core), the microprocessor 2100 of this example is a multi-core semiconductor device including N cores. The cores 2102 of the microprocessor 2100 may operate independently or may cooperate to execute machine readable instructions. For example, machine code corresponding to a firmware program, an embedded software program, or a software program may be executed by one of the cores 2102 or may be executed by multiple ones of the cores 2102 at the same or different times. In some examples, the machine code corresponding to the firmware program, the embedded software program, or the software program is split into threads and executed in parallel by two or more of the cores 2102. The software program may correspond to a portion or all of the machine readable instructions and/or operations represented by the flowcharts of FIGS. 6-18.

The cores 2102 may communicate by a first example bus 2104. In some examples, the first bus 2104 may be implemented by a communication bus to effectuate communication associated with one(s) of the cores 2102. For example, the first bus 2104 may be implemented by at least one of an Inter-Integrated Circuit (I2C) bus, a Serial Peripheral Interface (SPI) bus, a PCI bus, or a PCIe bus. Additionally or alternatively, the first bus 2104 may be implemented by any other type of computing or electrical bus. The cores 2102 may obtain data, instructions, and/or signals from one or more external devices by example interface circuitry 2106. The cores 2102 may output data, instructions, and/or signals to the one or more external devices by the interface circuitry 2106. Although the cores 2102 of this example include example local memory 2120 (e.g., Level 1 (L1) cache that may be split into an L1 data cache and an L1 instruction cache), the microprocessor 2100 also includes example shared memory 2110 that may be shared by the cores (e.g., Level 2 (L2 cache)) for high-speed access to data and/or instructions. Data and/or instructions may be transferred (e.g., shared) by writing to and/or reading from the shared memory 2110. The local memory 2120 of each of the cores 2102 and the shared memory 2110 may be part of a hierarchy of storage devices including multiple levels of cache memory and the main memory (e.g., the main memory 1914, 1916 of FIG. 19, the main memory 2014, 2016 of FIG. 20, etc.). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 2102 may be referred to as a CPU, DSP, GPU, etc., or any other type of hardware circuitry. Each core 2102 includes control unit circuitry 2114, arithmetic and logic (AL) circuitry (sometimes referred to as an ALU) 2116, a plurality of registers 2118, the local memory 2120, and a second example bus 2122. Other structures may be present. For example, each core 2102 may include vector unit circuitry, single instruction multiple data (SIMD) unit circuitry, load/store unit (LSU) circuitry, branch/jump unit circuitry, floating-point unit (FPU) circuitry, etc. The control unit circuitry 2114 includes semiconductor-based circuits structured to control (e.g., coordinate) data movement within the corresponding core 2102. The AL circuitry 2116 includes semiconductor-based circuits structured to perform one or more mathematic and/or logic operations on the data within the corresponding core 2102. The AL circuitry 2116 of some examples performs integer based operations. In other examples, the AL circuitry 2116 also performs floating point operations. In yet other examples, the AL circuitry 2116 may include first AL circuitry that performs integer based operations and second AL circuitry that performs floating point operations. In some examples, the AL circuitry 2116 may be referred to as an Arithmetic Logic Unit (ALU). The registers 2118 are semiconductor-based structures to store data and/or instructions such as results of one or more of the operations performed by the AL circuitry 2116 of the corresponding core 2102. For example, the registers 2118 may include vector register(s), SIMD register(s), general purpose register(s), flag register(s), segment register(s), machine specific register(s), instruction pointer register(s), control register(s), debug register(s), memory management register(s), machine check register(s), etc. The registers 2118 may be arranged in a bank as shown in FIG. 21. Alternatively, the registers 2118 may be organized in any other arrangement, format, or structure including distributed throughout the core 2102 to shorten access time. The second bus 2122 may be implemented by at least one of an I2C bus, a SPI bus, a PCI bus, or a PCIe bus

Each core 2102 and/or, more generally, the microprocessor 2100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 2100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 22 is a block diagram of another example implementation of the processor circuitry 1912 of FIG. 19 and/or the processor circuitry 2012 of FIG. 20. In this example, the processor circuitry 1912 of FIG. 19 and/or the processor circuitry 2012 of FIG. 20 is implemented by FPGA circuitry 2200. For example, the FPGA circuitry 2200 may be implemented by an FPGA. The FPGA circuitry 2200 can be used, for example, to perform operations that could otherwise be performed by the example microprocessor 2100 of FIG. 21 executing corresponding machine readable instructions. However, once configured, the FPGA circuitry 2200 instantiates the machine readable instructions in hardware and, thus, can often execute the operations faster than they could be performed by a general purpose microprocessor executing the corresponding software.

More specifically, in contrast to the microprocessor 2100 of FIG. 21 described above (which is a general purpose device that may be programmed to execute some or all of the machine readable instructions represented by the flowcharts of FIGS. 6-18 but whose interconnections and logic circuitry are fixed once fabricated), the FPGA circuitry 2200 of the example of FIG. 22 includes interconnections and logic circuitry that may be configured and/or interconnected in different ways after fabrication to instantiate, for example, some or all of the machine readable instructions represented by the flowcharts of FIGS. 6-18. In particular, the FPGA circuitry 2200 may be thought of as an array of logic gates, interconnections, and switches. The switches can be programmed to change how the logic gates are interconnected by the interconnections, effectively forming one or more dedicated logic circuits (unless and until the FPGA circuitry 2200 is reprogrammed). The configured logic circuits enable the logic gates to cooperate in different ways to perform different operations on data received by input circuitry. Those operations may correspond to some or all of the software represented by the flowcharts of FIGS. 6-18. As such, the FPGA circuitry 2200 may be structured to effectively instantiate some or all of the machine readable instructions of the flowcharts of FIGS. 6-18 as dedicated logic circuits to perform the operations corresponding to those software instructions in a dedicated manner analogous to an ASIC. Therefore, the FPGA circuitry 2200 may perform the operations corresponding to the some or all of the machine readable instructions of FIGS. 6-18 faster than the general purpose microprocessor can execute the same.

In the example of FIG. 22, the FPGA circuitry 2200 is structured to be programmed (and/or reprogrammed one or more times) by an end user by a hardware description language (HDL) such as Verilog. The FPGA circuitry 2200 of FIG. 22, includes example input/output (I/O) circuitry 2202 to obtain and/or output data to/from example configuration circuitry 2204 and/or external hardware 2206. For example, the configuration circuitry 2204 may be implemented by interface circuitry that may obtain machine readable instructions to configure the FPGA circuitry 2200, or portion(s) thereof. In some such examples, the configuration circuitry 2204 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 2206 may be implemented by external hardware circuitry. For example, the external hardware 2206 may be implemented by the microprocessor 2100 of FIG. 21. The FPGA circuitry 2200 also includes an array of example logic gate circuitry 2208, a plurality of example configurable interconnections 2210, and example storage circuitry 2212. The logic gate circuitry 2208 and the configurable interconnections 2210 are configurable to instantiate one or more operations that may correspond to at least some of the machine readable instructions of FIGS. 6-18 and/or other desired operations. The logic gate circuitry 2208 shown in FIG. 22 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2208 to enable configuration of the electrical structures and/or the logic gates to form circuits to perform desired operations. The logic gate circuitry 2208 may include other electrical structures such as look-up tables (LUTs), registers (e.g., flip-flops or latches), multiplexers, etc.

The configurable interconnections 2210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2208 to program desired logic circuits.

The storage circuitry 2212 of the illustrated example is structured to store result(s) of the one or more of the operations performed by corresponding logic gates. The storage circuitry 2212 may be implemented by registers or the like. In the illustrated example, the storage circuitry 2212 is distributed amongst the logic gate circuitry 2208 to facilitate access and increase execution speed.

The example FPGA circuitry 2200 of FIG. 22 also includes example Dedicated Operations Circuitry 2214. In this example, the Dedicated Operations Circuitry 2214 includes special purpose circuitry 2216 that may be invoked to implement commonly used functions to avoid the need to program those functions in the field. Examples of such special purpose circuitry 2216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2200 may also include example general purpose programmable circuitry 2218 such as an example CPU 2220 and/or an example DSP 2222. Other general purpose programmable circuitry 2218 may additionally or alternatively be present such as a GPU, an XPU, etc., that can be programmed to perform other operations.

Although FIGS. 21 and 22 illustrate two example implementations of the processor circuitry 1912 of FIG. 19 and/or the processor circuitry 2012 of FIG. 20, many other approaches are contemplated. For example, as mentioned above, modern FPGA circuitry may include an on-board CPU, such as one or more of the example CPU 2220 of FIG. 22. Therefore, the processor circuitry 1912 of FIG. 19 and/or the processor circuitry 2012 of FIG. 20 may additionally be implemented by combining the example microprocessor 2100 of FIG. 21 and the example FPGA circuitry 2200 of FIG. 22. In some such hybrid examples, a first portion of the machine readable instructions represented by the flowcharts of FIGS. 6-18 may be executed by one or more of the cores 2102 of FIG. 21, a second portion of the machine readable instructions represented by the flowcharts of FIGS. 6-18 may be executed by the FPGA circuitry 2200 of FIG. 22, and/or a third portion of the machine readable instructions represented by the flowcharts of FIGS. 6-18 may be executed by an ASIC. It should be understood that some or all of the recommendation engine circuitry 400 of FIG. 4 and/or the gateway circuitry 500 of FIG. 5 may, thus, be instantiated at the same or different times. Some or all of the circuitry may be instantiated, for example, in one or more threads executing concurrently and/or in series. Moreover, in some examples, some or all of the recommendation engine circuitry 400 of FIG. 4 and/or the gateway circuitry 500 of FIG. 5 may be implemented within one or more virtual machines and/or containers executing on the microprocessor.

In some examples, the processor circuitry 1912 of FIG. 19 and/or the processor circuitry 2012 of FIG. 20 may be in one or more packages. For example, the microprocessor 2100 of FIG. 21 and/or the FPGA circuitry 2200 of FIG. 22 may be in one or more packages. In some examples, an XPU may be implemented by the processor circuitry 1912 of FIG. 19 and/or the processor circuitry 2012 of FIG. 20, which may be in one or more packages. For example, the XPU may include a CPU in one package, a DSP in another package, a GPU in yet another package, and an FPGA in still yet another package.

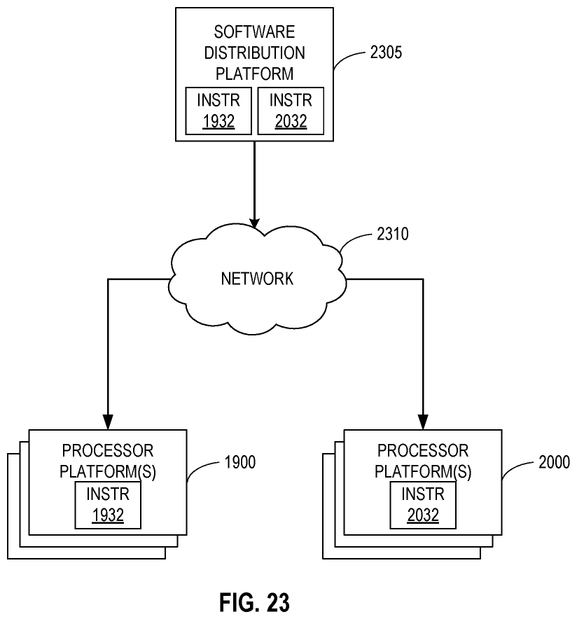

A block diagram illustrating an example software distribution platform 2305 to distribute software such as the example machine readable instructions 1932 of FIG. 19 and/or the example machine readable instructions 2032 of FIG. 20 to hardware devices owned and/or operated by third parties is illustrated in FIG. 23. The example software distribution platform 2305 may be implemented by any computer server, data facility, cloud service, etc., capable of storing and transmitting software to other computing devices. In some examples, the software distribution platform 2305 may be implemented by the cloud data center 146 of FIGS. 1 and/or 2. The third parties may be customers of the entity owning and/or operating the software distribution platform 2305. For example, the entity that owns and/or operates the software distribution platform 2305 may be a developer, a seller, and/or a licensor of software such as the example machine readable instructions 1932 of FIG. 19 and/or the example machine readable instructions 2032 of FIG. 20. The third parties may be consumers, users, retailers, OEMs, etc., who purchase and/or license the software for use and/or re-sale and/or sub-licensing. In the illustrated example, the software distribution platform 2305 includes one or more servers and one or more storage devices. The storage devices store the example machine readable instructions 1932 of FIG. 19 and/or the example machine readable instructions 2032 of FIG. 20, which may correspond to the example machine readable instructions 600, 700, 800, 900, 1000, 1100, 1200, 1300, 1400, 1500, 1600, 1700, 1800 of FIGS. 6-18, as described above. The one or more servers of the example software distribution platform 2305 are in communication with an example network 2310, which may correspond to any one or more of the Internet and/or any of the example networks 138, 148, 1926, 2026 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the example machine readable instructions 1932 of FIG. 19 and/or the example machine readable instructions 2032 of FIG. 20 from the software distribution platform 2305. For example, the software, which may correspond to the example machine readable instructions 600, 700, 800, 900, 1000, 1100, 1200, 1300 of FIGS. 6-13, may be downloaded to the example processor platform 1900 of FIG. 19, which is to execute the example machine readable instructions 1932 of FIG. 19 to implement the recommendation engine circuitry 400 of FIG. 4. In some examples, the software, which may correspond to the example machine readable instructions 1400, 1500, 1600, 1700, 1800 of FIGS. 14-18, may be downloaded to the example processor platform 2000 of FIG. 20, which is to execute the example machine readable instructions 2032 of FIG. 20 to implement the gateway circuitry 500 of FIG. 5. In some examples, one or more servers of the software distribution platform 2305 periodically offer, transmit, and/or force updates to the software (e.g., the example machine readable instructions 1932 of FIG. 19 and/or the example machine readable instructions 2032 of FIG. 20) to ensure improvements, patches, updates, etc., are distributed and applied to the software at the end user devices.

From the foregoing, it will be appreciated that example systems, methods, apparatus, and articles of manufacture have been disclosed for an application marketplace for process control systems. In some disclosed examples, by allowing end users to purchase and maintain process control system software through example marketplace applications, the end user can be granted a near-immediate experience of being granted software license rights to unlock or activate new features for use in a process control system. Advantageously, in some disclosed examples, remote systems such as cloud data centers can benefit from collecting metrics (e.g., up-to-the-minute metrics) and reporting of license usage and history for measurement (e.g., immediate or near immediate measurement) of demand.

Disclosed example systems, methods, apparatus, and articles of manufacture can recommend the purchase and installation of specific software, firmware, and/or hardware configuration instances to enhance operations of a process control system. For example, different hardware, software, and/or firmware can be recommended based on at least one of a configuration or a state of operation of a process control system.

Disclosed systems, methods, apparatus, and articles of manufacture improve the efficiency of using a computing device by recommending the unlocking, activation, and/or otherwise enabling of new features, functions, etc., not previously utilized in a process control system. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for an application marketplace for process control systems are disclosed herein. Further examples and combinations thereof include the following:

Example 1 includes an apparatus comprising at least one memory, machine readable instructions, and processor circuitry to at least one of instantiate or execute the machine readable instructions to detect at least one of a configuration or a state of operation of a process control system based on telemetry data associated with the process control system, execute a machine learning model to generate an output based on the at least one of the configuration or the state of operation, the output to be representative of a recommendation to change a portion of the process control system, and cause a change of the portion of the process control system based on the recommendation.

Example 2 includes the apparatus of example 1, wherein the processor circuitry is to cause the change of the portion of the process control system after a determination based on a policy that the recommendation is to be implemented without intervention from a user associated with the process control system.

Example 3 includes the apparatus of example 1, wherein the processor circuitry is to request authorization to cause the change from a user associated with the process control system after a determination based on a policy that the recommendation is to be implemented with intervention from the user.

Example 4 includes the apparatus of example 1, wherein the processor circuitry is to execute the machine learning model to classify the telemetry data into first data with a first data classification and second data with a second data classification, discard the first data based on a policy, and store the second data in a datastore based on the policy.

Example 5 includes the apparatus of example 1, wherein the configuration is a first configuration, the process control system is a first process control system, and the processor circuitry is to execute the machine learning model to identify one or more data classifications of the telemetry data, identify a second process control system based on the one or more data classifications, identify a second configuration of the second process control system, and identify the change of the first process control system based on the second configuration of the second process control system.

Example 6 includes the apparatus of example 1, wherein the process control system is a first process control system, and the processor circuitry is to detect that the first process control system is in the state of operation, and generate the recommendation to identify an application associated with a second process control system in the state of operation, the change to the portion of the first process control system to include execution of the application.

Example 7 includes the apparatus of example 6, wherein the processor circuitry is to detect that the state of operation is a design operation state, a fully enabled operation state, or a maintenance operation state.

Example 8 includes the apparatus of example 1, wherein the processor circuitry is to identify a first version of an application based on the configuration, and after a detection that a second version of the application is available, facilitate an upgrade of the application from the first version to the second version based on a policy.

Example 9 includes the apparatus of example 1, wherein the processor circuitry is to obtain data representative of a request for recovery of the process control system after a failure of the process control system, identify one or more applications corresponding to the configuration, and distribute the one or more applications to the process control system to cause the recovery of the process control system.

Example 10 includes the apparatus of example 1, wherein the processor circuitry is to obtain data representative of a request to access an application, and after a determination that the request indicates the access is for execution of the application by a cloud host, instantiate the application on the cloud host for execution.

Example 11 includes the apparatus of example 1, wherein the processor circuitry is to obtain data representative of a request to access an application, and after a determination that the request indicates the access is for local execution of the application by a client electronic device, cause a download of the application to the client electronic device for local execution on the client electronic device.

Example 12 includes the apparatus of example 1, wherein the processor circuitry is to identify an application associated with the process control system based on the configuration, and after a determination that feedback associated with the application is identified identify a change to the application based on the feedback, and redeploy the application for access by the process control system based on the change.

Example 13 includes the apparatus of example 1, wherein the processor circuitry is to determine that an application associated with the process control system is accessed by a client electronic device of the process control system, decrement one or more tokens from a first token balance recorded on a ledger, the first token balance corresponding to the client electronic device, and increment the one or more tokens for a second token balance recorded on the ledger, the second token balance corresponding to a developer of the application, the increment of the one or more tokens to effectuate payment for the access of the application by the client electronic device.

Example 14 includes the apparatus of example 1, wherein the recommendation includes a deployment of a virtual private network, a firewall, or a software data diode in the process control system, and the processor circuitry is to deploy at least one of the virtual private network, the firewall, or the software data diode in the process control system.

Example 15 includes the apparatus of example 1, wherein the configuration includes at least one of an installed product or a selected product for deployment in the process control system, and the recommendation includes a support service associated with the at least one of the installed product or the selected product for deployment in the process control system.

Example 16 includes the apparatus of example 1, wherein the processor circuitry is to determine that the change of the portion of the process control system is associated with a monetary cost based on an identification of a customer of the process control system.

Example 17 includes the apparatus of example 1, wherein the processor circuitry is to determine that the telemetry data includes usage data for improvements of products or sales funnel conversion to improve marketing strategies associated with the products to increase conversion rates.

Example 18 includes a non-transitory machine readable storage medium comprising instructions that, when executed, cause processor circuitry to at least detect at least one of a configuration or a state of operation of a process control system based on telemetry data associated with the process control system, execute a machine learning model to generate an output based on the at least one of the configuration or the state of operation, the output to be representative of a recommendation to change a portion of the process control system, and cause a change of the portion of the process control system based on the recommendation.

Example 19 includes the non-transitory machine readable storage medium of example 18, wherein the instructions, when executed, cause the processor circuitry to cause the change of the portion of the process control system after a determination based on a policy that the recommendation is to be implemented without intervention from a user associated with the process control system.

Example 20 includes the non-transitory machine readable storage medium of example 18, wherein the instructions, when executed, cause the processor circuitry to request authorization to cause the change from a user associated with the process control system after a determination based on a policy that the recommendation is to be implemented with intervention from the user.

Example 21 includes the non-transitory machine readable storage medium of example 18, wherein the instructions, when executed, cause the processor circuitry to execute the machine learning model to classify the telemetry data into first data with a first data classification and second data with a second data classification, discard the first data based on a policy, and store the second data in a datastore based on the policy.

Example 22 includes the non-transitory machine readable storage medium of example 18, wherein the configuration is a first configuration, the process control system is a first process control system, and the instructions, when executed, cause the processor circuitry to execute the machine learning model to identify one or more data classifications of the telemetry data, identify a second process control system based on the one or more data classifications, identify a second configuration of the second process control system, and identify the change of the first process control system based on the second configuration of the second process control system.

Example 23 includes the non-transitory machine readable storage medium of example 18, wherein the process control system is a first process control system, and the instructions, when executed, cause the processor circuitry to detect that the first process control system is in the state of operation, and generate the recommendation to identify an application associated with a second process control system in the state of operation, the change to the portion of the first process control system to include execution of the application.

Example 24 includes the non-transitory machine readable storage medium of 23, wherein the instructions, when executed, cause the processor circuitry to detect that the state of operation is a design operation state, a fully enabled operation state, or a maintenance operation state.

Example 25 includes the non-transitory machine readable storage medium of example 18, wherein the instructions, when executed, cause the processor circuitry to identify a first version of an application based on the configuration, and after a detection that a second version of the application is available, facilitate an upgrade of the application from the first version to the second version based on a policy.

Example 26 includes the non-transitory machine readable storage medium of example 18, wherein the instructions, when executed, cause the processor circuitry to obtain data representative of a request for recovery of the process control system after a failure of the process control system, identify one or more applications corresponding to the configuration, and distribute the one or more applications to the process control system to cause the recovery of the process control system.

Example 27 includes the non-transitory machine readable storage medium of example 18, wherein the instructions, when executed, cause the processor circuitry to obtain data representative of a request to access an application, and after a determination that the request indicates the access is for execution of the application by a cloud host, instantiate the application on the cloud host for execution.

Example 28 includes the non-transitory machine readable storage medium of example 18, wherein the instructions, when executed, cause the processor circuitry to obtain data representative of a request to access an application, and after a determination that the request indicates the access is for local execution of the application by a client electronic device, cause a download of the application to the client electronic device for local execution on the client electronic device.

Example 29 includes the non-transitory machine readable storage medium of example 18, wherein the instructions, when executed, cause the processor circuitry to identify an application associated with the process control system based on the configuration, and after a determination that feedback associated with the application is identified identify a change to the application based on the feedback, and redeploy the application for access by the process control system based on the change.

Example 30 includes the non-transitory machine readable storage medium of example 18, wherein the instructions, when executed, cause the processor circuitry to determine that an application associated with the process control system is accessed by a client electronic device of the process control system, remove one or more tokens from a first token balance recorded on a ledger, the first token balance corresponding to the client electronic device, and add the one or more tokens for a second token balance recorded on the ledger, the second token balance corresponding to a developer of the application, the increment of the one or more tokens to effectuate payment for the access of the application by the client electronic device.

Example 31 includes the non-transitory machine readable storage medium of example 18, wherein the recommendation includes a deployment of a virtual private network, a firewall, or a software data diode in the process control system, and the instructions, when executed, cause the processor circuitry to deploy at least one of the virtual private network, the firewall, or the software data diode in the process control system.

Example 32 includes the non-transitory machine readable storage medium of example 18, wherein the configuration includes at least one of an installed product or a selected product for deployment in the process control system, and the recommendation includes a support service associated with the at least one of the installed product or the selected product for deployment in the process control system.

Example 33 includes the non-transitory machine readable storage medium of example 18, wherein the instructions, when executed, cause the processor circuitry to determine that the change of the portion of the process control system is associated with a monetary cost based on an identification of a customer of the process control system.

Example 34 includes the non-transitory machine readable storage medium of example 18, wherein the instructions, when executed, cause the processor circuitry to determine that the telemetry data includes usage data for improvements of products or sales funnel conversion to improve marketing strategies associated with the products to increase conversion rates.

Example 35 includes a method comprising detecting at least one of a configuration or a state of operation of a process control system based on telemetry data associated with the process control system, executing a machine learning model to generate an output based on the at least one of the configuration or the state of operation, the output to be representative of a recommendation to change a portion of the process control system, and causing a change of the portion of the process control system based on the recommendation.

Example 36 includes the method of example 35, wherein the causing of the change of the portion of the process control system is after a determination based on a policy that the recommendation is to be implemented without intervention from a user associated with the process control system.

Example 37 includes the method of example 35, further including requesting authorization to cause the change from a user associated with the process control system after a determination based on a policy that the recommendation is to be implemented with intervention from the user.

Example 38 includes the method of example 35, further including executing the machine learning model to classify the telemetry data into first data with a first data classification and second data with a second data classification, deleting the first data based on a policy, and storing the second data in a datastore based on the policy.

Example 39 includes the method of example 35, wherein the configuration is a first configuration, the process control system is a first process control system, and the method further including executing the machine learning model to identify one or more data classifications of the telemetry data, identifying a second process control system based on the one or more data classifications, identifying a second configuration of the second process control system, and identifying the change of the first process control system based on the second configuration of the second process control system.

Example 40 includes the method of example 35, wherein the process control system is a first process control system, and the method further including detecting that the first process control system is in the state of operation, and generating the recommendation to identify an application associated with a second process control system in the state of operation, the change to the portion of the first process control system to include execution of the application.

Example 41 includes the method of example 40, further including detecting that the state of operation is a design operation state, a fully enabled operation state, or a maintenance operation state.

Example 42 includes the method of example 35, further including identifying a first version of an application based on the configuration, and after a detection that a second version of the application is available, upgrading the application from the first version to the second version based on a policy.

Example 43 includes the method of example 35, further including obtaining data representative of a request for recovery of the process control system after a failure of the process control system, identifying one or more applications corresponding to the configuration, and distributing the one or more applications to the process control system to cause the recovery of the process control system.

Example 44 includes the method of example 35, further including obtaining data representative of a request to access an application, and after a determination that the request indicates the access is for execution of the application by a cloud host, instantiating the application on the cloud host for execution.

Example 45 includes the method of example 35, further including obtaining data representative of a request to access an application, and after a determination that the request indicates the access is for local execution of the application by a client electronic device, causing a download of the application to the client electronic device for local execution on the client electronic device.

Example 46 includes the method of example 35, further including identifying an application associated with the process control system based on the configuration, and after a determination that feedback associated with the application is identified identifying a change to the application based on the feedback, and redeploying the application for access by the process control system based on the change.

Example 47 includes the method of example 35, further including determining that an application associated with the process control system is accessed by a client electronic device of the process control system, decrementing one or more tokens from a first token balance recorded on a ledger, the first token balance corresponding to the client electronic device, and incrementing the one or more tokens for a second token balance recorded on the ledger, the second token balance corresponding to a developer of the application, the increment of the one or more tokens to effectuate payment for the access of the application by the client electronic device.

Example 48 includes the method of example 35, wherein the recommendation includes a deployment of a virtual private network, a firewall, or a software data diode in the process control system, and the method further including deploying at least one of the virtual private network, the firewall, or the software data diode in the process control system.

Example 49 includes the method of example 35, wherein the configuration includes at least one of an installed product or a selected product for deployment in the process control system, and the recommendation includes a support service associated with the at least one of the installed product or the selected product for deployment in the process control system.

Example 50 includes the method of example 35, further including determining that the change of the portion of the process control system is associated with a monetary cost based on an identification of a customer of the process control system.

Example 51 includes the method of example 35, further including determining that the telemetry data includes usage data for improvements of products or sales funnel conversion to improve marketing strategies associated with the products to increase conversion rates.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
at least one memory;
machine readable instructions; and
processor circuitry to at least one of instantiate or execute the machine readable instructions to:
detect at least one of a configuration or a state of operation of a process control system based on telemetry data associated with the process control system;
execute a machine learning model to generate an output based on the at least one of the configuration or the state of operation, the output to be representative of a recommendation to change a portion of the process control system; and
cause a change of the portion of the process control system based on the recommendation.

2. (canceled)

3. (canceled)

4. The apparatus of claim 1, wherein the processor circuitry is to:
execute the machine learning model to classify the telemetry data into first data with a first data classification and second data with a second data classification;
discard the first data based on a policy; and
store the second data in a datastore based on the policy.

5. The apparatus of claim 1, wherein the configuration is a first configuration, the process control system is a first process control system, and the processor circuitry is to:
execute the machine learning model to identify one or more data classifications of the telemetry data;
identify a second process control system based on the one or more data classifications;
identify a second configuration of the second process control system; and
identify the change of the first process control system based on the second configuration of the second process control system.

6. The apparatus of claim 1, wherein the process control system is a first process control system, and the processor circuitry is to:
detect that the first process control system is in the state of operation; and
generate the recommendation to identify an application associated with a second process control system in the state of operation, the change to the portion of the first process control system to include execution of the application.

7. The apparatus of claim 6, wherein the processor circuitry is to detect that the state of operation is a design operation state, a fully enabled operation state, or a maintenance operation state.

8-11. (canceled)

12. The apparatus of claim 1, wherein the processor circuitry is to:
identify an application associated with the process control system based on the configuration; and
after a determination that feedback associated with the application is identified:
identify a change to the application based on the feedback; and
redeploy the application for access by the process control system based on the change.

13. The apparatus of claim 1, wherein the processor circuitry is to:
determine that an application associated with the process control system is accessed by a client electronic device of the process control system;
decrement one or more tokens from a first token balance recorded on a ledger, the first token balance corresponding to the client electronic device; and
increment the one or more tokens for a second token balance recorded on the ledger, the second token balance corresponding to a developer of the application, the increment of the one or more tokens to effectuate payment for the access of the application by the client electronic device.

14-17. (canceled)

18. A non-transitory machine readable storage medium comprising instructions that, when executed, cause processor circuitry to at least:
detect at least one of a configuration or a state of operation of a process control system based on telemetry data associated with the process control system;
execute a machine learning model to generate an output based on the at least one of the configuration or the state of operation, the output to be representative of a recommendation to change a portion of the process control system; and
cause a change of the portion of the process control system based on the recommendation.

19. The non-transitory machine readable storage medium of claim 18, wherein the instructions, when executed, cause the processor circuitry to cause the change of the portion of the process control system after a determination based on a policy that the recommendation is to be implemented without intervention from a user associated with the process control system.

20. (canceled)

21. (canceled)

22. The non-transitory machine readable storage medium of claim 18, wherein the configuration is a first configuration, the process control system is a first process control system, and the instructions, when executed, cause the processor circuitry to:
execute the machine learning model to identify one or more data classifications of the telemetry data;
identify a second process control system based on the one or more data classifications;
identify a second configuration of the second process control system; and
identify the change of the first process control system based on the second configuration of the second process control system.

23-25. (canceled)

26. The non-transitory machine readable storage medium of claim 18, wherein the instructions, when executed, cause the processor circuitry to:
obtain data representative of a request for recovery of the process control system after a failure of the process control system;
identify one or more applications corresponding to the configuration; and
distribute the one or more applications to the process control system to cause the recovery of the process control system.

27. The non-transitory machine readable storage medium of claim 18, wherein the instructions, when executed, cause the processor circuitry to:
obtain data representative of a request to access an application; and
after a determination that the request indicates the access is for execution of the application by a cloud host, instantiate the application on the cloud host for execution.

28-32. (canceled)

33. The non-transitory machine readable storage medium of claim 18, wherein the instructions, when executed, cause the processor circuitry to determine that the change of the portion of the process control system is associated with a monetary cost based on an identification of a customer of the process control system.

34. The non-transitory machine readable storage medium of claim 18, wherein the instructions, when executed, cause the processor circuitry to determine that the telemetry data includes usage data for improvements of products or sales funnel conversion to improve marketing strategies associated with the products to increase conversion rates.

35. A method comprising:
detecting at least one of a configuration or a state of operation of a process control system based on telemetry data associated with the process control system;
executing a machine learning model to generate an output based on the at least one of the configuration or the state of operation, the output to be representative of a recommendation to change a portion of the process control system; and
causing a change of the portion of the process control system based on the recommendation.

36. (canceled)

37. The method of claim 35, further including requesting authorization to cause the change from a user associated with the process control system after a determination based on a policy that the recommendation is to be implemented with intervention from the user.

38-41. (canceled)

42. The method of claim 35, further including:
identifying a first version of an application based on the configuration; and
after a detection that a second version of the application is available, upgrading the application from the first version to the second version based on a policy.

43. (canceled)

44. (canceled)

45. The method of claim 35, further including:
obtaining data representative of a request to access an application; and
after a determination that the request indicates the access is for local execution of the application by a client electronic device, causing a download of the application to the client electronic device for local execution on the client electronic device.

46. (canceled)

47. (canceled)

48. The method of claim 35, wherein the recommendation includes a deployment of a virtual private network, a firewall, or a software data diode in the process control system, and the method further including deploying at least one of the virtual private network, the firewall, or the software data diode in the process control system.

49. The method of claim 35, wherein the configuration includes at least one of an installed product or a selected product for deployment in the process control system, and the recommendation includes a support service associated with the at least one of the installed product or the selected product for deployment in the process control system.

50. (canceled)

51. (canceled)
